(19) United States
(12) Patent Application Publication
(10) Pub. No.: US 2023/0073006 A1
(43) Pub. Date: Mar. 9, 2023

(54) CATHODE AND CATHODE SLURRY FOR SECONDARY BATTERY

(71) Applicant: GRST International Limited, Hong Kong (CN)

(72) Inventors: Kam Piu Ho, Hong Kong (CN); Yingkai Jiang, Shenzhen (CN); Priscilla Huen, Hong Kong (CN)

(21) Appl. No.: 17/797,116

(22) PCT Filed: Mar. 12, 2021
(86) PCT No.: PCT/CN2021/080568

§ 371 Date: Aug. 3, 2022

(30) Foreign Application Priority Data
Mar. 20, 2020 (CN) PCT/CN2020/080525
Apr. 3, 2020 (CN) PCT/CN2020/083212
May 22, 2020 (CN) PCT/CN2020/091936
May 22, 2020 (CN) PCT/CN2020/091941
Jun. 17, 2020 (CN) PCT/CN2020/096672
Aug. 19, 2020 (CN) PCT/CN2020/110065
Sep. 25, 2020 (CN) PCT/CN2020/117789
Nov. 16, 2020 (CN) PCT/CN2020/129129

(51) Int. Cl. H01M 4/62; H01M 4/505; H01M 4/525

(52) U.S. Cl. CPC H01M 4/622; H01M 4/625; H01M 4/505; H01M 4/525; H01M 2004/028

(57) ABSTRACT

The invention provides an aqueous solvent-based cathode slurry for a secondary battery, comprising a cathode active material, a water-compatible copolymeric binder, a lithium compound, and an aqueous solvent. The lithium compound in the cathode slurry serves as a lithium-ion source in compensating for the irreversible capacity loss due to SEI formation during initial charging of the battery. Consequently, battery cells prepared using the cathode slurry disclosed herein exhibit improved electrochemical performance. Also provided herein is a cathode for a secondary battery, comprising a current collector and an electrode layer coated on one side or both sides of the current collector, wherein the electrode layer comprises a cathode active material, a water-compatible copolymeric binder, and a lithium compound; and which the cathode can be produced using the aqueous solvent-based cathode slurry disclosed.

### CROSS-REFERENCE TO RELATED APPLICATIONS

This is a U.S. national stage application of the International Patent Application No. PCT/CN2021/080568, filed Mar. 12, 2021, which claims the benefit under 35 U.S.C. § 365(c) of International Patent Application No. PCT/CN2020/080525, filed Mar. 20, 2020, International Patent Application No. PCT/CN2020/091936, filed May 22, 2020, International Patent Application No. PCT/CN2020/083212, filed Apr. 3, 2020, International Patent Application No. PCT/CN2020/091941, filed May 22, 2020, International Patent Application No. PCT/CN2020/096672, filed Jun. 17, 2020, International Patent Application No. PCT/CN2020/110065, filed Aug. 19, 2020, International Patent Application No. PCT/CN2020/117789, filed Sep. 25, 2020 and International Patent Application No. PCT/CN2020/129129, filed Nov. 16, 2020, the content of all of which are incorporated herein by reference in their entireties.

### FIELD OF THE INVENTION

The present invention relates to the field of batteries. In particular, this invention relates to cathodes and cathode slurries for lithium-ion batteries and other metal-ion batteries.

### BACKGROUND OF THE INVENTION

Over the past decades, lithium-ion batteries (LIBs) have come to be widely utilized in various applications, especially consumer electronics, because of their outstanding energy density, long cycle life and high discharging capability. Due to rapid market development of electric vehicles (EV) and grid energy storage, high-performance, low-cost LIBs are currently offering one of the most promising options for large-scale energy storage devices.

Lithium-ion batteries are usually fabricated in a discharged state. Upon initial charging, a passivating solid-electrolyte interphase (SEI) builds up at the interface between the electrolyte and the anode. The SEI is mainly formed from the decomposition products of the electrolyte which involves the consumption of lithium ions originating from the cathode. This phenomenon gives rise to an irreversible capacity loss of the battery since the lithium ions withdrawn from the cathode for SEI formation are rendered unusable or remain as deadweight during the subsequent operation of the battery. In practice, for anode active materials such as carbon, between 5% and 20% of the initial capacity is lost in irreversible SEI formation. For anode active materials that expose a high surface area in contact with the electrolyte, and undergo a large volume change during battery operation, more lithium ions are consumed for SEI formation. This is the case for silicon, where 20% to 40% of the initial capacity is expended in the formation of SEI. However, the SEI, which is permeable to lithium ions, is of crucial importance to the battery as the presence of the SEI prevents further undesirable decomposition of electrolyte. In view of such a problem, attempts have been made in mitigating or compensating this loss of lithium ions to increase or maximize the reversible capacity of lithium-ion batteries.

Supplementation of metallic lithium on the anode has been extensively investigated to remedy this loss in irreversible capacity during initial charging. However, the contacting of the metallic lithium with the anode involves imposing a potential of 0 V vs. Li/Li⁺ for Li⁺ generation, which is likely to induce several side reactions and may destruct existing anode active materials. Furthermore, with lithium being a highly chemically active metal that is unable to remain stable in air without reaction, such batteries require stringent environments for manufacture, which is highly difficult to implement on an industrial scale and inevitably arouses severe safety concerns.

The use of the compound Li₁₊ₓMn₂O₄ as cathode active material, where 0<x≤1, was thought to offer a solution in compensating for this lithium loss, due to its ability to intercalate a second lithium ion per formula unit to form Li₂Mn₂O₄ via chemical treatment using mild reducing agents such as LiI (Tarascon, J. M. and Guyomard, D. (1991) “Li Metal-Free Rechargeable Batteries Based on Li₁₊ₓMn₂O₄ Cathodes (0≤x≤1) and Carbon Anodes”, J. Electrochem. Soc., Vol. 138, No. 10, pp. 2864-2868). An excess of Li⁺ compared to conventional cathode active materials such as LiMn₂O₄ (where x is 0), due to the utilization of Li₂Mn₂O₄, Li₁₊ₓMn₂O₄ (with 0<x≤1) or mixtures of Li₁₊ₓMn₂O₄ as cathode active materials, could therefore be used during initial charging to overcome the irreversible capacity loss. However, this technique is specific to the compounds LiₓMn₂O₄, and the phase change of LiₓMn₂O₄ to Li₁₊ₓMn₂O₄ by chemical lithiation results in mechanical stresses on the metal oxides, thereby shortening the lifecycle of the battery.

CN Patent Application Publication No. 102148401 A introduces a method of pre-forming an SEI on the anode surface before battery assembly to reduce the irreversible capacity loss. The shortcoming of such a method lies in the need for conditions such as temperature and humidity to be strictly controlled in subsequent preparation processes after SEI pre-formation to prevent the oxidation of the SEI, which are extremely challenging to execute over a sustained period.

CN Patent Application Publication No. 109742319 A discloses a battery electrode that can be a cathode sheet or an anode sheet. The cathode sheet comprises an outermost layer of lithium-rich oxide applied on top of the cathode slurry film and the anode sheet comprises a binder layer that is made of lithium powder and carboxymethyl cellulose (CMC) and its derivatives positioned between the anode slurry film and the current collector. With this electrode arrangement, (1) the binder layer coated on the current collector of the anode sheet exhibits a corrosion resistivity function which is capable of reducing the tendency of SEI formation on the anode sheet surface, and thus lowers the uptake of lithium ions from the cathode sheet; and (2) only the outermost lithium-rich oxide layer of the cathode sheet is consumed for SEI formation during initial charging, without the utilization of lithium ions from the cathode slurry film. However, a problem may arise in the inability to further suppress decomposition of the remaining electrolyte due to reduced SEI formation. In addition, the incorporation of the lithium-rich oxide layer in the cathode sheet and the binder layer in the anode sheet naturally reduces the overall amount of cathode and anode active materials in the electrodes, hence the effectiveness of such an electrode arrangement in improving the energy density and cycle life of the battery is highly questionable. Moreover, the method does not provide sufficient data in supporting its findings and for evaluating the electrochemical performance of the electrode.

Generally, lithium-ion battery electrodes are fabricated by casting a slurry onto a metallic current collector. Such a slurry may comprise electrode active material, conductive carbon, and binder, in a solvent. The binder provides a good electrochemical stability, holds together the electrode active materials and adheres them to the current collector in the fabrication of electrodes. Polyvinylidene fluoride (PVDF) is one of the most commonly used binders in the commercial lithium-ion battery industry. PVDF can only dissolve in some specific organic solvents such as N-methyl-2-pyrrolidone (NMP). Accordingly, an organic solvent such as NMP would be commonly used as solvent to prepare an electrode slurry when the binder is PVDF.

CN Patent Application Publication No. 104037418 A discloses a cathode film for a lithium-ion battery prepared via a slurry method, comprising a lithium-containing transition metal oxide cathode active material, a conductive agent, a binder and a lithium-ion replenishing agent to compensate for the irreversible capacity loss. In the patent application, an organic solvent, such as NMP, is preferred as the solvent for the slurry. However, NMP is flammable and toxic and hence requires specific handling. Moreover, An NMP recovery system must be in place during the drying process to recover NMP vapors. This will generate significant costs in the manufacturing process since it requires a large capital investment. Therefore, the production of the cathode film in this patent application is limited by its insistent use of the expensive and toxic organic solvent NMP.

The use of less expensive and more environmentally-friendly solvents, such as aqueous solvents, most commonly water, is preferred in the present invention since water is remarkably safer than NMP and does not require the implementation of a recovery system. The use of aqueous solvents instead of organic solvents in producing electrode slurries thus significantly reduces the manufacturing costs and environmental impact, and therefore aqueous solvent-based cathode slurries have been considered in the present invention.

The problem of considerable irreversible lithium ion loss from SEI formation during initial charging is not mitigated by the usage of an aqueous solvent in producing the cathode film via a slurry instead of an organic solvent. Conversely, the usage of an aqueous solvent-based cathode slurry to produce cathodes presents an additional challenge of lithium dissolution from the active material into the aqueous solvent of the slurry. For that reason, the reversible capacity that could participate in subsequent cycling in batteries comprising cathodes produced via an aqueous solvent-based slurry could be significantly lower compared to batteries comprising cathodes produced via a conventional organic solvent-based slurry. Thus, a solution has been demanded to develop a means of compensating metal ion loss, particularly in cathodes produced via aqueous solvent-based cathode slurries, in order to reduce the irreversible capacity loss in lithium-ion batteries and other metal ion batteries.

In view of the above, the present inventors have intensively studied on the subject and have found that the problem of irreversible capacity loss due to SEI formation can be solved by the addition of a lithium compound to an aqueous solvent-based cathode slurry, and thereby the cathodes, for lithium-ion batteries, wherein the lithium compound is soluble in the aqueous solvent-based cathode slurry, and decomposes within the operating potential window of the cathode active material. Such a lithium compound is excellent in compensating for the irreversible capacity loss in lithium-ion batteries, and moreover does not increase resistance of the cathode. Therefore, an exceptional battery electrochemical performance is obtained.

The ability of the lithium compound to be soluble in the aqueous solvent-based cathode slurry is important, since this ensures that the lithium compound would be well dispersed within the aqueous solvent-based cathode slurry, ensuring a more even distribution of the lithium compound within the cathode layer when coated, thereby preventing local inconsistencies and inhomogeneities due to unequal lithium ion loss in these areas caused by uneven distribution of the lithium compound in the cathode layer. These local inconsistencies and inhomogeneities could then potentially have led to worsened battery electrochemical performance.

The ability of the lithium compound to decompose within the operating potential window of the cathode active material is also important. In a cathode, the strong ionic interactions between lithium cations and the anions of the lithium compound would mean that mobility of the lithium cations from the lithium compound would be poor if the anions are present. When the cathode is used in a battery, and the battery is cycled, the anions decompose, and this frees the lithium cations from the lithium compound to replenish the lithium ion capacity of the battery.

With both properties, water-solubility and the ability to decompose within the operating potential window of the cathode active material combined, the presence of the lithium compound would also assist in pore formation, and acts to ensure a small and uniform pore size and an even pore distribution is present within the cathode, after the cathode is subjected to initial charging. The small average size of the pores has an additional benefit in providing reduced diffusion pathways for rapid lithium ion transport into the cathode with full utilization of the cathode active material. Similarly, the evenness and uniformness of the pores ensure that local inconsistencies and inhomogeneities do not occur, allowing for efficient electrolyte distribution, and reducing the region(s) of the cathode where lithium ion cannot reach, resulting in full utilization of the cathode and excellent battery electrochemical performance.

The choice of binder is also critical to battery performance. In an aqueous solvent-based cathode slurry, common binders such as PVDF are insoluble. Surfactants may be added to allow for these binders to be dispersed, but the presence of surfactants in the cathode layer may lead to worsened battery electrochemical performance. Therefore, it is a further aim of the invention to disclose a water-compatible copolymer suitable for use as a binder in the aqueous solvent-based cathode slurry disclosed herein. Such a binder would have good dispersion in the aqueous solvent-based cathode slurry. This ensures good binding capability of the binder with the other cathode layer materials, as well as the cathode layer to the current collector when the aqueous solvent-based cathode slurry is coated onto said current collector, and thereby contribute to excellent battery electrochemical performance.

### SUMMARY OF THE INVENTION

The aforementioned needs are met by various aspects and embodiments disclosed herein. In one aspect, provided herein is an aqueous solvent-based cathode slurry for a secondary battery, comprising a cathode active material, a copolymeric binder and a lithium compound in an aqueous solvent. In some embodiments, the copolymeric binder is water-compatible. In another aspect, provided herein is a cathode for a secondary battery, fabricated by coating the aforementioned aqueous solvent-based cathode slurry onto a current collector.

In some embodiments, the lithium compound is soluble in the aqueous solvent-based cathode slurry. In some embodiments, the lithium compound decomposes within the operating potential window of the cathode active material.

The lithium compound serves as a lithium ion source in compensating for the irreversible capacity loss in lithium-ion batteries. The solubility of the lithium compound in the aqueous solvent-based cathode slurry allows for an even distribution of the compound in the coated cathode layer. The decomposition of the lithium compound ensures the mobility of the lithium ions from the lithium compound. As a result, lithium-ion battery cells comprising the cathode prepared using the aqueous solvent-based cathode slurry comprising the lithium compound disclosed herein exhibits exceptional electrochemical performance. Similarly, other metal-ion batteries may use other metal compounds matching their corresponding cell chemistries to provide comparable effect in compensating for the irreversible capacity loss.

### BRIEF DESCRIPTION OF THE DRAWINGS

FIG. 1 is a flow chart of an embodiment illustrating the steps for preparing a cathode via a cathode slurry disclosed herein.

FIG. 2a illustrate the SEM images of the distribution of lithium squarate with cathode active material, NMC811, prepared via an aqueous-solvent based slurry, at 10,000× magnification; FIGS. 2b and 2c illustrate the SEM images of the distribution of lithium squarate with cathode active material, NMC811, prepared using a dry method in which no solvent was involved, at 10,000× magnification and at 400× magnification respectively.

FIGS. 3a and 3b illustrate the SEM images of a cathode surface comprising cathode active material, lithium nickel manganese oxide (LNMO), and lithium oxalate as the lithium compound, wherein the cathode was produced via an aqueous-solvent based slurry, at 1,000× magnification before and after the 1^{st} charge/discharge cycle respectively. FIGS. 3c and 3d illustrate the SEM images of a cathode surface comprising cathode active material, lithium nickel manganese oxide (LNMO), and lithium oxalate as the lithium compound, wherein the cathode was produced via an organic solvent-based slurry, and wherein the organic solvent is more specifically NMP, at 1,000× magnification before and after the 1^{st} charge/discharge cycle respectively.

### DETAILED DESCRIPTION OF THE INVENTION

In one aspect, provided herein is an aqueous solvent-based cathode slurry for a secondary battery, comprising a cathode active material, a copolymeric binder, a lithium compound, and an aqueous solvent. In another aspect, provided herein is a cathode for a secondary battery, wherein the cathode is fabricated by coating the aforementioned aqueous solvent-based cathode slurry onto a current collector.

The term “electrode” refers to a “cathode” or an “anode.”

The term “positive electrode” is used interchangeably with cathode. Likewise, the term “negative electrode” is used interchangeably with anode.

The term “binder” or “binder material” refers to a chemical compound, mixture of compounds, or polymer that is used to hold an electrode material and/or a conductive agent in place and adhere them onto a conductive metal part to form an electrode. In some embodiments, the electrode does not comprise any conductive agent. In some embodiments, the binder material forms a solution or colloid in an aqueous solvent such as water.

The term “conductive agent” refers to a material that has good electrical conductivity. Therefore, the conductive agent is often mixed with an electrode active material at the time of forming an electrode to improve electrical conductivity of the electrode. In some embodiments, the conductive agent is chemically active. In some embodiments, the conductive agent is chemically inactive.

The term “polymer” refers to a polymeric compound prepared by polymerizing monomers, whether of the same or a different type. The generic term “polymer” embraces the terms “homopolymer” as well as “copolymer”.

The term “homopolymer” refers to a polymer prepared by the polymerization of the same type of monomer.

The term “copolymer” refers to a polymer prepared by the polymerization of two or more different types of monomers.

The term “polymeric binder” refers to a binder that is of a polymeric nature. The term “copolymeric binder” then refers to a polymeric binder wherein the binder is specifically a copolymer.

The term “water-compatible” refers to a chemical compound, mixture of compounds, or polymer that is able to be well-dispersed in water to form a solution or colloid. In some embodiments, the colloid is a suspension.

The term “aqueous solvent” refers to a solvent wherein the solvent is water, or wherein the solvent comprises water and one or more minor components, wherein water comprises a majority of the solvent system by weight. In some embodiments, the ratio of water to the sum of minor components in the solvent system is 51:49, 53:47, 55:45, 57:43, 59:41, 61:39, 63:37, 65:35, 67:33, 69:31, 71:29, 73:27, 75:25, 77:23, 79:21, 81:19, 83:17, 85:15, 87:13, 89:11, 91:9, 93:7, 95:5, 97:3, 99:1, or 100:0 by weight, based on the total weight of the solvent system.

The term “solubility ratio” with respect to the lithium compound refers to the ratio of the molar solubility of the lithium compound in the aqueous solvent-based cathode slurry at room temperature to the number of moles of lithium compound per unit volume in the aqueous solvent-based cathode slurry. In some embodiments, when the units of both molar solubility (e.g. mol/L) and moles per unit volume (e.g. also mol/L) are the same, the solubility ratio would be dimensionless. In some embodiments, when the solubility ratio is dimensionless, the solubility ratio should be greater than or equal to 1 in order for the lithium compound present in the aqueous solvent-based cathode slurry to be able to be dissolved. This may be advantageous in achieving a good dispersion of the lithium compound in the aqueous solvent-based cathode slurry.

The term “unsaturated” as used herein, refers to a moiety having one or more units of unsaturation.

The term “alkyl” or “alkyl group” refers to a univalent group having the general formula CₙH₂ₙ₊₁ derived from removing a hydrogen atom from a saturated, unbranched or branched aliphatic hydrocarbon, where n is an integer, or an integer between 1 and 20, or between 1 and 8. Examples of alkyl groups include, but are not limited to, (C₁-C₈)alkyl groups, such as methyl, ethyl, propyl, isopropyl, 2-methyl-1-propyl, 2-methyl-2-propyl, 2-methyl-1-butyl, 3-methyl-1-butyl, 2-methyl-3-butyl, 2,2-dimethyl-1-propyl, 2-methyl-1-pentyl, 3-methyl-1-pentyl, 4-methyl-1-pentyl, 2-methyl-2-pentyl, 3-methyl-2-pentyl, 4-methyl-2-pentyl, 2,2-dimethyl-1-butyl, 3,3-dimethyl-1-butyl, 2-ethyl-1-butyl, butyl, isobutyl, t-butyl, pentyl, isopentyl, neopentyl, hexyl, heptyl, and octyl. Longer alkyl groups include nonyl and decyl groups. An alkyl group can be unsubstituted or substituted with one or more suitable substituents. Furthermore, the alkyl group can be branched or unbranched. In some embodiments, the alkyl group contains at least 2, 3, 4, 5, 6, 7, or 8 carbon atoms.

The term “cycloalkyl” or “cycloalkyl group” refers to a saturated or unsaturated cyclic non-aromatic hydrocarbon radical having a single ring or multiple condensed rings. Examples of cycloalkyl groups include, but are not limited to, (C₃-C₇)cycloalkyl groups, such as cyclopropyl, cyclobutyl, cyclopentyl, cyclohexyl, and cycloheptyl, and saturated cyclic and bicyclic terpenes and (C₃-C₇)cycloalkenyl groups, such as cyclopropenyl, cyclobutenyl, cyclopentenyl, cyclohexenyl, and cycloheptenyl, and unsaturated cyclic and bicyclic terpenes. A cycloalkyl group can be unsubstituted or substituted by one or two suitable substituents. Furthermore, the cycloalkyl group can be monocyclic or polycyclic. In some embodiments, the cycloalkyl group contains at least 5, 6, 7, 8, 9, or 10 carbon atoms.

The term “alkoxy” refers to an alkyl group, as previously defined, attached to the principal carbon chain through an oxygen atom. Some non-limiting examples of the alkoxy group include methoxy, ethoxy, propoxy, butoxy, and the like. And the alkoxy defined above may be substituted or unsubstituted, wherein the substituent may be, but is not limited to, deuterium, hydroxy, amino, halo, cyano, alkoxy, alkyl, alkenyl, alkynyl, mercapto, nitro, and the like.

The term “alkenyl” refers to an unsaturated straight chain, branched chain, or cyclic hydrocarbon radical that contains one or more carbon-carbon double bonds. Examples of alkenyl groups include, but are not limited to, ethenyl, 1-propenyl, and 2-propenyl; and which may optionally be substituted on one or more of the carbon atoms of the radical.

The term “aryl” or “aryl group” refers to an organic radical derived from a monocyclic or polycyclic aromatic hydrocarbon by removing a hydrogen atom. Non-limiting examples of the aryl group include phenyl, naphthyl, benzyl, and tolanyl group; sexiphenylene, phenanthrenyl, anthracenyl, coronenyl, and tolanylphenyl. An aryl group can be unsubstituted or substituted with one or more suitable substituents. Furthermore, the aryl group can be monocyclic or polycyclic. In some embodiments, the aryl group contains at least 6, 7, 8, 9, or 10 carbon atoms.

The term “aliphatic” refers to a C₁ to C₃₀ alkyl group, a C₂ to C₃₀ alkenyl group, a C₂ to C₃₀ alkynyl group, a C₁ to C₃₀ alkylene group, a C₂ to C₃₀ alkenylene group, or a C₂ to C₃₀ alkynylene group. In some embodiments, the alkyl group contains at least 2, 3, 4, 5, 6, 7, or 8 carbon atoms.

The term “aromatic” refers to groups comprising aromatic hydrocarbon rings, optionally including heteroatoms or substituents. Examples of such groups include, but are not limited to, phenyl, tolyl, biphenyl, o-terphenyl, m-terphenyl, p-terphenyl, naphthyl, anthryl, phenanthryl, pyrenyl, triphenylenyl, and derivatives thereof.

The term “substituted” as used to describe a compound or chemical moiety refers to that at least one hydrogen atom of that compound or chemical moiety is replaced with a second chemical moiety. Examples of substituents include, but are not limited to, halogen; alkyl; heteroalkyl; alkenyl; alkynyl; aryl, heteroaryl, hydroxyl; alkoxyl; amino; nitro; thiol; thioether; imine; cyano; amido; phosphonato; phosphine; carboxyl; thiocarbonyl; sulfonyl; sulfonamide; acyl; formyl; acyloxy; alkoxycarbonyl; oxo; haloalkyl (e.g., trifluoromethyl); carbocyclic cycloalkyl, which can be monocyclic or fused or non-fused polycyclic (e.g., cyclopropyl, cyclobutyl, cyclopentyl or cyclohexyl) or a heterocycloalkyl, which can be monocyclic or fused or non-fused polycyclic (e.g., pyrrolidinyl, piperidinyl, piperazinyl, morpholinyl or thiazinyl); carbocyclic or heterocyclic, monocyclic or fused or non-fused polycyclic aryl (e.g., phenyl, naphthyl, pyrrolyl, indolyl, furanyl, thiophenyl, imidazolyl, oxazolyl, isoxazolyl, thiazolyl, triazolyl, tetrazolyl, pyrazolyl, pyridinyl, quinolinyl, isoquinolinyl, acridinyl, pyrazinyl, pyridazinyl, pyrimidinyl, benzimidazolyl, benzothiophenyl or benzofuranyl); amino (primary, secondary or tertiary); o-lower alkyl; o-aryl, aryl; aryl-lower alkyl; —CO₂CH₃; —CONH₂; —OCH₂CONH₂; —NH₂; —SO₂NH₂; —OCHF₂; —CF₃; —OCF₃; —NH(alkyl); —N(alkyl)₂; —NH(aryl); —N(alkyl)(aryl); —N(aryl)₂; —CHO; —CO(alkyl); —CO(aryl); —CO₂(alkyl); and —CO₂(aryl); and such moieties can also be optionally substituted by a fused-ring structure or bridge, for example —OCH₂O—. These substituents can optionally be further substituted with a substituent selected from such groups. All chemical groups disclosed herein can be substituted, unless it is specified otherwise.

The term “halogen” or “halo” refers to F, Cl, Br or I.

The term “structural unit” refers to the total monomeric units contributed by the same monomer type in a polymer.

The term “acid salt group” refers to the acid salt formed when an acid functional group reacts with a base. In some embodiments, the proton of the acid functional group is replaced with a metal cation. In some embodiments, the proton of the acid functional group is replaced with an ammonium ion. In some embodiments, the acid functional group is selected from the group consisting of carboxylic acid, sulfonic acid, and phosphonic acid.

The term “homogenizer” refers to an equipment that can be used for the homogenization of materials. The term “homogenization” refers to a process of distributing the materials uniformly throughout a fluid. Any conventional homogenizers can be used for the method disclosed herein. Some non-limiting examples of the homogenizer include stirring mixers, planetary stirring mixers, blenders and ultrasonicators.

The term “planetary mixer” refers to an equipment that can be used to mix or stir different materials for producing a homogeneous mixture, which consists of blades conducting a planetary motion within a vessel. In some embodiments, the planetary mixer comprises at least one planetary blade and at least one high-speed dispersion blade. The planetary and the high-speed dispersion blades rotate on their own axes and also rotate continuously around the vessel. The rotation speed can be expressed in unit of rotations per minute (rpm) which refers to the number of rotations that a rotating body completes in one minute.

The term “ultrasonicator” refers to an equipment that can apply ultrasound energy to agitate particles in a sample. Any ultrasonicator that can disperse the aqueous solvent-based cathode slurry disclosed herein can be used herein. Some non-limiting examples of the ultrasonicator include an ultrasonic bath, a probe-type ultrasonicator, and an ultrasonic flow cell.

The term “ultrasonic bath” refers to an apparatus through which the ultrasonic energy is transmitted via the container's wall of the ultrasonic bath into the liquid sample.

The term “probe-type ultrasonicator” refers to an ultrasonic probe immersed into a medium for direct sonication. The term “direct sonication” means that the ultrasound is directly coupled into the processing liquid.

The term “ultrasonic flow cell” or “ultrasonic reactor chamber” refers to an apparatus through which sonication processes can be carried out in a flow-through mode. In some embodiments, the ultrasonic flow cell is in a single-pass, multiple-pass, or recirculating configuration.

The term “applying” refers to an act of laying or spreading a substance on a surface.

The term “current collector” refers to any conductive substrate, which is in contact with an electrode layer and is capable of conducting an electrical current flowing to electrodes during discharging or charging a secondary battery. Some non-limiting examples of the current collector include a single conductive metal layer or substrate, and a single conductive metal layer or substrate with an overlying conductive coating layer, such as a carbon black-based coating layer. The conductive metal layer or substrate may be in the form of a foil or a porous body having a three-dimensional network structure, and may be a polymeric or metallic material or a metalized polymer. In some embodiments, the three-dimensional porous current collector is covered with a conformal carbon layer.

The term “electrode layer” refers to a layer, which is in contact with a current collector, that comprises an electrochemically active material. In some embodiments, the electrode layer is made by applying a coating on to the current collector. In some embodiments, the electrode layer is located on the surface of the current collector. In other embodiments, the three-dimensional porous current collector is coated conformally with an electrode layer.

The term “doctor blading” refers to a process for fabrication of large area films on rigid or flexible substrates. A coating thickness can be controlled by an adjustable gap width between a coating blade and a coating surface, which allows the deposition of variable wet layer thicknesses.

The term “slot-die coating” refers to a process for fabrication of large area films on rigid or flexible substrates. A slurry is applied to the substrate by continuously pumping slurry through a nozzle onto the substrate, which is mounted on a roller and constantly fed toward the nozzle. The thickness of the coating is controlled by various methods, such as altering the slurry flow rate or the speed of the roller.

The term “room temperature” refers to indoor temperatures from about 18° C. to about 30° C., e.g., 18, 19, 20, 21, 22, 23, 24, 25, 26, 27, 28, 29, or 30° C. In some embodiments, room temperature refers to a temperature of about 20° C.+/−1° C. or +/−2° C. or +/−3° C. In other embodiments, room temperature refers to a temperature of about 22° C. or about 25° C.

The term “particle size D50” refers to a volume-based accumulative 50% size (D50), which is a particle size at a point of 50% on an accumulative curve (i.e., a diameter of a particle in the 50^{th} percentile (median) of the volumes of particles) when the accumulative curve is drawn so that a particle size distribution is obtained on the volume basis and the whole volume is 100%. Further, with respect to the cathode active material of the present invention, the particle size D50 means a volume-averaged particle size of secondary particles which can be formed by mutual agglomeration of primary particles, and in a case where the particles are composed of the primary particles only, it means a volume-averaged particle size of the primary particles.

The term “particle size D10” refers to a volume-based accumulative 10% size (D10), which is a particle size at a point of 10% on an accumulative curve (i.e., a diameter of a particle in the 10^{th} percentile of the volumes of particles) when the accumulative curve is drawn so that a particle size distribution is obtained on the volume basis and the whole volume is 100%.

The term “particle size D90” refers to a volume-based accumulative 90% size (D90), which is a particle size at a point of 90% on an accumulative curve (i.e., a diameter of a particle in the 90^{th} percentile of the volumes of particles) when the accumulative curve is drawn so that a particle size distribution is obtained on the volume basis and the whole volume is 100%.

The term “solid content” refers to the amount of non-volatile material remaining after evaporation.

The term “peeling strength” refers to the amount of force required to separate two materials that are bonded to each other, such as a current collector and an electrode active material coating. It is a measure of the adhesion strength between such two materials and is usually expressed in N/cm.

The term “C rate” refers to the charging or discharging rate of a cell or battery, expressed in terms of its total storage capacity in Ah or mAh. For example, a rate of 1 C means utilization of all of the stored energy in one hour; a 0.1 C means utilization of 10% of the energy in one hour or full energy in 10 hours; and a 5 C means utilization of full energy in 12 minutes.

The term “ampere-hour (Ah)” refers to a unit used in specifying the storage capacity of a battery. For example, a battery with 1 Ah capacity can supply a current of one ampere for one hour or 0.5 A for two hours, etc. Therefore, 1 ampere-hour (Ah) is the equivalent of 3,600 coulombs of electrical charge. Similarly, the term “milliampere-hour (mAh)” also refers to a unit of the storage capacity of a battery and is 1/1,000 of an ampere-hour.

The term “battery cycle life” refers to the number of complete charge/discharge cycles a battery can perform before its nominal capacity falls below 80% of its initial rated capacity.

The term “capacity” is a characteristic of an electrochemical cell that refers to the total amount of electrical charge an electrochemical cell, such as a battery, is able to hold. Capacity is typically expressed in units of ampere-hours. The term “specific capacity” refers to the capacity output of an electrochemical cell, such as a battery, per unit weight, usually expressed in Ah/kg or mAh/g.

In the following description, all numbers disclosed herein are approximate values, regardless whether the word “about” or “approximate” is used in connection therewith. They may vary by 1 percent, 2 percent, 5 percent, or, sometimes, 10 to 20 percent. Whenever a numerical range with a lower limit, R^{L}, and an upper limit, R^{U}, is disclosed, any number falling within the range is specifically disclosed. In particular, the following numbers within the range are specifically disclosed: R=R^{L}+k*(R^{U}−R^{L}) wherein k is a variable ranging from 0 percent to 100 percent. Moreover, any numerical range defined by two R numbers as defined in the above is also specifically disclosed.

In the present description, all references to the singular include references to the plural and vice versa. In the present description, all references to an “aqueous solvent” may also specifically refer to water in the context of embodiments of this invention that exclusively uses water as the aqueous solvent.

At present, in lithium-ion batteries, lithium intercalation/deintercalation in the anode usually takes place at low potentials vs. Li/Li⁺, where non-aqueous liquid electrolytes are thermodynamically unstable. During initial charging, electrolyte decomposition inevitably occurs in an irreversible manner, leading to the formation of a solid-electrolyte interphase (SEI) over the anode surface. This is beneficial in a sense that the SEI generated can suppress further electrolyte decomposition to give a satisfactory cyclability to lithium-ion batteries. The SEI formation is not, however, favorable with respect to the specific capacity of lithium-ion batteries since a portion of the cathode active material is irreversibly consumed to provide lithium ions for SEI formation on anode. Therefore, various methods to reduce the effect of irreversible capacity loss due to SEI formation have been disclosed.

Currently, cathodes are often prepared by dispersing a cathode active material, a binder material and a conductive agent in an organic solvent such as N-methyl-2-pyrrolidone (NMP) to form a cathode slurry, then coating the cathode slurry onto a current collector and drying it. However, these organic solvents can cause severe environmental damage, and in addition can be toxic and require complicated and specific handling techniques.

Therefore, the use of aqueous solvents is preferred, and aqueous solvent-based slurries have been considered in the present invention. For lithium-ion batteries comprising cathodes manufactured via an aqueous solvent-based cathode slurry, along with suffering from an irreversible lithium ion loss for SEI formation, an additional obstacle is present in that lithium has a tendency to leach out of the cathode active material in the preparation of aqueous solvent-based cathode slurry. As a result, cathodes prepared using an aqueous solvent-based slurry possess a comparatively lower reversible capacity that could participate in further battery operation compared to cathodes prepared using a conventional organic solvent-based slurry. Hence, there has been an urge in formulating a means of compensating lithium ion loss, particularly for an aqueous solvent-based cathode slurry, to increase or maximize the reversible capacity of lithium-ion batteries.

The principal objective of the present invention is to provide an aqueous solvent-based cathode slurry, and thereby a cathode for lithium-ion batteries which reduces or eliminates the irreversible lithium ion loss derived from SEI formation. In response to the above problems, based on the studies of the present invention, it is found that presence of a supplementing lithium compound in the aqueous solvent-based cathode slurry, and therefore the cathode of a lithium battery produced via such an aqueous solvent-based cathode slurry, is capable of compensating for the irreversible lithium ion loss in the lithium-ion battery to achieve an increase in specific capacity of the battery, and thus contribute to remarkable battery electrochemical performance.

The lithium compound applied in the present invention has the following features: (1) it is soluble in the aqueous solvent-based cathode slurry; (2) it undergoes decomposition during initial charging of the assembled battery, within the operating potential window of the cathode active material (most commonly from 3.0 V to 4.7 V) and (3) it has an oxidizable anion that loses electrons upon initial charging.

Generally, the lithium compound exhibits a relatively low electrical conductivity. Thus, the introduction of the non-conductive lithium compound into the cathode is expected to impose an increase in resistance, i.e. interface resistance and composite volume resistivity within the cathode. However, with the lithium compound being soluble in the aqueous solvent-based cathode slurry, it is observed that the lithium compound can be homogeneously distributed within the aqueous solvent-based cathode slurry and unexpectedly, as a result, there is a negligible impact on the interface resistance and composite volume resistivity within the cathode with the incorporation of the lithium compound into the aqueous solvent-based cathode slurry used to produce the cathode. This indicates that the electrical conductivity of aqueous solvent-based cathode slurry remains optimal and thus is likely to facilitate an enhanced battery electrochemical performance.

During initial charging, the lithium compound undergoes decomposition within the operating potential range of the cathode active material to generate lithium ions that can either be consumed immediately for SEI formation or utilized in subsequent cycling of the battery. Therefore, the addition of the lithium compound to an aqueous solvent-based cathode slurry, and hence a cathode manufactured using such an aqueous solvent-based cathode slurry, would be able to compensate for lithium ions lost in initial cycling of a battery comprising the mentioned cathode due to the formation of the SEI.

In some embodiments, the decomposition of the anion of the lithium compound produces gaseous products. With the lithium compound capable of being homogeneously distributed within the aqueous solvent-based cathode slurry of the present invention due to its inherent solubility in aqueous solvent-based cathode slurry, pores formed in cathodes produced using such a cathode slurry due to the release of such gaseous products would have a small and uniform pore size with an even pore distribution. These gaseous products can be evacuated before battery sealing to avoid build-up of pressure within the battery.

Pores in the cathode helps facilitate electrolyte penetration and provide diffusion paths for Li⁺ transport through the electrolyte. The small average pore size within the cathode significantly increases the surface area of the cathode and reduces the diffusion pathways of the lithium ions into the cathode, thereby enabling more effective charge transfer across the cathode-electrolyte interface. The resulting uniform pore size within the cathode provides an optimal open volume for mass transport and permits efficient electrolyte distribution. An even pore distribution in the cathode reduces the region(s) of the cathode where lithium ion cannot reach and results in full utilization of the cathode.

Accordingly, the function of the present invention is to ensure that a cathode, produced via a cathode slurry of the present invention, yields a morphological structure of a small and uniform pore size with an even pore distribution after undergoing initial charging, which can ensure improved insertion and extraction of lithium ions with reduced diffusion pathways, and lead to an enhanced electrochemical performance.

Conversely, the aforementioned improvements are not achievable by cathodes prepared via an organic-solvent based slurry, for example a slurry that uses NMP as a solvent, since the lithium compound tends to form clusters and is unevenly distributed within the cathode slurry due the insolubility of the lithium compound in non-aqueous solvents. As a result, a relatively larger and variable pore size with an uneven pore distribution within the cathode structure are formed upon initial charging. Thus, pores can be concentrated in some regions and absent in some other regions. The uneven pore distribution may result in the constrained utilization of cathode active material. This may cause an overuse of some specific regions and put a constraint on the full utilization of cathode active material present in the cathode, lowering the specific capacity of the cathode. Indeed, it has been found that the lithium compound-containing cathode prepared by an organic solvent-based slurry induces an upsurge in resistances within the cathode, up to at least 4 times of the resistances of a comparable cathode prepared by an organic solvent-based slurry where no lithium compound has been incorporated. No improvement in electrochemical properties of batteries comprising cathodes prepared by an organic solvent-based slurry comprising a lithium compound, was observed.

Accordingly, the present invention provides a method of preparing a cathode slurry, comprising a cathode active material, a copolymeric binder, a lithium compound and an aqueous solvent. Such a cathode slurry can then be coated onto a current collector to form a cathode. Addition of the lithium compound to the aqueous solvent-based cathode slurry, and hence cathode, of the present invention has the combined effects of sustaining consistently low resistances within the cathode, and providing a lithium ion source for compensating irreversible capacity loss. Furthermore, the cathodes fabricated using the cathode slurry disclosed were found to have a small and uniform pore size with an even pore distribution after undergoing initial charging. As a result, the reversible capacity and hence cycling performance of lithium-ion batteries comprising cathodes produced using an aqueous solvent-based cathode slurry of the present invention is considerably improved.

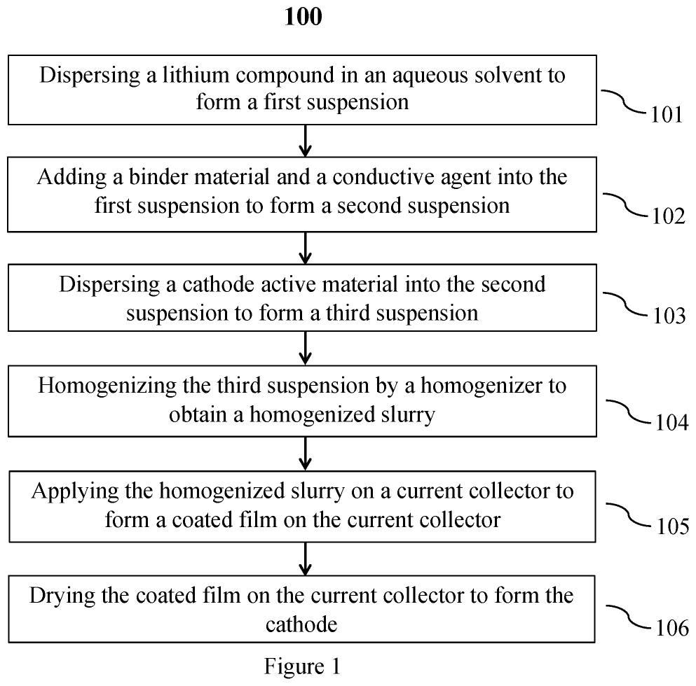

FIG. 1 is a flow chart of an embodiment illustrating the steps of method 100 for preparing a cathode using a cathode slurry disclosed herein. In some embodiments, the cathode slurry is an aqueous solvent-based cathode slurry. In some embodiments, the aqueous solvent-based cathode slurry is first formed by dispersing a lithium compound in an aqueous solvent in step 101 to form a first suspension.

In some embodiments, the aqueous solvent is water. In such embodiments, since the composition of the aqueous solvent-based cathode slurry does not contain any organic solvent, expensive and specific handling of organic solvents is avoided during manufacture of cathode slurries. In some embodiments, the aqueous solvent is selected from the group consisting of tap water, bottled water, purified water, pure water, distilled water, de-ionized water (DI water), D₂O, and combinations thereof.

In some embodiments, the aqueous solvent is a solution containing water as the major component and a volatile solvent as the minor component in addition to water. Examples of such volatile solvents include, but are not limited to, alcohols, lower aliphatic ketones, lower alkyl acetates, and the like. Although such volatile solvents are organic solvents, transition to using an aqueous solvent-based slurry to produce battery cathodes may be desirable in reducing emissions of volatile organic compounds and increasing processing efficiency. In some embodiments, the proportion of water in the aqueous solvent is from about 51% to about 100%, from about 51% to about 95%, from about 51% to about 90%, from about 51% to about 85%, from about 51% to about 80%, from about 51% to about 75%, from about 51% to about 70%, from about 55% to about 100%, from about 55% to about 95%, from about 55% to about 90%, from about 55% to about 85%, from about 55% to about 80%, from about 60% to about 100%, from about 60% to about 95%, from about 60% to about 90%, from about 60% to about 85%, from about 60% to about 80%, from about 65% to about 100%, from about 65% to about 95%, from about 65% to about 90%, from about 65% to about 85%, from about 70% to about 100%, from about 70% to about 95%, from about 70% to about 90%, from about 70% to about 85%, from about 75% to about 100%, from about 75% to about 95% or from about 80% to about 100% by weight.

In some embodiments, the proportion of water in the aqueous solvent is more than 50%, more than 55%, more than 60%, more than 65%, more than 70%, more than 75%, more than 80%, more than 85%, more than 90% or more than 95% by weight. In some embodiments, the proportion of water in the aqueous solvent is less than 55%, less than 60%, less than 65%, less than 70%, less than 75%, less than 80%, less than 85%, less than 90% or less than 95% by weight. In some embodiments, the aqueous solvent consists solely of water, that is, the proportion of water in the aqueous solvent is 100% by weight.

Any water-miscible solvents or volatile solvents can be used as the minor component (i.e. solvents other than water) of the aqueous solvent. Some non-limiting examples of the water-miscible solvents or volatile solvents include alcohols, lower aliphatic ketones, lower alkyl acetates, and combinations thereof. The addition of alcohol can improve the processability of the slurry formed therefrom and lower the freezing point of water. Some non-limiting examples of the alcohol include C₁-C₄ alcohols, such as methanol, ethanol, isopropanol, n-propanol, tert-butanol, n-butanol, and combinations thereof. Some non-limiting examples of the lower aliphatic ketones include acetone, dimethyl ketone, methyl ethyl ketone (MEK), and combinations thereof. Some non-limiting examples of the lower alkyl acetates include ethyl acetate (EA), isopropyl acetate, propyl acetate, butyl acetate (BA), and combinations thereof.

In some embodiments, the weight ratio of water and the minor component is from about 51:49 to about 99:1, from about 53:47 to about 99:1, from about 55:45 to about 99:1, from about 57:43 to about 99:1, from about 59:41 to about 99:1, from about 61:39 to about 99:1, from about 61:39 to about 98:2, from about 61:39 to about 96:4, from about 61:39 to about 94:6, from about 61:39 to about 92:8, from about 61:39 to about 90:10, from about 63:37 to about 90:10, from about 65:35 to about 90:10, from about 67:33 to about 90:10, from about 69:31 to about 90:10, from about 71:29 to about 90:10, from about 71:29 to about 88:12, from about 71:29 to about 86:14, from about 71:29 to about 84:16, from about 71:29 to about 82:18, or from about 71:29 to about 80:20. In some embodiments, the weight ratio of water and the minor component is less than 100:1, less than 95:5, less than 90:10, less than 85:15, less than 80:20, less than 75:25, less than 70:30, less than 65:35, less than 60:40 or less than 55:45. In some embodiments, the weight ratio of water and the minor component is more than 55:45, more than 60:40, more than 65:35, more than 70:30, more than 75:25, more than 80:20, more than 85:15, more than 90:10, or more than 95:5. In some embodiments, the aqueous solvent does not comprise a minor component.

In certain embodiments, the lithium compound is a compound represented by Chemical Formula (1):

[A⁺]ₐB^{a-} (1)

wherein the cation A⁺ is Li⁺, a is an integer from 1 to 10, and the anion B^{a-} is an oxidizable anion.

In some embodiments, the anion B^{a-} represents any anion that can lose electron(s) when subjected to electrochemical potentials. In certain embodiments, the anion B^{a-} is an oxidizable anion selected from the group consisting of azide anion, nitrite anion, chloride anion, deltate anion, squarate anion, croconate anion, rhodizonate anion, ketomalonate anion, diketosuccinate anion, hydrazide anion, and combinations thereof. In some embodiments, the anion B′ is an oxocarbon anion.

In certain embodiments, the lithium compound is selected from the group consisting of lithium azide (LiN₃), lithium nitrite (LiNO₂), lithium chloride (LiCl), lithium deltate (Li₂C₃O₃), lithium squarate (Li₂C₄O₄), lithium croconate (Li₂C₅O₅), lithium rhodizonate (Li₂C₆O₆), lithium ketomalonate (Li₂C₃O₅), lithium diketosuccinate (Li₂C₄O₆), lithium hydrazide, lithium fluoride (LiF), lithium bromide (LiBr), lithium iodide (LiI), lithium sulfite (Li₂SO₃), lithium selenite (Li₂SeO₃), lithium nitrate (LiNO₃), lithium acetate (CH₃COOLi), lithium salt of 3,4-dihydroxybenzoic acid (Li₂DHBA), lithium salt of 3,4-dihydroxybutyric acid, lithium formate, lithium hydroxide (LiOH), lithium dodecyl sulfate, lithium succinate, lithium citrate, and combinations thereof.

In some embodiments, the lithium compound is selected from the group of lithium salts of organic acids RCOOLi, wherein R is an alkyl, benzyl or aryl group; lithium salts of organic acid bearing more than one carboxylic acid group such as oxalic acid, citric acid, fumaric acid, and the like; and lithium salts of carboxyl multi-substituted benzene ring such as trimellitic acid, 1,2,4,5-benzenetetracarboxylic acid, mellitic acid, and the like.

In certain embodiments, the lithium compound is a compound represented by

Chemical Formula (2):

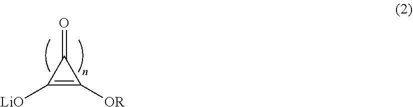

wherein n is an integer from 1 to 5, and R represents lithium (Li) or hydrogen (H).

In certain embodiments, the lithium compound is a compound represented by Chemical Formula (3):

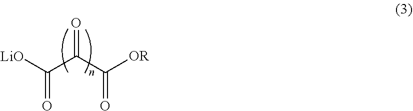

wherein n is an integer from 1 to 5, and R represents lithium (Li) or hydrogen (H).

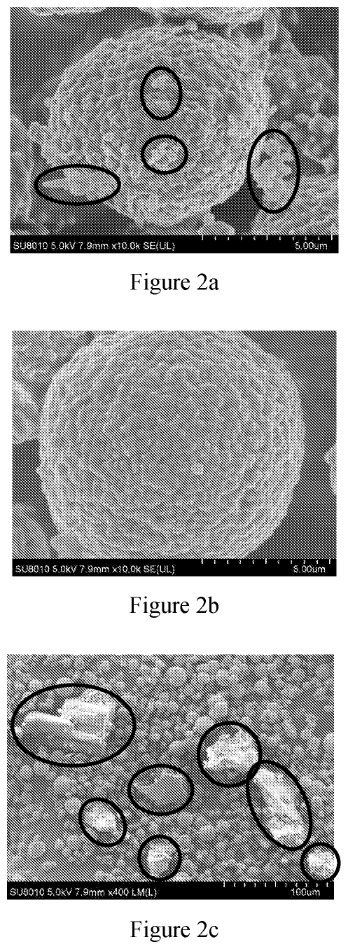

FIG. 2a depicts the distribution of lithium squarate with cathode active material, NMC811, prepared via an aqueous solvent-based slurry, at 10,000× magnification; whereas FIGS. 2b and 2c depict the distribution of lithium squarate with cathode active material, NMC811, prepared using a dry method in which no solvent was involved, at 10,000× magnification and at 400× magnification respectively. From the figures, it can be seen that the cathode active material particles have a diameter in the order of magnitude of 10 μm. In the mixture prepared via an aqueous solvent-based slurry, shown in FIG. 2a, the lithium squarate, being soluble in aqueous solvent, is well-dispersed among the cathode active material. More specifically, small grains of the lithium squarate with the length in the order of magnitude of 1 μm can be seen attached onto the cathode active material particles. This is not observed in the mixture prepared in the absence of a solvent, as shown in FIG. 2b. Instead, at a lower magnification, shown in FIG. 2c, it can be seen that the lithium squarate aggregates significantly and cannot be dispersed properly in the mixture in the absence of a solvent, forming flakes in the mixture with length in the tens of microns, with some flakes even having a length in the order of magnitude of 100 μm. This shows that the lithium compounds in the aqueous solvent-based cathode slurry, and therefore cathode, of the present invention do not agglomerate and maintain a high and stable level of dispersion. This not only aids the cathode made therefrom in maintaining a high electrical conductivity, but also ensures that pores with a small and uniform size are formed within the cathode during initial charging with an even distribution, improving the electrochemical performance of the lithium-ion batteries.

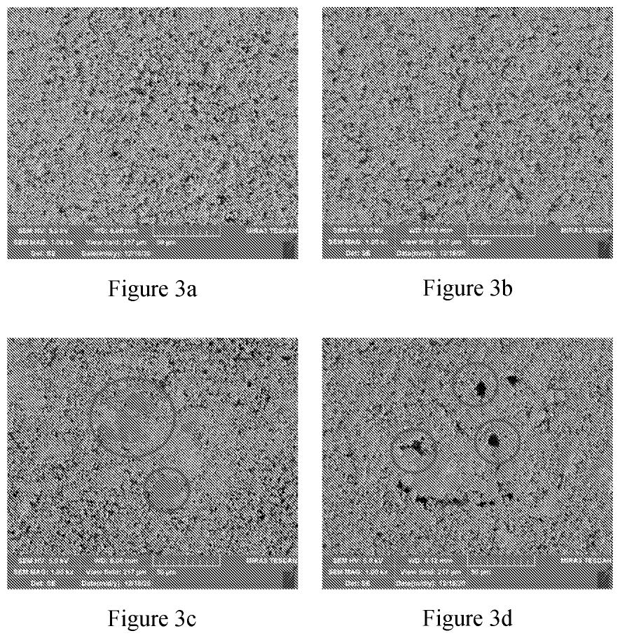

FIGS. 3a and 3b depict the cathode surface morphology via SEM at 1,000× magnification, with the cathode comprising cathode active material, lithium nickel manganese oxide (LNMO), as well as a lithium compound, lithium oxalate, and the cathode was prepared via an aqueous solvent-based slurry. More specifically, FIG. 3a depicts the morphology of the surface before cycling, while FIG. 3b depicts the morphology of the surface following the 1ₛₜ charge/discharge cycle. As shown, before cycling, the surface is rather homogenous, and following initial cycling, small, evenly distributed pores can be seen on the surface. This shows that the aqueous solvent-based cathode slurry as disclosed by this invention is very well dispersed, and therefore forms a cathode with excellent uniformity.

FIGS. 3c and 3d depict the cathode surface morphology via SEM at 1,000× magnification, with the cathode comprising cathode active material, lithium nickel manganese oxide (LNMO), as well as a lithium compound, lithium oxalate, and the cathode was prepared via an organic solvent-based slurry, where the solvent was NMP. More specifically, FIG. 3c depicts the morphology of the surface before cycling, while FIG. 3d depicts the morphology of the surface following the 1^{st} charge/discharge cycle. As shown, before cycling, the lithium compound tends to agglomerate and a homogeneous distribution of the lithium compound was not achieved. This is due to the insolubility of the lithium compound in organic solvents, resulting in poor dispersion of the cathode slurry materials within the NMP solvent. Following initial cycling, a relatively large and variable pore size with an uneven pore distribution in the cathode can be seen, and this shows that the usage of an organic solvent slurry to form such a cathode slurry leads to poor cathode uniformity.

Considerable increases in resistances within the cathode is resulted, up to at least 4 times the resistances compared where no lithium compound has been incorporated (Comparative Example 5 as compared to Comparative Example 6), when a slurry primarily using an organic solvent (such as NMP) as solvent was used to prepare the cathode. This substantially lowers the electrical conductivity of the cathode. With regions where lithium ions are more difficult to be reached or extracted, full utilization of cathode active material cannot be realized, the specific capacity of the cathode is subsequently reduced, and the electrochemical performance of the batteries is impaired.

For the above-mentioned reasons, the presence of the lithium compound in cathodes prepared using a dry method or via an organic solvent-based cathode slurry is not recommended. Instead, an aqueous solvent-based cathode slurry is particularly recommended for the production of a cathode layer incorporating a lithium compound.

Many of the lithium compounds are hygroscopic in nature or even supplied in the form of aqueous solutions. For conventional manufacturing methods of cathodes using slurries primarily using organic solvents such as NMP as solvent, use of such lithium compounds often requires an additional drying process for water removal. However, when aqueous solvent-based slurries are used to produce cathodes as in the present invention, the lithium compound can simply be dissolved in an aqueous solvent such as water and homogenously distributed with cathode active material and binder material (and conductive agent).

Being soluble in the aqueous solvent-based cathode slurry, the lithium compound dissolves, forming lithium cations and anions contained therein. When the lithium ion concentration of the lithium compound present in the aqueous solvent-based cathode slurry is less than that of required to completely eliminate the irreversible lithium ion loss, the irreversible capacity loss is only reduced. In the case where the lithium ions concentration of the lithium compound present in the aqueous solvent-based cathode slurry is more than that of required, the additional lithium ions are deemed superfluous since they would be incapable of taking part in the electrochemical reactions due to the full occupancy of the lattice structures in holding lithium ions. Lithium plating on the anode may also occur, which would lead to reduced battery electrochemical performance. Furthermore, with sustained plating, lithium dendrites can be formed, which is highly dangerous since this could lead to short circuiting if the dendrites contact the cathode, and should be avoided by all means.

The lithium ion concentration from the lithium compound in the aqueous solvent-based cathode slurry of the present invention not only affects the extent of replenishment of lithium ion loss for SEI formation during initial charging, but also governs the porosity of the cathode after undergoing first charging. During initial charging, the lithium compound undergoes decomposition, and forms pores within the cathode structure. An increase in lithium ion concentration from the lithium compound in the aqueous solvent-based cathode slurry inevitably drives an increase in concentration of anions, and hence more pores are formed within the cathode structure after initial charging, giving rise to a higher porosity.

A cathode structure with a higher porosity provides a significantly increased surface area of the cathode and improves the efficiency of electrolyte diffusion in the cathode. However, increased cathode porosity would result in decreased electrical conductivity within the cathode. Thus, there exists limitations in the lithium ion concentration from the lithium compound of the cathode slurry.

The lithium ion (Li⁺) concentration from the lithium compound in the aqueous solvent-based cathode slurry should be sufficient and approximately equivalent to the amount of irreversible lithium ions lost by the cathode active material of the cathode for SEI formation during initial charging.

In some embodiments, the lithium ion concentration from the lithium compound in the aqueous solvent-based cathode slurry is from about 0.005 M to about 3.5 M, from about 0.01 M to about 3.5 M, from about 0.02 M to about 3.5 M, from about 0.05 M to about 3.5 M, from about 0.1 M to about 3.5 M, from about 0.2 M to about 3.5 M, from about 0.3 M to about 3.5 M, from about 0.5 M to about 3.5 M, from about 0.7 M to about 3.5 M, from about 0.9 M to about 3.5 M, from about 0.9 M to about 3.25 M, from about 0.9 M to about 3 M, from about 0.9 M to about 2.75 M, from about 0.9 M to about 2.5 M, from about 0.9 M to about 2.25 M, from about 0.9 M to about 2 M, from about 0.9 M to about 1.75 M, from about 0.9 M to about 1.5 M, from about 0.9 M to about 1.3 M, from about 0.005 M to about 2.5 M, from about 0.01 M to about 2.5 M, from about 0.02 M to about 2.5 M, from about 0.05 M to about 2.5 M, from about 0.1 M to about 2.5 M, from about 0.2 M to about 2.5 M, from about 0.3 M to about 2.5 M, from about 0.5 M to about 2.5 M, from about 0.7 M to about 2.5 M, from about 0.005 M to about 2 M, from about 0.01 M to about 2 M, from about 0.02 M to about 2 M, from about 0.05 M to about 2 M, from about 0.1 M to about 2 M, from about 0.2 M to about 2 M, from about 0.3 M to about 2 M, from about 0.5 M to about 2 M, or from about 0.7 M to about 2 M.

In some embodiments, the lithium ion concentration from the lithium compound in the aqueous solvent-based cathode slurry is less than 3.5 M, less than 3.25 M, less than 3 M, less than 2.75 M, less than 2.5 M, less than 2.25 M, less than 2 M, less than 1.75 M, less than 1.5 M, less than 1.3 M, less than 1.1 M, less than 0.9 M, less than 0.7 M, less than 0.5 M, less than 0.3 M, less than 0.2 M, or less than 0.1 M. In some embodiments, the lithium ion concentration from the lithium compound in the aqueous solvent-based cathode slurry is more than 0.005 M, more than 0.01 M, more than 0.02 M, more than 0.05 M, more than 0.1 M, more than 0.2 M, more than 0.3 M, more than 0.5 M, more than 0.7 M, more than 0.9 M, more than 1.1 M, more than 1.3 M, more than 1.5 M, more than 1.75 M, more than 2 M, more than 2.25 M, or more than 2.5 M.

As described, it is important for the lithium compound to be soluble in the aqueous solvent-based cathode slurry, since this ensures good distribution of the lithium compound in the cathode layer. In some embodiments, the units of both molar solubility (e.g. mol/L) and moles per unit volume (e.g. also mol/L) are the same, and therefore the solubility ratio would be dimensionless. In some embodiments, the dimensionless solubility ratio of the lithium compound is from about 4000 to about 1, from about 3500 to about 1, from about 3000 to about 1, from about 2500 to about 1, from about 2000 to about 1, from about 1500 to about 1, from about 1250 to about 1, from about 1000 to about 1, from about 750 to about 1, from about 500 to about 1, from about 400 to about 1, from about 300 to about 1, from about 200 to about 1, from about 100 to about 1, from about 75 to about 1, from about 50 to about 1, from about 25 to about 1, from about 1000 to about 10, from about 1000 to about 15, from about 1000 to about 20, from about 1000 to about 25, from about 1000 to about 50, from about 1000 to about 75, from about 1000 to about 100, from about 1000 to about 200, from about 1000 to about 300, from about 1000 to about 400, from about 1000 to about 500, from about 1000 to about 750, from about 200 to about 2, from about 200 to about 5, from about 200 to about 10, from about 200 to about 15, from about 200 to about 20, from about 200 to about 25, from about 200 to about 50, from about 200 to about 75, or from about 200 to about 100.

In some embodiments, the dimensionless solubility ratio of the lithium compound is more than 1, more than 2, more than 5, more than 10, more than 15, more than 20, more than 25, more than 50, more than 75, more than 100, more than 200, more than 300, more than 400, more than 500, more than 750, more than 1000, more than 1250, more than 1500, or more than 2000. In some embodiments, the dimensionless solubility ratio of the lithium compound is less than 4000, less than 3500, less than 3000, less than 2500, less than 2000, less than 1500, less than 1250, less than 1000, less than 750, less than 500, less than 400, less than 300, less than 200, less than 100, less than 75, less than 50, less than 25, less than 20, or less than 15.

As described, it is also important that the lithium compound decomposes within the operating potential window of the cathode active material. This ensures that the lithium cations in the lithium compound can be released to increase the lithium ion capacity of a battery comprising a cathode, wherein the cathode comprises such a lithium compound. Table 1 shows the decomposition voltages of some lithium compounds embodied by this invention. In some embodiments, the decomposition voltage of the lithium compound is from about 3.0 V to about 5.0 V, from about 3.1 V to about 5.0 V, from about 3.2 V to about 5.0 V, from about 3.2 V to about 4.9 V, from about 3.2 V to about 4.8 V, from about 3.2 V to about 4.7 V, from about 3.2 V to about 4.6 V, from about 3.2 V to about 4.5 V, from about 3.2 V to about 4.4 V, from about 3.2 V to about 4.3 V, from about 3.2 V to about 4.2 V, from about 3.3 V to about 4.2 V, from about 3.4 V to about 4.2 V, from about 3.5 V to about 4.5 V, or from about 3.6 V to about 4.8 V.

In some embodiments, the decomposition voltage of the lithium compound is more than 3.0 V, more than 3.1 V, more than 3.2 V, more than 3.3 V, more than 3.4 V, more than 3.5 V, more than 3.6 V, more than 3.7 V, more than 3.8 V, more than 3.9 V, more than 4.0 V, more than 4.1 V, or more than 4.2 V. In some embodiments, the decomposition voltage of the lithium compound is less than 5.0 V, less than 4.9 V, less than 4.8 V, less than 4.7 V, less than 4.6 V, less than 4.5 V, less than 4.4 V, less than 4.3 V, less than 4.2 V, less than 4.1 V, less than 4.0 V, less than 3.9 V, less than 3.8 V, less than 3.7 V, less than 3.6 V, or less than 3.5 V.

The lithium ion concentration can be controlled by varying the concentration of the lithium compound in the aqueous solvent-based cathode slurry, as well as by choosing the lithium compound used, since one formula unit of a lithium compound containing multiple lithium ions would produce multiple units of lithium ions. The amount of the lithium compound in the aqueous solvent-based cathode slurry of the present invention has a direct influence on the extent of compensation of lithium ion loss resulting from SEI formation during initial charging of batteries, and hence critically impacts battery performance.

In certain embodiments, the proportion of the lithium compound in the first suspension is from about 0.01% to about 40%, from about 0.025% to about 40%, from about 0.05% to about 40%, from about 0.1% to about 40%, from about 0.25% to about 40%, from about 0.5% to about 40%, from about 1% to about 40%, from about 2% to about 40%, from about 4% to about 40%, from about 4% to about 35%, from about 4% to about 30%, from about 4% to about 25%, from about 4% to about 20%, from about 4% to about 15%, from about 4% to about 10%, from about 4% to about 8%, or from about 4% to about 6% by weight, based on the total weight of the first suspension.

In some embodiments, the proportion of the lithium compound in the first suspension is less than 40%, less than 35%, less than 30%, less than 25%, less than 20%, less than 15%, less than 10%, less than 8%, less than 6%, less than 4%, less than 2%, less than 1%, less than 0.5%, or less than 0.25% by weight, based on the total weight of the first suspension. In some embodiments, the proportion of the lithium compound in the first suspension is more than 0.01%, more than 0.025%, more than 0.05%, more than 0.1%, more than 0.25%, more than 0.5%, more than 1%, more than 2%, more than 4%, more than 6%, more than 8%, more than 10%, more than 15%, or more than 20% by weight, based on the total weight of the first suspension.

In some embodiments, the concentration of the lithium compound in the aqueous solvent-based cathode slurry is from about 0.005 M to about 2 M, from about 0.01 M to about 2 M, from about 0.02 M to about 2 M, from about 0.05 M to about 2 M, from about 0.1 M to about 2 M, from about 0.15 M to about 2 M, from about 0.2 M to about 2 M, from about 0.25 M to about 2 M, from about 0.3 M to about 2 M, from about 0.3 M to about 1.8 M, from about 0.3 M to about 1.6 M, from about 0.3 M to about 1.4 M, from about 0.3 M to about 1.2 M, from about 0.3 M to about 1 M, from about 0.3 M to about 0.8 M, from about 0.3 M to about 0.6 M, or from about 0.3 M to about 0.5 M.

In some embodiments, the concentration of the lithium compound in the aqueous solvent-based cathode slurry is less than 2 M, less than 1.8 M, less than 1.6 M, less than 1.4 M, less than 1.2 M, less than 1 M, less than 0.8 M, less than 0.6 M, less than 0.5 M, less than 0.4 M, less than 0.3 M, less than 0.25 M, less than 0.2 M, less than 0.15 M, less than 0.1 M, less than 0.05 M, or less than 0.02 M. In some embodiments, the concentration of the lithium compound in the aqueous solvent-based cathode slurry is more than 0.005 M, more than 0.01 M, more than 0.02 M, more than 0.05 M, more than 0.1 M, more than 0.15 M, more than 0.2 M, more than 0.25 M, more than 0.3 M, more than 0.4 M, more than 0.5 M, more than 0.6 M, more than 0.8 M, more than 1 M, more than 1.2 M, more than 1.4 M, or more than 1.6 M.

In some embodiments, the first suspension is stirred at a speed of from about 10 rpm to about 600 rpm, from about 50 rpm to about 600 rpm, from about 100 rpm to about 600 rpm, from about 150 rpm to about 600 rpm, from about 200 rpm to about 600 rpm, from about 250 rpm to about 600 rpm, from about 300 rpm to about 600 rpm, from about 300 rpm to about 550 rpm, from about 320 rpm to about 550 rpm, from about 340 rpm to about 550 rpm, from about 360 rpm to about 550 rpm, from about 380 rpm to about 550 rpm or from about 400 rpm to about 550 rpm.

In some embodiments, the first suspension is stirred at a speed of less than 600 rpm, less than 550 rpm, less than 500 rpm, less than 450 rpm, less than 400 rpm, less than 350 rpm, less than 300 rpm, less than 250 rpm, less than 200 rpm, less than 150 rpm, less than 100 rpm or less than 50 rpm. In some embodiments, the first suspension is stirred at a speed of more than 10 rpm, more than 50 rpm, more than 100 rpm, more than 150 rpm, more than 200 rpm, more than 250 rpm, more than 300 rpm, more than 350 rpm, more than 400 rpm, more than 450 rpm, more than 500 rpm or more than 550 rpm.

In some embodiments, the second suspension is formed by adding a binder into the first suspension in step 102. In some embodiments, the binder is a copolymeric binder. In some embodiments, the binder is a water-compatible copolymeric binder. In some embodiments, the second suspension further comprises a conductive agent.

The water-compatible copolymeric binder has excellent adhesion capacity, allowing the cathode layer to be strongly adhered to the current collector. More importantly, the water-compatible copolymeric binder, as its name suggests, is well dispersed in the aqueous solvent-based cathode slurry, ensuring good binding ability of the binder to the various cathode layer materials. The good binding ability of the water-compatible copolymeric binder to the various cathode layer materials results in reduced interfacial resistance between the various components of the cathode layer, thereby ensuring good ionic and electrical conductivity of the cathode layer. Good dispersion and binding ability of the water-compatible copolymeric binder in the aqueous solvent-based cathode slurry would therefore also reduce capacity loss due to uneven distribution of cathode layer components within the cathode layer, and ensures even lithiation of the cathode layer by the lithium compound throughout the entirety of the cathode layer. The good dispersion of the water-compatible copolymeric binder in the aqueous solvent-based cathode slurry also ensures a smooth and even coating of the slurry onto the current collector when producing a cathode, thereby reducing capacity loss due to roughness of the cathode. Therefore, the choice of binder used in a cathode slurry is critical to the electrochemical and mechanical performance of a battery comprising a cathode produced via such a slurry. When a water-compatible copolymeric binder is used in an aqueous solvent-based cathode slurry, batteries comprising a cathode produced via such a slurry have superb electrochemical and mechanical performance, particularly compared to binders that are not water compatible, as well as binders that are water compatible but not copolymeric in nature.

In some embodiments, the water-compatible copolymeric binder comprises a structural unit (a), wherein structural unit (a) is derived from a monomer selected from the group consisting of a carboxylic acid group-containing monomer, a carboxylic acid salt group-containing monomer, a sulfonic acid group-containing monomer, a sulfonic acid salt group-containing monomer, a phosphonic acid group-containing monomer, a phosphonic acid salt group-containing monomer, and combinations thereof. In some embodiments, an acid salt group is a salt of an acid group. In some embodiments, an acid salt group-containing monomer comprises an alkali metal cation. Examples of an alkali metal forming the alkali metal cation include lithium, sodium, and potassium. In some embodiments, an acid salt group-containing monomer comprises an ammonium cation. In some embodiments, structural unit (a) may be derived from a combination of a monomer containing a salt group and a monomer containing an acid group.

In some embodiments, the carboxylic acid group-containing monomer is acrylic acid, methacrylic acid, crotonic acid, 2-butyl crotonic acid, cinnamic acid, maleic acid, maleic anhydride, fumaric acid, itaconic acid, itaconic anhydride, tetraconic acid, or combinations thereof. In certain embodiments, the carboxylic acid group-containing monomer is 2-ethylacrylic acid, isocrotonic acid, cis-2-pentenoic acid, trans-2-pentenoic acid, angelic acid, tiglic acid, 3,3-dimethyl acrylic acid, 3-propyl acrylic acid, trans-2-methyl-3-ethyl acrylic acid, cis-2-methyl-3-ethyl acrylic acid, 3-isopropyl acrylic acid, trans-3-methyl-3-ethyl acrylic acid, cis-3-methyl-3-ethyl acrylic acid, 2-isopropyl acrylic acid, trimethyl acrylic acid, 2-methyl-3,3-diethyl acrylic acid, 3-butyl acrylic acid, 2-butyl acrylic acid, 2-pentyl acrylic acid, 2-methyl-2-hexenoic acid, trans-3-methyl-2-hexenoic acid, 3-methyl-3-propyl acrylic acid, 2-ethyl-3-propyl acrylic acid, 2,3-diethyl acrylic acid, 3,3-diethyl acrylic acid, 3-methyl-3-hexyl acrylic acid, 3-methyl-3-tert-butyl acrylic acid, 2-methyl-3-pentyl acrylic acid, 3-methyl-3-pentyl acrylic acid, 4-methyl-2-hexenoic acid, 4-ethyl-2-hexenoic acid, 3-methyl-2-ethyl-2-hexenoic acid, 3-tert-butyl acrylic acid, 2,3-dimethyl-3-ethyl acrylic acid, 3,3-dimethyl-2-ethyl acrylic acid, 3-methyl-3-isopropyl acrylic acid, 2-methyl-3-isopropyl acrylic acid, trans-2-octenoic acid, cis-2-octenoic acid, trans-2-decenoic acid, α-acetoxyacrylic acid, β-trans-aryloxyacrylic acid, α-chloro-β-E-methoxyacrylic acid, or combinations thereof. In some embodiments, the carboxylic acid group-containing monomer is methyl maleic acid, dimethyl maleic acid, phenyl maleic acid, bromo maleic acid, chloromaleic acid, dichloromaleic acid, fluoromaleic acid, difluoro maleic acid, nonyl hydrogen maleate, decyl hydrogen maleate, dodecyl hydrogen maleate, octadecyl hydrogen maleate, fluoroalkyl hydrogen maleate, or combinations thereof. In some embodiments, the carboxylic acid group-containing monomer is maleic anhydride, methyl maleic anhydride, dimethyl maleic anhydride, acrylic anhydride, methacrylic anhydride, methacrolein, methacryloyl chloride, methacryloyl fluoride, methacryloyl bromide, or combinations thereof.

In some embodiments, the carboxylic acid salt group-containing monomer is acrylic acid salt, methacrylic acid salt, crotonic acid salt, 2-butyl crotonic acid salt, cinnamic acid salt, maleic acid salt, maleic anhydride salt, fumaric acid salt, itaconic acid salt, itaconic anhydride salt, tetraconic acid salt, or combinations thereof. In certain embodiments, the carboxylic salt group-containing monomer is 2-ethylacrylic acid salt, isocrotonic acid salt, cis pentenoic acid salt, trans-2-pentenoic acid salt, angelic acid salt, tiglic acid salt, 3,3-dimethyl acrylic acid salt, 3-propyl acrylic acid salt, trans-2-methyl-3-ethyl acrylic acid salt, cis-2-methyl-3-ethyl acrylic acid salt, 3-isopropyl acrylic acid salt, trans-3-methyl-3-ethyl acrylic acid salt, cis-3-methyl-3-ethyl acrylic acid salt, 2-isopropyl acrylic acid salt, trimethyl acrylic acid salt, 2-methyl-3,3-diethyl acrylic acid salt, 3-butyl acrylic acid salt, 2-butyl acrylic acid salt, 2-pentyl acrylic acid salt, 2-methyl-2-hexenoic acid salt, trans-3-methyl-2-hexenoic acid salt, 3-methyl-3-propyl acrylic acid salt, 2-ethyl-3-propyl acrylic acid salt, 2,3-diethyl acrylic acid salt, 3,3-diethyl acrylic acid salt, 3-methyl-3-hexyl acrylic acid salt, 3-methyl-3-tert-butyl acrylic acid salt, 2-methyl-3-pentyl acrylic acid salt, 3-methyl-3-pentyl acrylic acid salt, 4-methyl-2-hexenoic acid salt, 4-ethyl-2-hexenoic acid salt, 3-methyl-2-ethyl-2-hexenoic acid salt, 3-tert-butyl acrylic acid salt, 2,3-dimethyl-3-ethyl acrylic acid salt, 3,3-dimethyl-2-ethyl acrylic acid salt, 3-methyl-3-isopropyl acrylic acid salt, 2-methyl-3-isopropyl acrylic acid salt, trans-2-octenoic acid salt, cis-2-octenoic acid salt, trans-2-decenoic acid salt, α-acetoxyacrylic acid salt, 3-trans-aryloxyacrylic acid salt, α-chloro-β-E-methoxyacrylic acid salt, or combinations thereof. In some embodiments, the carboxylic salt group-containing monomer is methyl maleic acid salt, dimethyl maleic acid salt, phenyl maleic acid salt, bromo maleic acid salt, chloromaleic acid salt, dichloromaleic acid salt, fluoromaleic acid salt, difluoro maleic acid salt, or combinations thereof.

In some embodiments, the sulfonic acid group-containing monomer is vinylsulfonic acid, methylvinylsulfonic acid, allylvinylsulfonic acid, allylsulfonic acid, methallylsulfonic acid, styrenesulfonic acid, 2-sulfoethyl methacrylic acid, 2-methylprop-2-ene-1-sulfonic acid, 2-acrylamido-2-methyl-1-propane sulfonic acid, 3-allyloxy-2-hydroxy-1-propane sulfonic acid, or combinations thereof.

In some embodiments, the sulfonic acid salt group-containing monomer is vinylsulfonic acid salt, methylvinylsulfonic acid salt, allylvinylsulfonic acid salt, allylsulfonic acid salt, methallylsulfonic acid salt, styrenesulfonic acid salt, 2-sulfoethyl methacrylic acid salt, 2-methylprop-2-ene-1-sulfonic acid salt, 2-acrylamido-2-methyl-1-propane sulfonic acid salt, 3-allyloxy-2-hydroxy-1-propane sulfonic acid salt, or combinations thereof.

In some embodiments, the phosphonic acid group-containing monomer is vinyl phosphonic acid, allyl phosphonic acid, vinyl benzyl phosphonic acid, acrylamide alkyl phosphonic acid, methacrylamide alkyl phosphonic acid, acrylamide alkyl diphosphonic acid, acryloylphosphonic acid, 2-methacryloyloxyethyl phosphonic acid, bis(2-methacryloyloxyethyl) phosphonic acid, ethylene 2-methacryloyloxyethyl phosphonic acid, ethyl-methacryloyloxyethyl phosphonic acid, or combinations thereof.

In some embodiments, the phosphonic acid salt group-containing monomer is salt of vinyl phosphonic acid, salt of allyl phosphonic acid, salt of vinyl benzyl phosphonic acid, salt of acrylamide alkyl phosphonic acid, salt of methacrylamide alkyl phosphonic acid, salt of acrylamide alkyl diphosphonic acid, salt of acryloylphosphonic acid, salt of 2-methacryloyloxyethyl phosphonic acid, salt of bis(2-methacryloyloxyethyl) phosphonic acid, salt of ethylene 2-methacryloyloxyethyl phosphonic acid, salt of ethyl-methacryloyloxyethyl phosphonic acid, or combinations thereof.

In some embodiments, the proportion of structural unit (a) within the water-compatible copolymeric binder is from about 15% to about 80%, from about 17.5% to about 80%, from about 20% to about 80%, from about 22.5% to about 80%, from about 25% to about 80%, from about 27.5% to about 80%, from about 30% to about 80%, from about 32.5% to about 80%, from about 35% to about 80%, from about 37.5% to about 80%, from about 40% to about 80%, from about 42.5% to about 80%, from about 45% to about 80%, from about 45% to about 77.5%, from about 45% to about 75%, from about 45% to about 72.5%, from about 45% to about 70%, from about 45% to about 67.5%, from about 45% to about 65%, from about 45% to about 62.5%, from about 45% to about 60%, from about 45% to about 57.5%, from about 45% to about 55%, from about 45% to about 52.5%, or from about 45% to about 50% by mole, based on the total number of moles of monomeric units in the water-compatible copolymeric binder.

In some embodiments, the proportion of structural unit (a) within the water-compatible copolymeric binder is less than 80%, less than 77.5%, less than 75%, less than 72.5%, less than 70%, less than 67.5%, less than 65%, less than 62.5%, less than 60%, less than 57.5%, less than 55%, less than 52.5%, less than 50%, less than 47.5%, less than 45%, less than 42.5%, less than 40%, less than 37.5%, less than 35%, less than 32.5%, less than 30%, less than 27.5%, or less than 25%, by mole, based on the total number of moles of monomeric units in the water-compatible copolymeric binder. In some embodiments, the proportion of structural unit (a) within the water-compatible copolymeric binder is more than 15%, more than 17.5%, more than 20%, more than 22.5%, more than 25%, more than 27.5%, more than 30%, more than 32.5%, more than 35%, more than 37.5%, more than 40%, more than 42.5%, more than 45%, more than 47.5%, more than 50%, more than 52.5%, more than 55%, more than 57.5%, more than 60%, more than 62.5%, more than 65%, more than 67.5%, or more than 70%, by mole, based on the total number of moles of monomeric units in the water-compatible copolymeric binder.

In some embodiments, the water-compatible copolymeric binder additionally comprises a structural unit (b), wherein structural unit (b) is derived from a monomer selected from the group consisting of an amide group-containing monomer, a hydroxyl group-containing monomer, and combinations thereof.

In some embodiments, the amide group-containing monomer is acrylamide, methacrylamide, N-methyl methacrylamide, N-ethyl methacrylamide, N-n-propyl methacrylamide, N-isopropyl methacrylamide, isopropyl acrylamide, N-n-butyl methacrylamide, N-isobutyl methacrylamide, N,N-dimethyl acrylamide, N,N-dimethyl methacrylamide, N,N-diethyl acrylamide, N,N-diethyl methacrylamide, N-methylol methacrylamide, N-(methoxymethyl)methacrylamide, N-(ethoxymethyl)methacrylamide, N-(propoxymethyl)methacrylamide, N-(butoxymethyl)methacrylamide, N,N-dimethyl methacrylamide, N,N-dimethylaminopropyl methacrylamide, N,N-dimethylaminoethyl methacrylamide, N,N-dimethylol methacrylamide, diacetone methacrylamide, diacetone acrylamide, methacryloyl morpholine, N-hydroxyl methacrylamide, N-methoxymethyl acrylamide, N-methoxymethyl methacrylamide, N,N′-methylene-bis-acrylamide (MBA), N-hydroxymethyl acrylamide, or combinations thereof.

In some embodiments, the hydroxyl group-containing monomer is a C₁ to C₂₀ alkyl group or a C₅ to C₂₀ cycloalkyl group-containing methacrylate having a hydroxyl group. In some embodiments, the hydroxyl group-containing monomer is 2-hydroxyethylacrylate, 2-hydroxyethyl methacrylate, 2-hydroxypropyl acrylate, 2-hydroxypropyl methacrylate, 2-hydroxybutyl methacrylate, 3-hydroxypropylacrylate, 3-hydroxypropylmethacrylate, 4-hydroxybutyl methacrylate, 5-hydroxypentylacrylate, 6-hydroxyhexyl methacrylate, 1,4-cyclohexanedimethanol mono(meth)acrylate, 3-chloro-2-hydroxypropyl methacrylate, diethylene glycol mono(meth)acrylate, allyl alcohol, or combinations thereof.

In some embodiments, the proportion of structural unit (b) within the water-compatible copolymeric binder is from about 5% to about 35%, from about 7% to about 35%, from about 9% to about 35%, from about 11% to about 35%, from about 13% to about 35%, from about 15% to about 35%, from about 17% to about 35%, from about 17% to about 33%, from about 17% to about 31%, from about 17% to about 29%, from about 17% to about 27%, from about 17% to about 25%, or from about 17% to about 23% by mole, based on the total number of moles of monomeric units in the water-compatible copolymeric binder.

In some embodiments, the proportion of structural unit (b) within the water-compatible copolymeric binder is less than 35%, less than 33%, less than 31%, less than 29%, less than 27%, less than 25%, less than 23%, less than 21%, less than 19%, less than 17%, or less than 15% by mole, based on the total number of moles of monomeric units in the water-compatible copolymeric binder. In some embodiments, the proportion of structural unit (b) within the water-compatible copolymeric binder is more than 5%, more than 7%, more than 9%, more than 11%, more than 13%, more than 15%, more than 17%, more than 19%, more than 21%, more than 23%, or more than 25% by mole, based on the total number of moles of monomeric units in the water-compatible copolymeric binder.

In some embodiments, the water-compatible copolymeric binder additionally comprises a structural unit (c), wherein structural unit (c) is derived from a monomer selected from the group consisting of a nitrile group-containing monomer, ester group-containing monomer, epoxy group-containing monomer, a fluorine-containing monomer, and combinations thereof.

In some embodiments, the nitrile group-containing monomer includes α,β-ethylenically unsaturated nitrile monomers. In some embodiments, the nitrile group-containing monomer is acrylonitrile, α-halogenoacrylonitrile, α-alkylacrylonitrile, or combinations thereof. In some embodiments, the nitrile group-containing monomer is α-chloroacrylonitrile, α-bromoacrylonitrile, α-fluoroacrylonitrile, methacrylonitrile, α-ethylacrylonitrile, α-isopropylacrylonitrile, α-n-hexylacrylonitrile, α-methoxyacrylonitrile, 3-methoxyacrylonitrile, 3-ethoxyacrylonitrile, α-acetoxyacrylonitrile, α-phenylacrylonitrile, α-tolylacrylonitrile, α-(methoxyphenyl)acrylonitrile, α-(chlorophenyl)acrylonitrile, α-(cyanophenyl)acrylonitrile, vinylidene cyanide, or combinations thereof.

In some embodiments, the ester group-containing monomer is C₁ to C₂₀ alkyl acrylate, C₁ to C₂₀ alkyl (meth)acrylate, cycloalkyl acrylate, or combinations thereof. In some embodiments, the ester group-containing monomer is methyl acrylate, ethyl acrylate, n-propyl acrylate, isopropyl acrylate, n-butyl acrylate, sec-butyl acrylate, tert-butyl acrylate, pentyl acrylate, hexyl acrylate, heptyl acrylate, octyl acrylate, 3,3,5-trimethylhexyl acrylate, 2-ethylhexyl acrylate, nonyl acrylate, decyl acrylate, lauryl acrylate, n-tetradecyl acrylate, oxtadecyl acrylate, cyclohexyl acrylate, phenyl acrylate, methoxymethyl acrylate, methoxyethyl acrylate, ethoxymethyl acrylate, ethoxyethyl acrylate, perfluorooctyl acrylate, stearyl acrylate, or combinations thereof. In some embodiments, the ester group-containing monomer is cyclohexyl acrylate, cyclohexyl methacrylate, isobornyl acrylate, isobornyl methacrylate, 3,3,5-trimethylcyclohexylacrylate, or combinations thereof. In some embodiments, the ester group-containing monomer is methyl methacrylate, ethyl methacrylate, n-propyl methacrylate, isopropyl methacrylate, n-butyl methacrylate, sec-butyl methacrylate, tert-butyl methacrylate, isobutyl methacrylate, n-pentyl methacrylate, isopentyl methacrylate, hexyl methacrylate, heptyl methacrylate, octyl methacrylate, 2-ethylhexyl methacrylate, nonyl methacrylate, decyl methacrylate, lauryl methacrylate, n-tetradecyl methacrylate, stearyl methacrylate, 2,2,2-trifluoroethyl methacrylate, phenyl methacrylate, benzyl methacrylate, or combinations thereof.

In some embodiments, the epoxy group-containing monomer is vinyl glycidyl ether, allyl glycidyl ether, allyl 2,3-epoxypropyl ether, butenyl glycidyl ether, butadiene monoepoxide, chloroprene monoepoxide, 3,4-epoxy-1-butene, 4,5-epoxy-2-pentene, 3,4-epoxy-1-vinylcyclohexane, 1,2-epoxy-4-vinylcyclohexane, 3,4-epoxy cyclohexylethylene, epoxy vinylcyclohexene, 1,2-epoxy-5,9-cyclododecadiene, or combinations thereof.

In some embodiments, the epoxy group-containing monomer is 3,4-epoxy butene, 1,2-epoxy-5-hexene, 1,2-epoxy-9-decene, glycidyl acrylate, glycidyl methacrylate, glycidyl crotonate, glycidyl 2,4-dimethyl pentenoate, glycidyl 4-hexenoate, glycidyl 4-heptenoate, glycidyl 5-methyl-4-heptenoate, glycidyl sorbate, glycidyl linoleate, glycidyl oleate, glycidyl 3-butenoate, glycidyl 3-pentenoate, glycidyl-4-methyl-3-pentenoate, or combinations thereof.

In some embodiments, the fluorine-containing monomer is a C₁ to C₂₀ alkyl group-containing acrylate, methacrylate, or combinations thereof, wherein the monomer comprises at least one fluorine atom. In some embodiments, the fluorine-containing monomer is perfluoro alkyl acrylate such as perfluoro dodecyl acrylate, perfluoro n-octyl acrylate, perfluoro n-butyl acrylate, perfluoro hexylethyl acrylate and perfluoro octylethyl acrylate; perfluoro alkyl methacrylate such as perfluoro dodecyl methacrylate, perfluoro n-octyl methacrylate, perfluoro n-butyl methacrylate, perfluoro hexylethyl methacrylate and perfluoro octylethyl methacrylate; perfluoro oxyalkyl acrylate such as perfluoro dodecyloxyethyl acrylate and perfluoro decyloxyethyl acrylate; perfluoro oxyalkyl methacrylate such as perfluoro dodecyloxyethyl methacrylate and perfluoro decyloxyethyl methacrylate, or combinations thereof. In some embodiments, the fluorine-containing monomer is a carboxylate containing at least one C₁ to C₂₀ alkyl group and at least one fluorine atom; wherein the carboxylate is selected from the group consisting of crotonate, malate, fumarate, itaconate, and combinations thereof. In some embodiments, the fluorine-containing monomer is vinyl fluoride, trifluoroethylene, trifluorochloroethylene, fluoroalkyl vinyl ether, perfluoroalkyl vinyl ether, hexafluoropropylene, 2,3,3,3-tetrafluoropropene, vinylidene fluoride, tetrafluoroethylene, 2-fluoro acrylate, or combinations thereof.

In some embodiments, the proportion of structural unit (c) within the water-compatible copolymeric binder is from about 15% to about 75%, from about 17.5% to about 75%, from about 20% to about 75%, from about 22.5% to about 75%, from about 25% to about 75%, from about 27.5% to about 75%, from about 30% to about 75%, from about 32.5% to about 75%, from about 35% to about 75%, from about 37.5% to about 75%, from about 40% to about 75%, from about 42.5% to about 75%, from about 42.5% to about 72.5%, from about 42.5% to about 70%, from about 42.5% to about 67.5%, from about 42.5% to about 65%, from about 42.5% to about 62.5%, from about 42.5% to about 60%, from about 42.5% to about 57.5%, from about 42.5% to about 55%, from about 42.5% to about 52.5%, from about 42.5% to about 50%, or from about 42.5% to about 47.5% by mole, based on the total number of moles of monomeric units in the water-compatible copolymeric binder.

In some embodiments, the proportion of structural unit (c) within the water-compatible copolymeric binder is less than 75%, less than 72.5%, less than 70%, less than 67.5%, less than 65%, less than 62.5%, less than 60%, less than 57.5%, less than 55%, less than 52.5%, less than 50%, less than 47.5%, less than 45%, less than 42.5%, less than 40%, less than 37.5%, less than 35%, less than 32.5%, less than 30%, less than 27.5%, or less than 25% by mole, based on the total number of moles of monomeric units in the water-compatible copolymeric binder. In some embodiments, the proportion of structural unit (c) within the water-compatible copolymeric binder is more than 15%, more than 17.5%, more than 20%, more than 22.5%, more than 25%, more than 27.5%, more than 30%, more than 32.5%, more than 35%, more than 37.5%, more than 40%, more than 42.5%, more than 45%, more than 47.5%, more than 50%, more than 52.5%, more than 55%, more than 57.5%, more than 60%, more than 62.5%, or more than 65% by mole, based on the total number of moles of monomeric units in the water-compatible copolymeric binder.

In other embodiments, the water-compatible copolymeric binder may additionally comprise a structural unit derived from an olefin. Any hydrocarbon that has at least one carbon-carbon double bond may be used as an olefin without any specific limitations. In some embodiments, the olefin includes a C₂ to C₂₀ aliphatic compound, a C₈ to C₂₀ aromatic compound or a cyclic compound containing vinylic unsaturation, a C₄ to C₄₀ diene, and combinations thereof. In some embodiments, the olefin is styrene, ethylene, propylene, isobutylene, 1-butene, 1-pentene, 1-hexene, 1-heptene, 1-octene, 1-nonene, 1-decene, 1-dodecene, 1-tetradecene, 1-hexadecene, 1-octadecene, 1-eicosene, 3-methyl-1-butene, cyclobutene, 3-methyl-1-pentene, 4-methyl-1-pentene, 4,6-dimethyl-1-heptene, 4-vinylcyclohexene, vinyl cyclohexane, norbornene, norbornadiene, ethylidene norbornene, cyclopentene, cyclohexene, dicyclopentadiene, cyclooctene, or combinations thereof. In some embodiments, the copolymer does not comprise a structural unit derived from an olefin. In some embodiments, the copolymer does not comprise a structural unit derived from styrene, ethylene, propylene, isobutylene, 1-butene, 1-pentene, 1-hexene, 1-heptene, 1-octene, 1-nonene, 1-decene, 1-dodecene, 1-tetradecene, 1-hexadecene, 1-octadecene, 1-eicosene, 3-methyl-1-butene, cyclobutene, 3-methyl-1-pentene, 4-methyl-1-pentene, 4,6-dimethyl-1-heptene, 4-vinylcyclohexene, vinyl cyclohexane, norbornene, norbornadiene, ethylidene norbornene, cyclopentene, cyclohexene, dicyclopentadiene or cyclooctene.

A conjugated diene group-containing monomer constitutes as an olefin. In some embodiments, a conjugated diene group-containing monomer includes C₄ to C₄₀ dienes; aliphatic conjugated diene monomers such as 1,3-butadiene, 1,3-pentadiene, 1,4-hexadiene, 1,5-hexadiene, 1,7-octadiene, 1,9-decadiene, isoprene, myrcene, 2-methyl-1,3-butadiene, 2,3-dimethyl-1,3-butadiene, 2-chloro-1,3-butadiene; substituted linear conjugated pentadienes; substituted side chain conjugated hexadienes; and combinations thereof. In some embodiments, the copolymer does not comprise a structural unit derived from C₄ to C₄₀ dienes; aliphatic conjugated diene monomers such as 1,3-butadiene, 1,3-pentadiene, 1,4-hexadiene, 1,5-hexadiene, 1,7-octadiene, 1,9-decadiene, isoprene, myrcene, 2-methyl-1,3-butadiene, 2,3-dimethyl-1,3-butadiene, 2-chloro-1,3-butadiene; substituted linear conjugated pentadienes; or substituted side chain conjugated hexadienes.

In other embodiments, the water-compatible copolymeric binder may additionally comprise a structural unit derived from an aromatic vinyl group-containing monomer. In some embodiments, the aromatic vinyl group-containing monomer is styrene, α-methylstyrene, vinyltoluene, divinylbenzene, or combinations thereof. In some embodiments, the water-compatible copolymeric binder does not comprise a structural unit derived from an aromatic vinyl group-containing monomer. In some embodiments, the water-compatible copolymeric binder does not comprise a structural unit derived from styrene, α-methylstyrene, vinyltoluene or divinylbenzene.

In certain embodiments, the proportion of the water-compatible copolymeric binder in the aqueous solvent-based cathode slurry is from about 0.1% to about 10%, from about 0.1% to about 9%, from about 0.1% to about 8%, from about 0.1% to about 7%, from about 0.1% to about 6%, from about 0.1% to about 5%, from about 0.1% to about 4%, from about 0.1% to about 3%, from about 0.3% to about 5%, from about 0.3% to about 4%, from about 0.3% to about 3%, from about 0.5% to about 5%, from about 0.5% to about 4%, from about 0.5% to about 3%, from about 1% to about 5%, from about 1% to about 4%, from about 1% to about 3%, from about 1.5% to about 5% or from about 1.5% to about 4% by weight, based on the total weight of the aqueous solvent-based cathode slurry.

In some embodiments, the proportion of the water-compatible copolymeric binder in the aqueous solvent-based cathode slurry is less than 10%, less than 9%, less than 8%, less than 7%, less than 6%, less than 5%, less than 4%, less than 3%, less than 2% or less than 1% by weight, based on the total weight of the aqueous solvent-based cathode slurry. In some embodiments, the proportion of the water-compatible copolymeric binder in the aqueous solvent-based cathode slurry is more than 0.1%, more than 0.5%, more than 1%, more than 2%, more than 3%, more than 4%, more than 5%, more than 6%, more than 7%, more than 8% or more than 9% by weight, based on the total weight of the aqueous solvent-based cathode slurry.

In some embodiments, the aqueous solvent-based cathode slurry may comprise a conductive agent. The conductive agent enhances the electrically-conducting properties of an electrode. Any suitable material can act as the conductive agent. In some embodiments, the conductive agent is a carbonaceous material. Some non-limiting examples of carbonaceous materials suitable for use as a conductive agent include carbon, carbon black, graphite, expanded graphite, graphene, graphene nanoplatelets, carbon fibers, carbon nano-fibers, graphitized carbon flake, carbon tubes, carbon nanotubes, activated carbon, Super P, 0-dimensional KS6, 1-dimensional vapor grown carbon fibers (VGCF), mesoporous carbon, and combinations thereof. In certain embodiments, the conductive agent does not comprise a carbonaceous material.

In some embodiments, the conductive agent is a conductive polymer selected from the group consisting of polypyrrole, polyaniline, polyacetylene, polyphenylene sulfide (PPS), polyphenylene vinylene (PPV), poly(3,4-ethylenedioxythiophene) (PEDOT), polythiophene, and combinations thereof. In some embodiments, the conductive agent plays two roles simultaneously, not only as a conductive agent but also as a binder material. In certain embodiments, the positive electrode layer comprises three components; the cathode active material, lithium compound, and conductive polymer. In other embodiments, the positive electrode layer comprises cathode active material, lithium compound, conductive agent, and conductive polymer. In certain embodiments, the conductive polymer is an additive and the positive electrode layer comprises cathode active material, lithium compound, conductive agent, water-compatible copolymeric binder, and conductive polymer. In other embodiments, the conductive agent does not comprise a conductive polymer.

In certain embodiments, the proportion of the conductive agent in the aqueous solvent-based cathode slurry is from about 0.5% to about 5%, from about 0.5% to about 4%, from about 0.5% to about 3%, from about 1% to about 5%, from about 1% to about 4%, from about 2% to about 3% or from about 1.5% to about 3% by weight, based on the total weight of the aqueous solvent-based cathode slurry. In some embodiments, the proportion of the conductive agent in the aqueous solvent-based cathode slurry is more than 0.5%, more than 1%, more than 1.5%, more than 2%, more than 2.5%, more than 3%, more than 3.5%, more than 4% or more than 4.5% by weight, based on the total weight of the aqueous solvent-based cathode slurry. In certain embodiments, the proportion of the conductive agent in the aqueous solvent-based cathode slurry is less than 5%, less than 4.5%, less than 4%, less than 3.5%, less than 3%, less than 2.5%, less than 2%, less than 1.5% or less than 1% by weight, based on the total weight of the aqueous solvent-based cathode slurry.

In some embodiments, the weight of the water-compatible copolymeric binder is greater than, smaller than, or equal to the weight of the conductive agent in the aqueous solvent-based cathode slurry. In certain embodiments, the ratio of the weight of the water-compatible copolymeric binder to the weight of the conductive agent in the aqueous solvent-based cathode slurry is from about 1:10 to about 10:1, from about 1:10 to about 5:1, from about 1:10 to about 1:1, from about 1:10 to about 1:5, from about 1:5 to about 5:1, from about 1:3 to about 3:1, from about 1:2 to about 2:1, or from about 1:1.5 to about 1.5:1.

In some embodiments, the first and second suspension is independently stirred at a temperature from about 5° C. to about 40° C., from about 5° C. to about 35° C., from about 5° C. to about 30° C., from about 5° C. to about 25° C., from about 5° C. to about 20° C., from about 5° C. to about 15° C., from about 5° C. to about 10° C., from about 10° C. to about 40° C., from about 10° C. to about 35° C., from about 10° C. to about 30° C., from about 10° C. to about 25° C., from about 10° C. to about 20° C., or from about 15° C. to about 35° C. In some embodiments, the first and second suspension is independently stirred at a temperature of less than 40° C., less than 35° C., less than 30° C., less than 25° C., less than 20° C., less than 15° C., or less than 10° C. In some embodiments, the first and second suspension is independently stirred at a temperature of more than 5° C., more than 10° C., more than 15° C., more than 20° C., more than 25° C., more than 30° C., or more than 35° C.

In some embodiments, the first and second suspension is independently stirred for a time period from about 1 minute to about 60 minutes, from about 1 minute to about 50 minutes, from about 1 minute to about 40 minutes, from about 1 minute to about 30 minutes, from about 1 minute to about 20 minutes, from about 1 minute to about 10 minutes, from about 5 minutes to about 60 minutes, from about 5 minutes to about 50 minutes, from about 5 minutes to about 40 minutes, from about 5 minutes to about 30 minutes, from about 5 minutes to about 20 minutes, from about 5 minutes to about 10 minutes, from about 10 minutes to about 60 minutes, from about 10 minutes to about 50 minutes, from about 10 minutes to about 40 minutes, from about 10 minutes to about 30 minutes, from about 10 minutes to about 20 minutes, from about 15 minutes to about 60 minutes, from about 15 minutes to about 50 minutes, from about 15 minutes to about 40 minutes, from about 15 minutes to about 30 minutes, from about 15 minutes to about 20 minutes, from about 20 minutes to about 50 minutes, from about 20 minutes to about 40 minutes, or from about 20 minutes to about 30 minutes.

In certain embodiments, the first and second suspension is independently stirred for a time period of less than 60 minutes, less than 55 minutes, less than 50 minutes, less than 45 minutes, less than 40 minutes, less than 35 minutes, less than 30 minutes, less than 25 minutes, less than 20 minutes, less than 15 minutes, less than 10 minutes, or less than 5 minutes. In some embodiments, the first and second suspension is independently stirred for a time period of more than 5 minutes, more than 10 minutes, more than 15 minutes, more than 20 minutes, more than 25 minutes, more than 30 minutes, more than 35 minutes, more than 40 minutes, more than 45 minutes, more than 50 minutes, or more than 55 minutes.

In some embodiments, the second suspension is stirred at a speed of from about 100 rpm to about 1500 rpm, from about 100 rpm to about 1400 rpm, from about 150 rpm to about 1400 rpm, from about 200 rpm to about 1400 rpm, from about 250 rpm to about 1400 rpm, from about 300 rpm to about 1400 rpm, from about 300 rpm to about 1300 rpm, from about 350 rpm to about 1300 rpm, from about 400 rpm to about 1300 rpm, from about 450 rpm to about 1300 rpm, from about 450 rpm to about 1200 rpm, from about 500 rpm to about 1200 rpm, from about 600 rpm to about 1200 rpm, from about 700 rpm to about 1400 rpm, from about 800 rpm to about 1400 rpm, from about 900 rpm to about 1400 rpm, from about 1000 rpm to about 1400 rpm, from about 300 rpm to about 1000 rpm, from about 300 rpm to about 900 rpm, from about 300 rpm to about 800 rpm, or from about 300 rpm to about 700 rpm.

In some embodiments, the second suspension is stirred at a speed of less than 1500 rpm, less than 1400 rpm, less than 1300 rpm, less than 1200 rpm, less than 1100 rpm, less than 1000 rpm, less than 900 rpm, less than 800 rpm, less than 700 rpm, less than 600 rpm, less than 500 rpm, less than 400 rpm, less than 300 rpm, or less than 200 rpm. In some embodiments, the second suspension is stirred at a speed of more than 100 rpm, more than 200 rpm, more than 300 rpm, more than 400 rpm, more than 500 rpm, more than 600 rpm, more than 700 rpm, more than 800 rpm, more than 900 rpm, more than 1000 rpm, more than 1100 rpm, more than 1200 rpm, more than 1300 rpm, or more than 1400 rpm.

In some embodiments, the third suspension is formed by dispersing a cathode active material into the second suspension in step 103.

In some embodiments, the electrode active material is a cathode active material, wherein the cathode active material is selected from the group consisting of LiCoO₂, LiNiO₂, LiNiₓMn_{y}O₂, Li_{1+z}NiₓMn_{y}Co_{1-x-y}O₂, LiNiₓCo_{y}Al_{z}O₂, LiV₂O₅, LiTiS₂, LiMoS₂, LiMnO₂, LiCrO₂, LiMn₂O₄, Li₂MnO₃, LiFeO₂, LiFePO₄, and combinations thereof, wherein each x is independently from 0.2 to 0.9; each y is independently from 0.1 to 0.45; and each z is independently from 0 to 0.2. In certain embodiments, the cathode active material is selected from the group consisting of LiCoO₂, LiNiO₂, LiNiₓMn_{y}O₂, Li_{1+z}NiₓMn_{y}Co_{1-x-y}O₂ (NMC), LiNiₓCo_{y}Al_{z}O₂, LiV₂O₅, LiTiS₂, LiMoS₂, LiMnO₂, LiCrO₂, LiMn₂O₄, LiFeO₂, LiFePO₄, and combinations thereof, wherein each x is independently from 0.4 to 0.6; each y is independently from 0.2 to 0.4; and each z is independently from 0 to 0.1. In other embodiments, the cathode active material is not LiCoO₂, LiNiO₂, LiV₂O₅, LiTiS₂, LiMoS₂, LiMnO₂, LiCrO₂, LiMn₂O₄, LiFeO₂, or LiFePO₄. In further embodiments, the cathode active material is not LiNiₓMn_{y}O₂, Li_{1+z}NiₓMn_{y}Co_{1-x-y}O₂, or LiNiₓCo_{y}Al_{z}O₂, wherein each x is independently from 0.2 to 0.9; each y is independently from 0.1 to 0.45; and each z is independently from 0 to 0.2. In certain embodiments, the cathode active material is Li₁₊ₓNiₐMn_{b}Co_{c}Al_{(1-a-b-c)}O₂; wherein −0.2≤x≤0.2, 0≤a≤1, 0≤b≤1, 0≤c≤1, and a+b+c≤1. In some embodiments, the cathode active material has the general formula Li₁₊ₓNiₐMn_{b}Co_{c}Al_{(1-a-b-c)}O₂, with 0.33≤a≤0.92, 0.33≤a≤0.9, 0.33≤a≤0.8, 0.5≤a≤0.92, 0.5≤a≤0.9, 0.5≤a≤0.8, 0.6≤a≤0.92, or 0.6≤a≤0.9; 0≤b≤0.5, 0≤b≤0.3, 0.1≤b≤0.5, 0.1≤b≤0.4, 0.1≤b≤0.3, 0.1≤b≤0.2, or 0.2≤b≤0.5; 0≤c≤0.5, 0≤c≤0.3, 0.1≤c≤0.5, 0.1≤c≤0.4, 0.1≤c≤0.3, 0.1≤c≤0.2, or 0.2≤c≤0.5. In some embodiments, the cathode active material has the general formula LiMPO₄, wherein M is selected from the group consisting of Fe, Co, Ni, Mn, Al, Mg, Zn, Ti, La, Ce, Sn, Zr, Ru, Si, Ge, and combinations thereof. In some embodiments, the cathode active material is selected from the group consisting of LiFePO₄, LiCoPO₄, LiNiPO₄, LiMnPO₄, LiMnFePO₄, and combinations thereof. In some embodiments, the cathode active material is LiNiₓMn_{y}O₄; wherein 0.1≤x≤0.8 and 0.1≤y≤2.

In certain embodiments, the cathode active material is doped with a dopant selected from the group consisting of Fe, Ni, Mn, Al, Mg, Zn, Ti, La, Ce, Sn, Zr, Ru, Si, Ge, and combinations thereof. In some embodiments, the dopant is not Fe, Ni, Mn, Mg, Zn, Ti, La, Ce, Ru, Si, or Ge. In certain embodiments, the dopant is not Al, Sn, or Zr.

In some embodiments, the cathode active material is LiNi_{0.33}Mn_{0.33}Co_{0.33}O₂ (NMC333), LiNi_{0.4}Mn_{0.4}Co_{0.2}O₂, LiNi_{0.5}Mn_{0.3}Co_{0.2}O₂ (NMC532), LiNi_{0.6}Mn_{0.2}Co_{0.202} (NMC622), LiNi_{0.7}Mn_{0.15}Co_{0.15}O₂, LiNi_{0.8}Mn_{0.1}Co_{0.1}O₂ (NMC811), LiNi_{0.92}Mn_{0.04}Co_{0.04}O₂, LiNi_{0.8}Co_{0.15}Al_{0.05}O₂ (NCA), LiNiO₂ (LNO), or combinations thereof.

In other embodiments, the cathode active material is not LiCoO₂, LiNiO₂, LiMnO₂, LiMn₂O₄, or Li₂MnO₃. In further embodiments, the cathode active material is not LiNi_{0.33}Mn_{0.33}Co_{0.33}O₂, LiNi_{0.4}Mn_{0.4}Co_{0.2}O₂, LiNi_{0.5}Mn_{0.3}Co_{0.2}O₂, LiNi_{0.6}Mn_{0.2}Co_{0.2}O₂, LiNi_{0.7}Mn_{0.15}Co_{0.15}O₂, LiNi_{0.8}Mn_{0.1}Co_{0.1}O₂, LiNi_{0.92}Mn_{0.04}Co_{0.04}O₂, or LiNi_{0.8}Co_{0.15}Al_{0.05}O₂.

In certain embodiments, the cathode active material comprises or is a core-shell composite having a core and shell structure, wherein the core and the shell each independently comprise a lithium transition metal oxide selected from the group consisting of Li₁₊ₓNiₐMn_{b}Co_{c}Al_{(1-a-b-c)}O₂, LiCoO₂, LiNiO₂, LiMnO₂, LiMn₂O₄, Li₂MnO₃, LiCrO₂, Li₄Ti₅O₁₂, LiV₂O₅, LiTiS₂, LiMoS₂, and combinations thereof; wherein −0.2≤x≤0.2, 0≤a<1, 0≤b<1, 0≤c<1, and a+b+c≤1. In other embodiments, the core and the shell each independently comprise two or more lithium transition metal oxides. In some embodiments, one of the core or shell comprises only one lithium transition metal oxide, while the other comprises two or more lithium transition metal oxides. The lithium transition metal oxide or oxides in the core and the shell may be the same, or they may be different or partially different. In some embodiments, the two or more lithium transition metal oxides are uniformly distributed over the core. In certain embodiments, the two or more lithium transition metal oxides are not uniformly distributed over the core. In some embodiments, the cathode active material is not a core-shell composite.

In some embodiments, each of the lithium transition metal oxides in the core and the shell is independently doped with a dopant selected from the group consisting of Fe, Ni, Mn, Al, Mg, Zn, Ti, La, Ce, Sn, Zr, Ru, Si, Ge, and combinations thereof. In certain embodiments, the core and the shell each independently comprise two or more doped lithium transition metal oxides. In some embodiments, the two or more doped lithium transition metal oxides are uniformly distributed over the core and/or the shell. In certain embodiments, the two or more doped lithium transition metal oxides are not uniformly distributed over the core and/or the shell.

In some embodiments, the cathode active material comprises or is a core-shell composite comprising a core comprising a lithium transition metal oxide and a shell comprising a transition metal oxide. In certain embodiments, the lithium transition metal oxide is selected from the group consisting of Li₁₊ₓNiₐMn_{b}Co_{c}Al_{(1-a-b-c)}O₂, LiCoO₂, LiNiO₂, LiMnO₂, LiMn₂O₄, Li₂MnO₃, LiCrO₂, Li₄Ti₅O₁₂, LiV₂O₅, LiTiS₂, LiMoS₂, and combinations thereof; wherein −0.2≤x≤0.2, 0≤a<1, 0≤b<1, 0≤c<1, and a+b+c≤1. In some embodiments, the transition metal oxide is selected from the group consisting of Fe₂O₃, MnO₂, Al₂O₃, MgO, ZnO, TiO₂, La₂O₃, CeO₂, SnO₂, ZrO₂, RuO₂, and combinations thereof. In certain embodiments, the shell comprises a lithium transition metal oxide and a transition metal oxide.

In some embodiments, the diameter of the core is from about 1 μm to about 15 μm, from about 3 μm to about 15 μm, from about 3 μm to about 10 μm, from about 5 μm to about 10 μm, from about 5 μm to about 45 μm, from about 5 μm to about 35 μm, from about 5 μm to about 25 μm, from about 10 μm to about 45 μm, from about 10 μm to about 40 μm, or from about 10 μm to about 35 μm, from about 10 μm to about 25 μm, from about 15 μm to about 45 μm, from about 15 μm to about 30 μm, from about 15 μm to about 25 μm, from about 20 μm to about 35 μm, or from about 20 μm to about 30 μm. In certain embodiments, the thickness of the shell is from about 1 μm to about 45 μm, from about 1 μm to about 35 μm, from about 1 μm to about 25 μm, from about 1 μm to about 15 μm, from about 1 μm to about 10 μm, from about 1 μm to about 5 μm, from about 3 μm to about 15 μm, from about 3 μm to about 10 inn, from about 5 μm to about 10 μm, from about 10 μm to about 35 μm, from about 10 μm to about 20 μm, from about 15 μm to about 30 μm, from about 15 μm to about 25 μm, or from about 20 μm to about 35 μm. In certain embodiments, the diameter or thickness ratio of the core and the shell are in the range of 15:85 to 85:15, 25:75 to 75:25, 30:70 to 70:30, or 40:60 to 60:40. In certain embodiments, the volume or weight ratio of the core and the shell is 95:5, 90:10, 80:20, 70:30, 60:40, 50:50, 40:60, or 30:70.

In some embodiments, the proportion of the cathode active material in the aqueous solvent-based cathode slurry is from about 20% to about 70%, from about 20% to about 65%, from about 20% to about 60%, from about 20% to about 55%, from about 20% to about 50%, from about 20% to about 40%, from about 20% to about 30%, from about 30% to about 70%, from about 30% to about 65%, from about 30% to about 60%, from about 30% to about 55%, from about 30% to about 50%, from about 40% to about 70%, from about 40% to about 65%, from about 40% to about 60%, from about 40% to about 55%, from about 40% to about 50%, from about 50% to about 70%, or from about 50% to about 60% by weight, based on the total weight of the aqueous solvent-based cathode slurry. In certain embodiments, the proportion of the cathode active material in the aqueous solvent-based cathode slurry is more than 20%, more than 30%, more than 40%, more than 50% or more than 60% by weight, based on the total weight of the aqueous solvent-based cathode slurry. In some embodiments, the proportion of the cathode active material in the aqueous solvent-based cathode slurry is less than 70%, less than 60%, less than 50%, less than 40% or less than 30% by weight, based on the total weight of the aqueous solvent-based cathode slurry.

In some embodiments, the third suspension is stirred for a time period from about 10 minutes to about 120 minutes, from about 20 minutes to about 120 minutes, from about 30 minutes to about 120 minutes, from about 40 minutes to about 120 minutes, from about 50 minutes to about 120 minutes, from about 60 minutes to about 120 minutes, from about 60 minutes to about 110 minutes, from about 60 minutes to about 100 minutes, from about 60 minutes to about 90 minutes, from about 55 minutes to about 90 minutes, from about 50 minutes to about 90 minutes, from about 45 minutes to about 90 minutes, from about 45 minutes to about 85 minutes, from about 45 minutes to about 80 minutes or from about 45 minutes to about 75 minutes, to achieve a uniform dispersion of cathode active material.

In certain embodiments, the third suspension is stirred for a time period of less than 120 minutes, less than 110 minutes, less than 100 minutes, less than 90 minutes, less than 80 minutes, less than 70 minutes, less than 60 minutes, less than 55 minutes, less than 50 minutes, less than 45 minutes, less than 40 minutes, less than 35 minutes, less than 30 minutes, less than 25 minutes, less than 20 minutes or less than 15 minutes, to achieve a uniform dispersion of cathode active material. In some embodiments, the third suspension is stirred for a time period of more than 10 minutes, more than 15 minutes, more than 20 minutes, more than 25 minutes, more than 30 minutes, more than 35 minutes, more than 40 minutes, more than 45 minutes, more than 50 minutes, more than 55 minutes, more than 60 minutes, more than 65 minutes, more than 70 minutes, more than 75 minutes, more than 80 minutes, more than 85 minutes, more than 90 minutes, more than 100 minutes or more than 110 minutes, to achieve a uniform dispersion of cathode active material.

In some embodiments, the third suspension is stirred at a speed of from about 500 rpm to about 1500 rpm, from about 550 rpm to about 1500 rpm, from about 600 rpm to about 1500 rpm, from about 650 rpm to about 1500 rpm, from about 700 rpm to about 1500 rpm, from about 750 rpm to about 1500 rpm, from about 800 rpm to about 1500 rpm, from about 850 rpm to about 1500 rpm, from about 900 rpm to about 1500 rpm, from about 950 rpm to about 1500 rpm, from about 1000 rpm to about 1500 rpm, from about 1000 rpm to about 1400 rpm, from about 1000 rpm to about 1300 rpm or from about 1100 rpm to about 1300 rpm, to achieve a uniform dispersion of cathode active material.

In some embodiments, the third suspension is stirred at a speed of less than 1500 rpm, less than 1400 rpm, less than 1300 rpm, less than 1200 rpm, less than 1100 rpm, less than 1000 rpm, less than 900 rpm, less than 800 rpm, less than 700 rpm or less than 600 rpm, to achieve a uniform dispersion of cathode active material. In some embodiments, the third suspension is stirred at a speed of more than 500 rpm, more than 600 rpm, more than 700 rpm, more than 800 rpm, more than 900 rpm, more than 1000 rpm, more than 1100 rpm, more than 1200 rpm, more than 1300 rpm or more than 1400 rpm, to achieve a uniform dispersion of cathode active material.

In other embodiments, the water-compatible copolymeric binder (and the conductive agent) can be dispersed in an aqueous solvent to form a first suspension. A second suspension can then be formed by dispersing the cathode active material in the first suspension. Thereafter, a third suspension can be formed by adding the lithium compound to the second suspension.

In some embodiments, before homogenization of the third suspension, the third suspension is degassed under a reduced pressure for a short period of time to remove air bubbles trapped in the suspension. In some embodiments, the third suspension is degassed at a pressure from about 1 kPa to about 20 kPa, from about 1 kPa to about 15 kPa, from about 1 kPa to about 10 kPa, from about 5 kPa to about 20 kPa, from about 5 kPa to about 15 kPa, or from about 10 kPa to about 20 kPa. In certain embodiments, the third suspension is degassed at a pressure less than 20 kPa, less than 15 kPa, or less than 10 kPa.

In some embodiments, the third suspension is degassed for a time period from about 30 minutes to about 4 hours, from about 1 hour to about 4 hours, from about 2 hours to about 4 hours, or from about 30 minutes to about 2 hours. In certain embodiments, the third suspension is degassed for a time period less than 4 hours, less than 2 hours, or less than 1 hour.

In certain embodiments, the third suspension is degassed after homogenization. The homogenized third suspension may also be degassed at the pressures and for the time durations stated in the step of degassing the third suspension before homogenization.

In some embodiments, the homogenized aqueous solvent-based cathode slurry is formed by homogenizing the third suspension by a homogenizer in step 104.

The third suspension is homogenized by a homogenizer at a temperature from about 10° C. to about 30° C. to obtain a homogenized aqueous solvent-based cathode slurry. The homogenizer may be equipped with a temperature control system, and the temperature of the third suspension can be controlled by the temperature control system. Any homogenizer that can reduce or eliminate particle aggregation, and/or promote homogeneous distribution of cathode slurry materials can be used herein. Homogeneous distribution plays an important role in fabricating batteries with good battery performance. In some embodiments, the homogenizer is a planetary stirring mixer, a stirring mixer, a blender, or an ultrasonicator.

In some embodiments, the third suspension is homogenized at a temperature from about 10° C. to about 30° C., from about 10° C. to about 25° C., from about 10° C. to about 20° C., or from about 10° C. to about 15° C. In some embodiments, the third suspension is homogenized at a temperature of less than 30° C., less than 25° C., less than 20° C., or less than 15° C.

In some embodiments, the planetary stirring mixer comprises at least one planetary blade and at least one high-speed dispersion blade. In certain embodiments, the rotational speed of the planetary blade is from about 20 rpm to about 200 rpm, from about 20 rpm to about 150 rpm, from about 30 rpm to about 150 rpm, or from about 50 rpm to about 100 rpm. In certain embodiments, the rotational speed of the dispersion blade is from about 1,000 rpm to about 4,000 rpm, from about 1,000 rpm to about 3,500 rpm, from about 1,000 rpm to about 3,000 rpm, from about 1,000 rpm to about 2,000 rpm, from about 1,500 rpm to about 3,000 rpm, or from about 1,500 rpm to about 2,500 rpm.

In certain embodiments, the ultrasonicator is an ultrasonic bath, a probe-type ultrasonicator or an ultrasonic flow cell. In some embodiments, the ultrasonicator is operated at a power density from about 10 W/L to about 100 W/L, from about 20 W/L to about 100 W/L, from about 30 W/L to about 100 W/L, from about 40 W/L to about 80 W/L, from about 40 W/L to about 70 W/L, from about 40 W/L to about 60 W/L, from about 40 W/L to about 50 W/L, from about 50 W/L to about 60 W/L, from about 20 W/L to about 80 W/L, from about 20 W/L to about 60 W/L, or from about 20 W/L to about 40 W/L. In certain embodiments, the ultrasonicator is operated at a power density of more than 10 W/L, more than 20 W/L, more than 30 W/L, more than 40 W/L, more than 50 W/L, more than 60 W/L, more than 70 W/L, more than 80 W/L, or more than 90 W/L.

In some embodiments, the third suspension is homogenized for a time period from about 10 minutes to about 6 hours, from about 10 minutes to about 5 hours, from about 10 minutes to about 4 hours, from about 10 minutes to about 3 hours, from about 10 minutes to about 2 hours, from about 10 minutes to about 1 hour, from about 10 minutes to about 30 minutes, from about 30 minutes to about 3 hours, from about 30 minutes to about 2 hours, from about 30 minutes to about 1 hour, from about 1 hour to about 6 hours, from about 1 hour to about 5 hours, from about 1 hour to about 4 hours, from about 1 hour to about 3 hours, from about 1 hour to about 2 hours, from about 2 hours to about 6 hours, from about 2 hours to about 4 hours, from about 2 hours to about 3 hours, from about 3 hours to about 5 hours, or from about 4 hours to about 6 hours, to promote homogeneous distribution of cathode slurry materials. In certain embodiments, the third suspension is homogenized for a time period of less than 6 hours, less than 5 hours, less than 4 hours, less than 3 hours, less than 2 hours, less than 1 hour, or less than 30 minutes, to promote homogeneous distribution of cathode slurry materials. In some embodiments, the third suspension is homogenized for a time period of more than 10 minutes, more than 20 minutes, more than 30 minutes, more than 1 hour, more than 2 hours, more than 3 hours, more than 4 hours, or more than 5 hours, to promote homogeneous distribution of cathode slurry materials.

In some embodiments, the pH of the aqueous solvent-based cathode slurry is from about 8 to about 14, from about 8 to about 13.5, from about 8 to about 13, from about 8 to about 12.5, from about 8 to about 12, from about 8 to about 11.5, from about 8 to about 11, from about 8 to about 10.5, from about 8 to about 10, from about 8 to about 9, from about 9 to about 14, from about 9 to about 13, from about 9 to about 12, from about 9 to about 11, from about 10 to about 14, from about 10 to about 13, from about 10 to about 12, from about 10 to about 11, from about 10.5 to about 14, from about 10.5 to about 13.5, from about 10.5 to about 13, from about 10.5 to about 12.5, from about 10.5 to about 12, from about 10.5 to about 11.5, from about 11 to about 14, from about 11 to about 13, from about 11 to about 12, from about 11.5 to about 12.5, from about 11.5 to about 12, or from about 12 to about 14. In certain embodiments, the pH of the aqueous solvent-based cathode slurry is less than 14, less than 13.5, less than 13, less than 12.5, less than 12, less than 11.5, less than 11, less than 10.5, less than 10, less than 9.5, less than 9, or less than 8.5. In some embodiments, the pH of the aqueous solvent-based cathode slurry is more than 8, more than 8.5, more than 9, more than 9.5, more than 10, more than 10.5, more than 11, more than 11.5, more than 12, more than 12.5, more than 13, or more than 13.5.

In some embodiments, the solid content of the aqueous solvent-based cathode slurry is from about 40% to about 80%, from about 45% to about 75%, from about 45% to about 70%, from about 45% to about 65%, from about 45% to about 60%, from about 45% to about 55%, from about 45% to about 50%, from about 50% to about 75%, from about 50% to about 70%, from about 50% to about 65%, from about 55% to about 75%, from about 55% to about 70%, from about 60% to about 75%, or from about 65% to about 75% by weight, based on the total weight of the aqueous solvent-based cathode slurry. In certain embodiments, the solid content of the aqueous solvent-based cathode slurry is more than 40%, more than 45%, more than 50%, more than 55%, more than 60%, more than 65% more than 70% or more than 75% by weight, based on the total weight of the aqueous solvent-based cathode slurry. In certain embodiments, the solid content of the aqueous solvent-based cathode slurry is less than 80%, less than 75%, less than 70%, less than 65%, less than 60%, less than 55%, less than 50% or less than 45% by weight, based on the total weight of the aqueous solvent-based cathode slurry.

The aqueous solvent-based cathode slurry of the present invention can have a higher solid content than conventional cathode slurries. This allows for more cathode active material to be prepared for further processing at any one time, thus improving efficiency and maximizing productivity.

The viscosity of the aqueous solvent-based cathode slurry is preferably less than about 8,000 mPa s. In some embodiments, the viscosity of the aqueous solvent-based cathode slurry is from about 1,000 mPa s to about 8,000 mPa s, from about 1,000 mPa s to about 7,000 mPa s, from about 1,000 mPa s to about 6,000 mPa s, from about 1,000 mPa s to about 5,000 mPa s, from about 1,000 mPa s to about 4,000 mPa s, from about 1,000 mPa s to about 3,000 mPa s, or from about 1,000 mPa s to about 2,000 mPa s. In certain embodiments, the viscosity of the aqueous solvent-based cathode slurry is less than 8,000 mPa s, less than 7,000 mPa s, less than 6,000 mPa s, less than 5,000 mPa s, less than 4,000 mPa s, less than 3,000 mPa s, or less than 2,000 mPa s. In some embodiments, the viscosity of the aqueous solvent-based cathode slurry is more than 1,000 mPa s, more than 2,000 mPa s, more than 3,000 mPa s, more than 4,000 mPa s, more than 5,000 mPa s, more than 6,000 mPa s, or more than 7,000 mPa s. Thus, the resultant slurry can be fully mixed or homogeneous.

The aqueous solvent-based cathode slurry disclosed herein has a small D50, and a uniform and narrow particle size distribution. In some embodiments, the aqueous solvent-based cathode slurry of the present invention has a particle size D50 in the range from about 0.1 μm to about 20 μm, from about 0.2 μm to about 20 μm, from about 0.3 μm to about 20 μm, from about 0.4 μm to about 20 μm, from about 0.5 μm to about 20 μm, from about 0.1 μm to about 19.5 μm, from about 0.2 μm to about 19.5 μm, from about 0.3 μm to about 19.5 μm, from about 0.4 μm to about 19.5 μm, from about 0.5 μm to about 19.5 μm, from about 0.1 μm to about 19 μm, from about 0.2 μm to about 19 μm, from about 0.3 μm to about 19 μm, from about 0.4 μm to about 19 μm, from about 0.5 μm to about 19 μm, from about 0.1 μm to about 18.5 μm, from about 0.2 μm to about 18.5 μm, from about 0.3 μm to about 18.5 μm, from about 0.4 μm to about 18.5 μm, from about 0.5 μm to about 18.5 μm, from about 0.1 μm to about 18 μm, from about 0.2 μm to about 18 μm, from about 0.3 μm to about 18 μm, from about 0.4 μm to about 18 μm, from about 0.5 μm to about 18 μm, from about 0.2 μm to about 17.5 μm, from about 0.2 μm to about 17 μm, from about 0.2 μm to about 16.5 μm, from about 0.2 μm to about 16 μm, from about 0.2 μm to about 15.5 μm, from about 0.2 μm to about 15 μm, from about 0.2 μm to about 14.5 μm, from about 0.2 μm to about 14 μm, from about 0.2 μm to about 13.5 μm, from about 0.2 μm to about 13 μm, from about 0.2 μm to about 12.5 μm, from about 0.2 μm to about 12 μm, from about 0.2 μm to about 11.5 μm, from about 0.2 μm to about 11 μm, from about 0.2 μm to about 10.5 μm, from about 0.2 μm to about 10 μm, from about 0.4 μm to about 17 μm, from about 0.5 μm to about 17 μm, from about 1 μm to about 16 μm, or from about 1 μm to about 15 μm.

In certain embodiments, the particle size D50 of the aqueous solvent-based cathode slurry is less than 20 μm, less than 18 μm, less than 16 μm, less than 14 μm, less than 12 μm, less than 10 μm, less than 8 μm, less than 6 μm, less than 4 μm, less than 2 μm, or less than 1 μm. In some embodiments, the particle diameter D50 of the aqueous solvent-based cathode slurry is greater than 1 μm, greater than 2 μm, greater than 4 μm, greater than 6 μm, greater than 8 μm, greater than 10 μm, greater than 12 μm, greater than 14 μm, greater than 16 μm, or greater than 18 μm.

In some embodiments, the particle size D10 of the aqueous solvent-based cathode slurry is from about 0.05 μm to about 8 μm, from about 0.1 μm to about 8 μm, from about 0.15 μm to about 8 μm, from about 0.2 μm to about 8 μm, from about 0.25 μm to about 8 μm, from about 0.3 μm to about 8 μm, from about 0.35 μm to about 8 μm, from about 0.4 μm to about 8 μm, from about 0.1 μm to about 7.5 μm, from about 0.15 μm to about 7.5 μm, from about 0.2 μm to about 7.5 μm, from about 0.25 μm to about 7.5 μm, from about 0.3 μm to about 7.5 μm, from about 0.35 μm to about 7.5 μm, from about 0.4 μm to about 7.5 μm, from about 0.1 μm to about 7 μm, from about 0.15 μm to about 7 μm, from about 0.2 μm to about 7 μm, from about 0.25 μm to about 7 μm, from about 0.3 μm to about 7 μm, from about 0.35 μm to about 7 μm, from about 0.4 μm to about 7 μm, from about 0.1 μm to about 6.5 μm, from about 0.15 μm to about 6.5 μm, from about 0.2 μm to about 6.5 μm, from about 0.25 μm to about 6.5 μm, from about 0.3 μm to about 6.5 μm, from about 0.35 μm to about 6.5 μm, from about 0.4 μm to about 6.5 μm, from about 0.1 μm to about 6 μm, from about 0.15 μm to about 6 μm, from about 0.2 μm to about 6 μm, from about 0.25 μm to about 6 μm, from about 0.3 μm to about 6 μm, from about 0.35 μm to about 6 μm, from about 0.4 μm to about 6 μm, from about 0.2 μm to about 5 μm, from about 0.2 μm to about 4 μm, from about 0.3 μm to about 5 μm, or from about 0.3 μm to about 4 μm.

In some embodiments, the particle size D10 of the aqueous solvent-based cathode slurry is less than 8 μm, less than 7 μm, less than 6 μm, less than 5 μm, less than 4 μm, less than 3 μm, less than 2 μm, less than 1 μm, less than 0.5 μm, or less than 0.1 μm. In some embodiments, the particle size D10 of the aqueous solvent-based cathode slurry is more than 0.05 μm, more than 0.1 μm, more than 0.5 μm, more than 1 μm, more than 2 μm, more than 3 μm, more than 4 μm, more than 5 μm, more than 6 μm, or more than 7 μm.

In some embodiments, the particle size D90 of the aqueous solvent-based cathode slurry is from about 0.5 μm to about 40 μm, from about 0.5 μm to about 39 μm, from about 0.5 μm to about 38 μm, from about 0.5 μm to about 37 μm, from about 0.5 μm to about 36 μm, from about 0.5 μm to about 35 μm, from about 0.5 μm to about 34 μm, from about 1 μm to about 40 μm, from about 1 μm to about 39 μm, from about 1 μm to about 38 μm, from about 1 μm to about 37 μm, from about 1 μm to about 36 μm, from about 1 μm to about 35 μm, from about 1 μm to about 34 μm, from about 1.5 μm to about 40 μm, from about 1.5 μm to about 39 μm, from about 1.5 μm to about 38 μm, from about 1.5 μm to about 37 μm, from about 1.5 μm to about 36 μm, from about 1.5 μm to about 35 μm, from about 1.5 μm to about 34 μm, from about 2 μm to about 40 μm, from about 2 μm to about 39 μm, from about 2 μm to about 38 μm, from about 2 μm to about 37 μm, from about 2 μm to about 36 μm, from about 2 μm to about 35 μm, from about 2 μm to about 34 μm, from about 1 μm to about 33 μm, from about 1 μm to about 32 μm, from about 1 μm to about 30 μm, from about 1 μm to about 28 μm, from about 1 μm to about 26 μm, from about 1 μm to about 24 μm, from about 1 μm to about 22 μm, from about 1 μm to about 20 μm, from about 2 μm to about 33 μm, from about 2 μm to about 30 μm, from about 2 μm to about 26 μm, from about 2 μm to about 20 μm, or from about 2 μm to about 15 μm.

In some embodiments, the particle size D90 of the aqueous solvent-based cathode slurry is less than 40 μm, less than 38 μm, less than 36 μm, less than 34 μm, less than 32 μm, less than 30 μm, less than 28 μm, less than 26 μm, less than 24 μm, less than 22 μm, less than 20 μm, less than 18 μm, less than 16 μm, less than 14 μm, less than 12 μm, less than 10 μm, less than 8 μm, less than 6 μm, or less than 4 μm. In some embodiments, the particle size D90 of the aqueous solvent-based cathode slurry is more than 0.5 μm, more than 1 μm, more than 2 μm, more than 4 μm, more than 6 μm, more than 8 μm, more than 10 μm, more than 12 μm, more than 14 μm, more than 16 μm, more than 18 μm, more than 20 μm, more than 22 μm, more than 24 μm, more than 26 μm, more than 28 μm, more than 30 μm, more than 32 μm, more than 34 μm, more than 36 μm, or more than 38 μm.

In some embodiments, the ratio of the particle size D90 to the particle size D10 of the aqueous solvent-based cathode slurry is from about 2 to about 10, from about 2.5 to about 10, from about 3 to about 10, from about 3.5 to about 10, from about 4 to about 10, from about 4.5 to about 10, from about 5 to about 10, from about 2 to about 9.5, from about 2.5 to about 9.5, from about 3 to about 9.5, from about 3.5 to about 9.5, from about 4 to about 9.5, from about 4.5 to about 9.5, from about 5 to about 9.5, from about 2 to about 9, from about 2.5 to about 9, from about 3 to about 9, from about 3.5 to about 9, from about 4 to about 9, from about 4.5 to about 9, from about 5 to about 9, from about 2 to about 8.5, from about 2.5 to about 8.5, from about 3 to about 8.5, from about 3.5 to about 8.5, from about 4 to about 8.5, from about 4.5 to about 8.5, from about 5 to about 8.5, from about 2 to about 8, from about 2 to about 7.5, from about 2 to about 7, from about 2 to about 6.5, from about 2 to about 6, from about 3 to about 8, from about 3 to about 7, or from about 3 to about 6.

In some embodiments, the ratio of the particle size D90 to the particle size D10 of the aqueous solvent-based cathode slurry is less than 10, less than 9.5, less than 9, less than 8.5, less than 8, less than 7.5, less than 7, less than 6.5, less than 6, less than 5.5, less than 5, less than 4.5, less than 4, less than 3.5, less than 3, or less than 2.5. In some embodiments, the ratio of the particle size D90 to the particle size D10 of the aqueous solvent-based cathode slurry is more than 2, more than 2.5, more than 3, more than 3.5, more than 4, more than 4.5, more than 5, more than 5.5, more than 6, more than 6.5, more than 7, more than 7.5, more than 8, more than 8.5, more than 9, or more than 9.5.

In conventional methods of preparing cathode slurries, a dispersing agent may be used to assist in dispersing the cathode active material, conductive agent and binder material in the slurry solvent. In some embodiments, the dispersing agent is a nonionic surfactant, an anionic surfactant, a cationic surfactant, an amphoteric surfactant, or combinations thereof. One of the advantages of the present invention is that the cathode slurry materials can be dispersed homogeneously at room temperature without the use of a dispersing agent. This is beneficial since the presence of the dispersing agent in the cathode layer may cause worsened electrochemical performance. Moreover, surfactants can cause damage to the environment when released, and many surfactants are toxic.

In some embodiments, the method of the present invention does not comprise a step of adding a dispersing agent to the first suspension, second suspension, third suspension or the homogenized aqueous solvent-based cathode slurry. In certain embodiments, each of the first suspension, the second suspension, the third suspension and the homogenized aqueous solvent-based cathode slurry is independently free of a dispersing agent. In some embodiments, the method of the present invention does not comprise a step of adding a nonionic surfactant, an anionic surfactant, a cationic surfactant, an amphoteric surfactant, or combinations thereof to the first suspension, second suspension, third suspension or the homogenized aqueous solvent-based cathode slurry. In certain embodiments, each of the first suspension, the second suspension, the third suspension and the homogenized aqueous solvent-based cathode slurry is independently free of nonionic surfactant, anionic surfactant, cationic surfactant and amphoteric surfactant.

In some embodiments, no anionic surfactants including fatty acid salts; alkyl sulfates; polyoxyalkylene alkyl ether acetates; alkylbenzene sulfonates; polyoxyalkylene alkyl ether sulfates; higher fatty acid amide sulfonates; N-acylsarcosin salts; alkyl phosphates; polyoxyalkylene alkyl ether phosphate salts; long-chain sulfosuccinates; long-chain N-acylglutamates; polymers and copolymers comprising acrylic acids, anhydrides, esters, vinyl monomers and/or olefins and their alkali metal, alkaline earth metal and/or ammonium salt derivatives; salts of polycarboxylic acids; formalin condensate of naphthalene sulfonic acid; alkyl naphthalene sulfonic acid; naphthalene sulfonic acid; alkyl naphthalene sulfonate; formalin condensates of acids and naphthalene sulfonates such as their alkali metal salts, alkaline earth metal salts, ammonium salts or amine salts; melamine sulfonic acid; alkyl melamine sulfonic acid; formalin condensate of melamine sulfonic acid; formalin condensate of alkyl melamine sulfonic acid; alkali metal salts, alkaline earth metal salts, ammonium salts and amine salts of melamine sulfonates; lignin sulfonic acid; and alkali metal salts, alkaline earth metal salts, ammonium salts and amine salts of lignin sulfonates are added to the aqueous solvent-based cathode slurry.

In some embodiments, no cationic surfactants including alkyltrimethylammonium salts such as stearyltrimethylammonium chloride, lauryltrimethylammonium chloride and cetyltrimethylammonium bromide; dialkyldimethylammonium salts; trialkylmethylammonium salts; tetraalkylammonium salts; alkylamine salts; benzalkonium salts; alkylpyridinium salts; and imidazolium salts are added to the aqueous solvent-based cathode slurry.

In some embodiments, no nonionic surfactants including polyoxyalkylene oxide-added alkyl ethers; polyoxyalkylene styrene phenyl ethers; polyhydric alcohols; ester compounds of monovalent fatty acid; polyoxyalkylene alkylphenyl ethers; polyoxyalkylene fatty acid ethers; polyoxyalkylene sorbitan fatty acid esters; glycerin fatty acid esters; polyoxyalkylene castor oil; polyoxyalkylene hydrogenated castor oil; polyoxyalkylene sorbitol fatty acid ester; polyglycerin fatty acid ester; alkyl glycerin ether; polyoxyalkylene cholesteryl ether; alkyl polyglucoside; sucrose fatty acid ester; polyoxyalkylene alkyl amine; polyoxyethylene-polyoxypropylene block polymers; sorbitan fatty acid ester; and fatty acid alkanolamides are added to the aqueous solvent-based cathode slurry.

In some embodiments, no amphoteric surfactants including 2-undecyl-N, N-(hydroxyethylcarboxymethyl)-2-imidazoline sodium salt, 2-cocoyl-2-imidazolinium hydroxide-1-carboxyethyloxy disodium salt; imidazoline-based amphoteric surfactants; 2-heptadecyl-N-carboxymethyl-N-hydroxyethyl imidazolium betaine, lauryldimethylaminoacetic acid betaine, alkyl betaine, amide betaine, sulfobetaine and other betaine-based amphoteric surfactants; N-laurylglycine, N-lauryl β-alanine, N-stearyl β-alanine, lauryl dimethylamino oxide, oleyl dimethylamino oxide, sodium lauroyl glutamate, lauryl dimethylaminoacetic acid betaine, stearyl dimethylaminoacetic acid betaine, cocamidopropyl hydroxysultaine, and 2-alkyl-N-carboxymethyl-N-hydroxyethylimidazolinium betaine are added to the aqueous solvent-based cathode slurry.

In some embodiments, after uniform mixing of cathode slurry materials, the homogenized aqueous solvent-based cathode slurry can be applied on a current collector to form a coated film on the current collector in step 105. The current collector acts to collect electrons generated by electrochemical reactions of the cathode active material or to supply electrons required for the electrochemical reactions.

In some embodiments, the current collector can be in the form of a foil, sheet or film. In certain embodiments, the current collector is stainless steel, titanium, nickel, aluminum, copper, or alloys thereof; or electrically-conductive resin. In certain embodiments, the current collector has a two-layered structure comprising an outer layer and an inner layer, wherein the outer layer comprises a conductive material and the inner layer comprises an insulating material or another conductive material; for example, aluminum mounted with a conductive resin layer or a polymeric insulating material coated with an aluminum film. In some embodiments, the current collector has a three-layered structure comprising an outer layer, a middle layer and an inner layer, wherein the outer and inner layers comprise a conductive material and the middle layer comprises an insulating material or another conductive material; for example, a plastic substrate coated with a metal film on both sides. In certain embodiments, each of the outer layer, middle layer and inner layer is independently stainless steel, titanium, nickel, aluminum, copper, or alloys thereof; or electrically-conductive resin. In some embodiments, the insulating material is a polymeric material selected from the group consisting of polycarbonate, polyacrylate, polyacrylonitrile, polyester, polyamide, polystyrene, polyurethane, polyepoxy, poly(acrylonitrile butadiene styrene), polyimide, polyolefin, polyethylene, polypropylene, polyphenylene sulfide, poly(vinyl ester), polyvinyl chloride, polyether, polyphenylene oxide, cellulose polymer, and combinations thereof. In certain embodiments, the current collector has more than three layers. In some embodiments, the current collector is coated with a protective coating. In certain embodiments, the protective coating comprises a carbon-containing material. In some embodiments, the current collector is not coated with a protective coating.

In some embodiments, a conductive layer can be coated on an aluminum current collector to improve its current conductivity. In certain embodiments, the conductive layer comprises a material selected from the group consisting of carbon, carbon black, graphite, expanded graphite, graphene, graphene nanoplatelets, carbon fibers, carbon nano-fibers, graphitized carbon flake, carbon tubes, carbon nanotubes, activated carbon, Super P, 0-dimensional KS6, 1-dimensional vapor grown carbon fibers (VGCF), mesoporous carbon, and combinations thereof. In some embodiments, the conductive layer does not comprise carbon, carbon black, graphite, expanded graphite, graphene, graphene nanoplatelets, carbon fibers, carbon nano-fibers, graphitized carbon flake, carbon tubes, carbon nanotubes, activated carbon, Super P, 0-dimensional KS6, 1-dimensional vapor grown carbon fibers (VGCF), or mesoporous carbon.

In some embodiments, the conductive layer has a thickness from about 0.5 μm to about 5.0 μm. Thickness of the conductive layer will affect the volume occupied by the current collector within a battery and the amount of the electrode material and hence the capacity in the battery.

In certain embodiments, the thickness of the conductive layer on the current collector is from about 0.5 μm to about 4.5 μm, from about 1.0 μm to about 4.0 μm, from about 1.0 μm to about 3.5 μm, from about 1.0 μm to about 3.0 μm, from about 1.0 μm to about 2.5 μm, from about 1.0 μm to about 2.0 μm, from about 1.1 μm to about 2.0 μm, from about 1.2 μm to about 2.0 μm, from about 1.5 μm to about 2.0 μm, from about 1.8 μm to about 2.0 μm, from about 1.0 μm to about 1.8 μm, from about 1.2 μm to about 1.8 μm, from about 1.5 μm to about 1.8 μm, from about 1.0 μm to about 1.5 μm, or from about 1.2 to about 1.5 μm. In some embodiments, the thickness of the conductive layer on the current collector is less than 4.5 μm, less than 4.0 μm, less than 3.5 μm, less than 3.0 μm, less than 2.5 μm, less than 2.0 μm, less than 1.8 μm, less than 1.5 μm, or less than 1.2 μm. In some embodiments, the thickness of the conductive layer on the current collector is more than 1.0 μm, more than 1.2 μm, more than 1.5 inn, more than 1.8 inn, more than 2.0 μm, more than 2.5 μm, more than 3.0 μm, or more than 3.5 μm.

The thickness of the current collector affects the volume it occupies within the battery, the amount of the electrode active material needed, and hence the capacity in the battery. In some embodiments, the current collector has a thickness from about 5 μm to about 30 μm. In certain embodiments, the current collector has a thickness from about 5 μm to about 20 μm, from about 5 μm to about 15 μm, from about 10 μm to about 30 μm, from about 10 μm to about 25 μm, or from about 10 μm to about 20 μm.

In certain embodiments, the coating process is performed using a doctor blade coater, a slot-die coater, a transfer coater, a spray coater, a roll coater, a gravure coater, a dip coater, or a curtain coater.

Evaporating the solvent is needed to create a dry porous electrode, and which is in turn needed to fabricate the battery. In some embodiments, the cathode is formed by drying the coated film on the current collector in step 106.

Any dryer that can dry the coated film on the current collector can be used herein. Some non-limiting examples of the dryer include a batch drying oven, a conveyor drying oven, and a microwave drying oven. Some non-limiting examples of the conveyor drying oven include a conveyor hot air-drying oven, a conveyor resistance drying oven, a conveyor inductive drying oven, and a conveyor microwave drying oven.

In some embodiments, the conveyor drying oven for drying the coated film on the current collector includes one or more heating sections, wherein each of the heating sections is individually temperature-controlled, and wherein each of the heating sections may include independently controlled heating zones.

In certain embodiments, the conveyor drying oven comprises a first heating section positioned on one side of the conveyor and a second heating section positioned on an opposing side of the conveyor from the first heating section, wherein each of the first and second heating sections independently comprises one or more heating elements and a temperature control system connected to the heating elements of the first heating section and the second heating section in a manner to monitor and selectively control the temperature of each heating section.

In some embodiments, the conveyor drying oven comprises a plurality of heating sections, wherein each heating section includes independent heating elements that are operated to maintain a constant temperature within the heating section.

In certain embodiments, each of the first and second heating sections independently has an inlet heating zone and an outlet heating zone, wherein each of the inlet and outlet heating zones independently comprises one or more heating elements and a temperature control system connected to the heating elements of the inlet heating zone and the outlet heating zone in a manner to monitor and selectively control the temperature of each heating zone separately from the temperature control of the other heating zones.

The coated film on the current collector should be dried at a temperature of approximately 90° C. or less in approximately 20 minutes or less. Drying the coated positive electrode at temperatures above 90° C. may result in undesirable deformation of the cathode, thus affecting the performance of the positive electrode.

In some embodiments, the coated film on the current collector can be dried at a temperature from about 25° C. to about 90° C. In certain embodiments, the coated film on the current collector can be dried at a temperature from about 25° C. to about 80° C., from about 25° C. to about 70° C., from about 25° C. to about 60° C., from about 35° C. to about 90° C., from about 35° C. to about 80° C., from about 35° C. to about 75° C., from about 40° C. to about 90° C., from about 40° C. to about 80° C., or from about 40° C. to about 75° C. In some embodiments, the coated film on the current collector is dried at a temperature of less than 90° C., less than 85° C., less than 80° C., less than 75° C., less than 70° C., less than 65° C., less than 60° C., less than 55° C., or less than 50° C. In some embodiments, the coated film on the current collector is dried at a temperature of higher than 25° C., higher than 30° C., higher than 35° C., higher than 40° C., higher than 45° C., higher 50° C., higher than 55° C., higher than 60° C., higher than 65° C., higher than 70° C., higher than 75° C., higher than 80° C., or higher than 85° C.

In certain embodiments, the conveyor moves at a speed from about 1 meter/minute to about 120 meters/minute, from about 1 meter/minute to about 100 meters/minute, from about 1 meter/minute to about 80 meters/minute, from about 1 meter/minute to about 60 meters/minute, from about 1 meter/minute to about 40 meters/minute, from about 10 meters/minute to about 120 meters/minute, from about 10 meters/minute to about 80 meters/minute, from about 10 meters/minute to about 60 meters/minute, from about 10 meters/minute to about 40 meters/minute, from about 25 meters/minute to about 120 meters/minute, from about 25 meters/minute to about 100 meters/minute, from about 25 meters/minute to about 80 meters/minute, from about 25 meters/minute to about 60 meters/minute, from about 50 meters/minute to about 120 meters/minute, from about 50 meters/minute to about 100 meters/minute, from about 50 meters/minute to about 80 meters/minute, from about 75 meters/minute to about 120 meters/minute, from about 75 meters/minute to about 100 meters/minute, from about 2 meters/minute to about 25 meters/minute, from about 2 meters/minute to about 20 meters/minute, from about 3 meters/minute to about 30 meters/minute, or from about 3 meters/minute to about 20 meters/minute.

Controlling the conveyor length and speed can regulate the drying time of the coated film. In some embodiments, the coated film on the current collector can be dried for a time period from about 1 minute to about 30 minutes, from about 1 minute to about 25 minutes, from about 2 minutes to about 20 minutes, from about 2 minutes to about 15 minutes, from about 2 minutes to about 10 minutes, from about 5 minutes to about 30 minutes, from about 5 minutes to about 20 minutes, from about 5 minutes to about 10 minutes, from about 10 minutes to about 30 minutes, or from about 10 minutes to about 20 minutes. In certain embodiments, the coated film on the current collector can be dried for a time period of less than 30 minutes, less than 25 minutes, less than 20 minutes, less than 15 minutes, less than 10 minutes, or less than 5 minutes. In some embodiments, the coated film on the current collector can be dried for a time period of more than 1 minute, more than 5 minutes, more than 10 minutes, more than 15 minutes, more than 20 minutes, or more than 25 minutes.

After the coated film on the current collector is dried, a cathode is formed. In some embodiments, the cathode is compressed mechanically in order to enhance the density of the cathode. In some embodiments, the dried and compressed coated film on the current collector is designated as an electrode layer.

In some embodiments, the proportion of the lithium compound in the electrode layer of the cathode is from about 0.01% to about 10%, from about 0.025% to about 10%, from about 0.05% to about 10%, from about 0.075% to about 10%, from about 0.1% to about 10%, from about 0.25% to about 10%, from about 0.5% to about 10%, from about 0.75% to about 10%, from about 0.75% to about 8%, from about 0.75% to about 6%, from about 0.75% to about 4%, from about 0.75% to about 3%, from about 0.75% to about 2%, from about 0.75% to about 1.5%, or from about 0.75% to about 1% by weight, based on the total weight of the electrode layer.

In some embodiments, the proportion of the lithium compound in the electrode layer of the cathode is less than 10%, less than 8%, less than 6%, less than 4%, less than 3%, less than 2%, less than 1.5%, less than 1%, less than 0.75%, less than 0.5%, less than 0.25%, less than 0.1%, less than 0.08%, or less than 0.05% by weight, based on the total weight of the electrode layer. In some embodiments, the proportion of the lithium compound in the electrode layer of the cathode is more than 0.01%, more than 0.025%, more than 0.05%, more than 0.075%, more than 0.1%, more than 0.25%, more than 0.5%, more than 0.75%, more than 1%, more than 1.5%, more than 2%, more than 3%, more than 4%, or more than 6% by weight, based on the total weight of the electrode layer.

In some embodiments, the proportion of the binder material in the electrode layer of the cathode is from about 0.125% to about 25%, from about 0.25% to about 25%, from about 0.375% to about 25%, from about 0.5% to about 25%, from about 1% to about 25%, from about 1.5% to about 25%, from about 2% to about 25%, from about 4% to about 25%, from about 4% to about 22.5%, from about 4% to about 20%, from about 4% to about 17.5%, from about 4% to about 15%, from about 4% to about 12.5%, from about 4% to about 10%, or from about 4% to about 8% by weight, based on the total weight of the electrode layer.

In some embodiments, the proportion of the binder material in the electrode layer of the cathode is less than 25%, less than 22.5%, less than 20%, less than 17.5%, less than 15%, less than 12.5%, less than 10%, less than 8%, less than 6%, less than 4%, less than 2%, less than 1.5%, or less than 1% by weight, based on the total weight of the electrode layer. In some embodiments, the proportion of the binder material in the electrode layer of the cathode is more than 0.125%, more than 0.25%, more than 0.375%, more than 0.5%, more than 1%, more than 1.5%, more than 2%, more than 4%, more than 6%, more than 8%, more than 10%, more than 12.5%, or more than 15% by weight, based on the total weight of the electrode layer.

In some embodiments, the proportion of the conductive agent in the electrode layer of the cathode is from about 0.625% to about 12.5%, from about 0.75% to about 12.5%, from about 0.875% to about 12.5%, from about 1% to about 12.5%, from about 1.5% to about 12.5%, from about 2% to about 12.5%, from about 2.5% to about 12.5%, from about 3% to about 12.5%, from about 3.5% to about 12.5%, from about 3.5% to about 10%, from about 3.5% to about 9%, from about 3.5% to about 8%, from about 3.5% to about 7%, from about 3.5% to about 6%, from about 3.5% to about 5.5%, from about 3.5% to about 5%, or from about 3.5% to about 4.5% by weight, based on the total weight of the electrode layer.

In some embodiments, the proportion of the conductive agent in the electrode layer of the cathode is less than 12.5%, less than 10%, less than 9%, less than 8%, less than 7%, less than 6%, less than 5.5%, less than 5%, less than 4.5%, less than 4%, less than 3.5%, less than 3%, less than 2.5%, less than 2%, less than 1.5%, or less than 1% by weight, based on the total weight of the electrode layer. In some embodiments, the proportion of the conductive agent in the electrode layer of the cathode is more than 0.625%, more than 0.75%, more than 0.875%, more than 1%, more than 1.5%, more than 2%, more than 2.5%, more than 3%, more than 3.5%, more than 4%, more than 4.5%, more than 5%, more than 5.5%, more than 6%, more than 7%, or more than 8% by weight, based on the total weight of the electrode layer.

In some embodiments, the proportion of the cathode active material in the electrode layer of the cathode is from about 50% to about 99%, from about 52.5% to about 99%, from about 55% to about 99%, from about 57.5% to about 99%, from about 60% to about 99%, from about 62.5% to about 99%, from about 65% to about 99%, from about 67.5% to about 99%, from about 70% to about 99%, from about 70% to about 97.5%, from about 70% to about 95%, from about 70% to about 92.5%, from about 70% to about 90%, from about 70% to about 87.5%, from about 70% to about 85%, from about 70% to about 82.5%, or from about 70% to about 80% by weight, based on the total weight of the electrode layer.

In some embodiments, the proportion of the cathode active material in the electrode layer of the cathode is less than 99%, less than 97.5%, less than 95%, less than 92.5%, less than 90%, less than 87.5%, less than 85%, less than 82.5%, less than 80%, less than 77.5%, less than 75%, less than 72.5%, less than 70%, less than 67.5%, less than 65%, less than 62.5%, less than 60%, less than 57.5%, or less than 55% by weight, based on the total weight of the electrode layer. In some embodiments, the proportion of the cathode active material in the electrode layer of the cathode is more than 50%, more than 52.5%, more than 55%, more than 57.5%, more than 60%, more than 62.5%, more than 65%, more than 67.5%, more than 70%, more than 72.5%, more than 75%, more than 77.5%, more than 80%, more than 82.5%, more than 85%, more than 87.5%, more than 90%, more than 92.5%, or more than 95% by weight, based on the total weight of the electrode layer.

In certain embodiments, the thickness of each of the cathode and anode electrode layers on the current collector is independently from about 5 μm to about 90 μm, from about 5 μm to about 50 μm, from about 5 μm to about 25 μm, from about 10 μm to about 90 μm, from about 10 μm to about 50 μm, from about 10 μm to about 30 μm, from about 15 μm to about 90 μm, from about 20 μm to about 90 μm, from about 25 μm to about 90 μm, from about 25 μm to about 80 μm, from about 25 μm to about 75 μm, from about 25 μm to about 50 μm, from about 30 μm to about 90 μm, from about 30 μm to about 80 μm, from about 35 μm to about 90 μm, from about 35 μm to about 85 μm, from about 35 μm to about 80 μm, or from about 35 μm to about 75 μm.

In some embodiments, the thickness of each of the cathode and anode electrode layers on the current collector is independently more than 5 μm, more than 10 μm, more than 15 μm, more than 20 μm, more than 25 μm, more than 30 μm, more than 35 μm, more than 40 μm, more than 45 μm, more than 50 μm, more than 55 μm, more than 60 μm, more than 65 μm, more than 70 μm, more than 75 μm, or more than 80 μm. In some embodiments, the thickness of each of the cathode and anode electrode layers on the current collector is independently less than 90 μm, less than 85 μm, less than 80 μm, less than 75 μm, less than 70 μm, less than 65 μm, less than 60 μm, less than 55 μm, less than 50 μm, less than 45 μm, less than 40 μm, less than 35 μm, less than 30 μm, less than 25 μm, less than 20 μm, less than 15 μm, or less than 10 μm.

In some embodiments, the surface density of each of the cathode and anode electrode layers on the current collector is independently from about 1 mg/cm² to about 40 mg/cm², from about 1 mg/cm² to about 35 mg/cm², from about 1 mg/cm² to about 30 mg/cm², from about 1 mg/cm² to about 25 mg/cm², from about 1 mg/cm² to about 15 mg/cm², from about 3 mg/cm² to about 40 mg/cm², from about 3 mg/cm² to about 35 mg/cm², from about 3 mg/cm² to about 30 mg/cm², from about 3 mg/cm² to about 25 mg/cm², from about 3 mg/cm² to about 20 mg/cm², from about 3 mg/cm² to about 15 mg/cm², from about 5 mg/cm² to about 40 mg/cm², from about 5 mg/cm² to about 35 mg/cm², from about 5 mg/cm² to about 30 mg/cm², from about 5 mg/cm² to about 25 mg/cm², from about 5 mg/cm² to about 20 mg/cm², from about 5 mg/cm² to about 15 mg/cm², from about 8 mg/cm² to about 40 mg/cm², from about 8 mg/cm² to about 35 mg/cm², from about 8 mg/cm² to about 30 mg/cm², from about 8 mg/cm² to about 25 mg/cm², from about 8 mg/cm² to about 20 mg/cm², from about 10 mg/cm² to about 40 mg/cm², from about 10 mg/cm² to about 35 mg/cm², from about 10 mg/cm² to about 30 mg/cm², from about 10 mg/cm² to about 25 mg/cm², from about 10 mg/cm² to about 20 mg/cm², from about 15 mg/cm² to about 40 mg/cm², or from about 20 mg/cm² to about 40 mg/cm².

In some embodiments, the surface density of each of the cathode and anode electrode layers on the current collector is independently less than 40 mg/cm², less than 36 mg/cm², less than 32 mg/cm², less than 28 mg/cm², less than 24 mg/cm², less than 20 mg/cm², less than 16 mg/cm², less than 12 mg/cm², less than 8 mg/cm², or less than 4 mg/cm². In some embodiments, the surface density of each of the cathode and anode electrode layers on the current collector is independently more than 1 mg/cm², more than 4 mg/cm², more than 8 mg/cm², more than 12 mg/cm², more than 16 mg/cm², more than 20 mg/cm², more than 24 mg/cm², more than 28 mg/cm², more than 32 mg/cm², or more than 36 mg/cm².

In some embodiments, the density of each of the cathode and anode electrode layers on the current collector is independently from about 0.5 g/cm³ to about 6.5 g/cm³, from about 0.5 g/cm³ to about 6.0 g/cm³, from about 0.5 g/cm³ to about 5.5 g/cm³, from about 0.5 g/cm³ to about 5.0 g/cm³, from about 0.5 g/cm³ to about 4.5 g/cm³, from about 0.5 g/cm³ to about 4.0 g/cm³, from about 0.5 g/cm³ to about 3.5 g/cm³, from about 0.5 g/cm³ to about 3.0 g/cm³, from about 0.5 g/cm³ to about 2.5 g/cm³, from about 1.0 g/cm³ to about 6.5 g/cm³, from about 1.0 g/cm³ to about 5.5 g/cm³, from about 1.0 g/cm³ to about 4.5 g/cm³, from about 1.0 g/cm³ to about 3.5 g/cm³, from about 2.0 g/cm³ to about 6.5 g/cm³, from about 2.0 g/cm³ to about 5.5 g/cm³, from about 2.0 g/cm³ to about 4.5 g/cm³, from about 3.0 g/cm³ to about 6.5 g/cm³, or from about 3.0 g/cm³ to about 6.0 g/cm³.

In some embodiments, the density of each of the cathode and anode electrode layers on the current collector is independently less than 6.5 g/cm³, less than 6.0 g/cm³, less than 5.5 g/cm³, less than 5.0 g/cm³, less than 4.5 g/cm³, less than 4.0 g/cm³, less than 3.5 g/cm³, less than 3.0 g/cm³, less than 2.5 g/cm³, less than 2.0 g/cm³, less than 1.5 g/cm³, or less than 0.5 g/cm³. In some embodiments, the density of each of the cathode and anode electrode layers on the current collector is independently more than 0.5 g/cm³, more than 1.0 g/cm³, more than 1.5 g/cm³, more than 2.0 g/cm³, more than 2.5 g/cm³, more than 3.0 g/cm³, more than 3.5 g/cm³, more than 4.0 g/cm³, more than 4.5 g/cm³, more than 5.0 g/cm³, more than 5.5 g/cm³, or more than 6.0 g/cm³.

In some embodiments, lithium compound is dissolved into the aqueous solvent-based cathode slurry. Following drying of the slurry, for example in an electrode layer produced via coating the said slurry, the lithium compound would be crystallized out of solution. As a result, in some embodiments, the lithium compound forms grains of small size. In some embodiments, such grains are attached to the cathode active material particles. This may be advantageous as the presence of the lithium compound attached to the surface of the cathode active material particles may help reduce loss of lithium ions from the cathode active materials.

In some embodiments, the average length of the lithium compound grains in the electrode layer of the cathode is from about 0.1 μm to about 10 μm, from about 0.15 μm to about 10 μm, from about 0.2 μm to about 10 μm, from about 0.25 μm to about 10 μm, from about 0.5 μm to about 10 μm, from about 0.75 μm to about 10 μm, from about 1 μm to about 10 μm, from about 1.25 μm to about 10 μm, from about 1.5 μm to about 10 μm, from about 1.5 μm to about 9 μm, from about 1.5 μm to about 8 μm, from about 1.5 μm to about 7 μm, from about 1.5 μm to about 6 μm, from about 1.5 μm to about 5 μm, from about 1.5 μm to about 4 μm, from about 1.5 μm to about 3.5 μm, from about 1.5 μm to about 3 μm, from about 0.1 μm to about 5 μm, from about 0.15 μm to about 5 μm, from about 0.2 μm to about 5 μm, from about 0.25 μm to about 5 μm, from about 0.5 μm to about 5 μm, from about 0.75 μm to about 5 μm, from about 1 μm to about 5 μm, from about 1.25 μm to about 5 μm, from 0.1 μm to about 3 μm, from about 0.15 μm to about 3 μm, from about 0.2 μm to about 3 μm, from about 0.25 μm to about 3 μm, from about 0.5 μm to about 3 μm, from about 0.75 μm to about 3 μm, from about 1 μm to about 3 μm, or from about 1.25 μm to about 3 μm.

In some embodiments, the average length of the lithium compound grains in the electrode layer of the cathode is less than 10 μm, less than 9 μm, less than 8 μm, less than 7 μm, less than 6 μm, less than 5 μm, less than 4 μm, less than 3.5 μm, less than 3 μm, less than 2.5 μm, less than 2 μm, less than 1.75 μm, less than 1.5 μm, less than 1.25 μm, less than 1 μm, or less than 0.75 μm. In some embodiments, the average length of the lithium compound grains in the electrode layer of the cathode is more than 0.1 μm, more than 0.15 μm, more than 0.2 μm, more than 0.25 μm, more than 0.5 μm, more than 0.75 μm, more than 1 μm, more than 1.25 μm, more than 1.5 μm, more than 1.75 μm, more than 2 μm, more than 2.5 μm, more than 3 μm, more than 3.5 μm, more than 4 μm, or more than 5 μm.

In some embodiments, the ratio of average cathode active material diameter to average lithium compound grain length in the electrode layer of the cathode is from about 1:1 to about 100:1, from about 1.5:1 to about 100:1, from about 2:1 to about 100:1, from about 2.5:1 to about 100:1, from about 5:1 to about 100:1, from about 10:1 to about 100:1, from about 15:1 to about 100:1, from about 20:1 to about 100:1, from about 25:1 to about 100:1, from about 25:1 to about 90:1, from about 25:1 to about 80:1, from about 25:1 to about 70:1, from about 25:1 to about 60:1, from about 25:1 to about 50:1, from about 25:1 to about 45:1, from about 25:1 to about 40:1, from about 25:1 to about 35:1, from about 1:1 to about 25:1, from about 1.5:1 to about 25:1, from about 2:1 to about 25:1, from about 2.5:1 to about 25:1, from about 5:1 to about 25:1, from about 10:1 to about 25:1, from about 1:1 to about 50:1, from about 1.5:1 to about 50:1, from about 2:1 to about 50:1, from about 2.5:1 to about 50:1, from about 5:1 to about 50:1, from about 10:1 to about 50:1, from about 15:1 to about 50:1, or from about 20:1 to about 50:1.

In some embodiments, the ratio of average cathode active material diameter to average lithium compound grain length in the electrode layer of the cathode is more than 1:1, more than 1.5:1, more than 2:1, more than 2.5:1, more than 5:1, more than 10:1, more than 15:1, more than 20:1, more than 25:1, more than 30:1, more than 35:1, more than 40:1, more than 45:1, more than 50:1, more than 60:1, more than 70:1, or more than 80:1. In some embodiments, the ratio of average cathode active material diameter to average lithium compound grain length in the electrode layer of the cathode is less than 100:1, less than 90:1, less than 80:1, less than 70:1, less than 60:1, less than 50:1, less than 45:1, less than 40:1, less than 35:1, less than 30:1, less than 25:1, less than 20:1, less than 15:1, less than 10:1, less than 5:1, less than 2.5:1, or less than 2:1.

Cathodes prepared by the present invention exhibit strong adhesion of the electrode layer to the current collector. It is important for the electrode layer to have good peeling strength to the current collector as this prevents delamination or separation of the electrode, which would greatly influence the mechanical stability of the electrodes and the cyclability of the battery. Therefore, the electrode should have sufficient peeling strength to withstand the rigors of battery manufacture.

In some embodiments, the peeling strength between the current collector and the electrode layer of the cathode is in the range from about 1.0 N/cm to about 8.0 N/cm, from about 1.0 N/cm to about 6.0 N/cm, from about 1.0 N/cm to about 5.0 N/cm, from about 1.0 N/cm to about 4.0 N/cm, from about 1.0 N/cm to about 3.0 N/cm, from about 1.0 N/cm to about 2.5 N/cm, from about 1.0 N/cm to about 2.0 N/cm, from about 1.2 N/cm to about 3.0 N/cm, from about 1.2 N/cm to about 2.5 N/cm, from about 1.2 N/cm to about 2.0 N/cm, from about 1.5 N/cm to about 3.0 N/cm, from about 1.5 N/cm to about 2.5 N/cm, from about 1.5 N/cm to about 2.0 N/cm from about 1.8 N/cm to about 3.0 N/cm, from about 1.8 N/cm to about 2.5 N/cm, from about 2.0 N/cm to about 6.0 N/cm, from about 2.0 N/cm to about 5.0 N/cm, from about 2.0 N/cm to about 3.0 N/cm, from about 2.0 N/cm to about 2.5 N/cm, from about 2.2 N/cm to about 3.0 N/cm, from about 2.5 N/cm to about 3.0 N/cm, from about 3.0 N/cm to about 8.0 N/cm, from about 3.0 N/cm to about 6.0 N/cm, or from about 4.0 N/cm to about 6.0 N/cm.

In some embodiments, the peeling strength between the current collector and the electrode layer of the cathode is more than 1.0 N/cm, more than 1.2 N/cm, more than 1.5 N/cm, more than 2.0 N/cm, more than 2.2 N/cm, more than 2.5 N/cm, more than 3.0 N/cm, more than 3.5 N/cm, more than 4.5 N/cm, more than 5.0 N/cm, more than 5.5 N/cm, more than 6.0 N/cm, more than 6.5 N/cm, or more than 7.0 N/cm. In some embodiments, the peeling strength between the current collector and the electrode layer of the cathode is less than 8.0 N/cm, less than 7.5 N/cm, less than 7 N/cm, less than 6.5 N/cm, less than 6.0 N/cm, less than 5.5 N/cm, less than 5.0 N/cm, less than 4.5 N/cm, less than 4.0 N/cm, less than 3.5 N/cm, less than 3.0 N/cm, less than 2.8 N/cm, less than 2.5 N/cm, less than 2.2 N/cm, less than 2.0 N/cm, less than 1.8 N/cm, or less than 1.5 N/cm.

The method disclosed herein has the advantage that aqueous solvents can be used in the manufacturing process, which can save processing time and equipment, as well as improve safety by eliminating the need to handle or recycle hazardous organic solvents. In addition, costs are reduced by simplifying the overall process. Therefore, this method is especially suited for industrial processes because of its low cost and ease of handling.

As described above, by adding the lithium compound to the aqueous solvent-based cathode slurry comprising the water-compatible copolymeric binder disclosed herein, irreversible lithium ion loss in initial cycling of a battery comprising a cathode produced by such an aqueous solvent-based cathode slurry can be compensated. The water-soluble nature of the lithium compound and the binding capability of the water-compatible copolymeric binder in water both contribute to good dispersion of the various cathode materials, including the lithium compound, within the cathode slurry. As a result, a consistently low resistance and an even pore distribution are also achieved within the said cathode, thereby improving the electrochemical performance of a battery comprising such a cathode. Therefore, the development of aqueous solvent-based cathode slurries capable of improving battery performance such as cyclability and capacity is achieved by the present invention.

Also provided herein is an electrode assembly comprising a cathode prepared by the method described below. The electrode assembly comprises at least one cathode, at least one anode, and at least one separator placed in between the cathode and anode.

It should be noted that the present invention is not limited to lithium-ion batteries. Other metal-ion batteries may use other metal compounds that are soluble in aqueous solvent and match the corresponding chemistries of the batteries to compensate for the irreversible capacity loss due to SEI formation. For example, sodium-ion batteries would employ sodium analogues of the lithium compounds disclosed, such as sodium azide (NaN₃), sodium nitrite (NaNO₂), sodium chloride (NaCl), sodium deltate (Na₂C₃O₃), sodium squarate (Na₂C₄O₄), sodium croconate (Na₂C₅O₅), sodium rhodizonate (Na₂C₆O₆), sodium ketomalonate (Na₂C₃O₅), sodium diketosuccinate (Na₂C₄O₆), sodium hydrazide, sodium fluoride (NaF), sodium bromide (NaBr), sodium iodide (NaI), sodium sulfite (Na₂SO₃), sodium selenite (Na₂SeO₃), sodium nitrate (NaNO₃), sodium acetate (CH₃COONa), sodium salt of 3,4-dihydroxybenzoic acid (Na₂DHBA), sodium salt of 3,4-dihydroxybutyric acid, sodium formate, sodium hydroxide, sodium dodecyl sulfate, sodium succinate, sodium citrate, or combinations thereof.

Some non-limiting examples of the sodium compound include sodium salts of organic acids RCOONa, wherein R is an alkyl, benzyl or aryl group; sodium salts of organic acids bearing more than one carboxylic acid group such as oxalic acid, citric acid, fumaric acid, and the like; and sodium salts of carboxyl multi-substituted benzene rings such as trimellitic acid, 1,2,4,5-benzenetetracarboxylic acid, mellitic acid, and the like. Application of the sodium compound disclosed herein in the cathode of sodium-ion batteries provides similar results as the lithium compounds demonstrated in the present invention.

The following examples are presented to exemplify embodiments of the invention but are not intended to limit the invention to the specific embodiments set forth. Unless indicated to the contrary, all parts and percentages are by weight. All numerical values are approximate. When numerical ranges are given, it should be understood that embodiments outside the stated ranges may still fall within the scope of the invention. Specific details described in each example should not be construed as necessary features of the invention.

### EXAMPLES

The composite volume resistivity of the cathode and the interface resistance between the cathode layer and the current collector were measured using an electrode resistance measurement system (RM2610, HIOKI).

The adhesive strengths of the dried binder layers were measured by a tensile testing machine (DZ-106A, obtained from Dongguan Zonhow Test Equipment Co. Ltd., China). This test measures the average force required to peel a binder layer from the current collector at 180° angle in Newtons. The mean roughness depth (R_{z}) of the current collector is 2 μm. The copolymeric binder was coated on the current collector and dried to obtain a binder layer of thickness 10 μm to 12 μm. The coated current collector was then placed in an environment of constant temperature of 25° C. and humidity of 50% to 60% for 30 minutes. A strip of adhesion tape (3M; US; model no. 810) with a width of 18 mm and a length of 20 mm was attached onto the surface of the binder layer. The binder strip was clipped onto the testing machine and the tape was folded back on itself at 180 degrees, and placed in a moveable jaw and pulled at room temperature and a peel rate of 300 mm per minute. The maximum stripping force measured was taken as the adhesive strength. Measurements were repeated three times to find the average value.

### Example 1

### A) Preparation of Binder Material

7.45 g of sodium hydroxide (NaOH) was added into a round-bottom flask containing 380 g of distilled water. The mixture was stirred at 80 rpm for 30 mins to obtain a first suspension.

16.77 g of acrylic acid was added into the first suspension. The mixture was further stirred at 80 rpm for 30 mins to obtain a second suspension.

7.19 g of acrylamide was dissolved in 10 g of DI water to form an acrylamide solution. Thereafter, 17.19 g of acrylamide solution was added into the second suspension. The mixture was further heated to 55° C. and stirred at 80 rpm for 45 mins to obtain a third suspension.

35.95 g of acrylonitrile was added into the third suspension. The mixture was further stirred at 80 rpm for 10 mins to obtain a fourth suspension.

Further, 0.015 g of water-soluble free radical initiator (ammonium persulfate, APS; obtained from Aladdin Industries Corporation, China) was dissolved in 3 g of DI water and 0.0075 g of reducing agent (sodium bisulfite; obtained from Tianjin Damao Chemical Reagent Factory, China) was dissolved in 1.5 g of DI water. 3.015 g of APS solution and 1.5075 g of sodium bisulfite solution were added into the fourth suspension. The mixture was stirred at 200 rpm for 24 h at 55° C. to obtain a fifth suspension.

After the complete reaction, the temperature of the fifth suspension was lowered to 25° C. 3.72 g of NaOH was dissolved in 400 g of DI water. Thereafter, 403.72 g of sodium hydroxide solution was added dropwise into the fifth suspension to adjust pH to 7.3 to form the binder material. The binder material was filtered using 200 μm nylon mesh. The solid content of the binder material was 8.88 wt. %. The adhesive strength between the copolymeric binder and the current collector was 3.41 N/cm. The components of the copolymeric binder of Example 1 and their respective proportions are shown in Table 2 below.

### B) Preparation of Positive Electrode

A first suspension was prepared by dispersing 1.85 g of lithium compound, LiNO₂ in 14.48 g of deionized water in a 50 mL round bottom flask while stirring with an overhead stirrer (R20, IKA). After the addition, the first suspension was further stirred for about 10 minutes at a speed of 500 rpm.

Thereafter, 22.52 g of binder material above (8.88 wt. % solid content) was added into the first suspension while stirring with an overhead stirrer. The mixture was stirred at 500 rpm for about 30 minutes. 3.15 g of conductive agent (SuperP; obtained from Timcal Ltd, Bodio, Switzerland) was added into the mixture and stirred at 1,200 rpm for 30 minutes to obtain the second suspension.

A third suspension was prepared by dispersing 58.0 g of NMC811 (obtained from Shandong Tianjiao New Energy Co., Ltd, China) into the second suspension at 25° C. while stirring with an overhead stirrer. Then, the third suspension was degassed under a pressure of about 10 kPa for 1 hour. The third suspension was further stirred for about 90 minutes at 25° C. at a speed of 1,200 rpm to form a homogenized cathode slurry. The components of the cathode slurry of Example 1 are shown in Table 2 below. The concentration of the lithium compound in the cathode slurry was 1.0 M, the solubility ratio of the lithium compound in the cathode slurry was 18.9, and the solid content of the cathode slurry was 65.00%.

The homogenized cathode slurry was coated onto one side of an aluminum foil having a thickness of 16 μm as a current collector using a doctor blade coater with a gap width of 60 μm at room temperature. The coated slurry film of 55 μm on the aluminum foil was dried to form a cathode electrode layer by an electrically heated oven at 80° C. The drying time was about 120 minutes. The electrode was then pressed to decrease the thickness of a cathode electrode layer to 34 μm. The surface density of the cathode electrode layer on the current collector was 16.00 mg/cm². The composite volume resistivity of the cathode and the interface resistance between the cathode layer and the current collector of Example 1 were measured and is shown in Table 4 below.

### C) Preparation of Negative Electrode

A negative electrode slurry was prepared by mixing 90 wt. % of graphite (BTR New Energy Materials Inc., Shenzhen, Guangdong, China) with 1.5 wt. % carboxymethyl cellulose (CMC, BSH-12, DKS Co. Ltd., Japan) and 3.5 wt. % SBR (AL-2001, NIPPON A&L INC., Japan) as a binder, and 5 wt. % carbon black as a conductive agent in deionized water. The solid content of the anode slurry was 50 wt. %. The slurry was coated onto one side of a copper foil having a thickness of 8 μm using a doctor blade with a gap width of about 55 μm. The coated film on the copper foil was dried at about 50° C. for 120 minutes by a hot air dryer to obtain a negative electrode. The electrode was then pressed to decrease the thickness of the coating to 30 μm and the surface density was 10 mg/cm².

### D) Assembling of Coin Cell

CR2032 coin-type Li cells were assembled in an argon-filled glove box. The coated cathode and anode sheets were cut into disc-form positive and negative electrodes, which were then assembled into an electrode assembly by stacking the cathode and anode electrode plates alternatively and then packaged in a case made of stainless steel of the CR2032 type. The cathode and anode electrode plates were kept apart by separators. The separator was a ceramic coated microporous membrane made of nonwoven fabric (MPM, Japan), which had a thickness of about 25 μm. The electrode assembly was then dried in a box-type resistance oven under vacuum (DZF-6020, obtained from Shenzhen Kejing Star Technology Co. Ltd., China) at 105° C. for about 16 hours.

An electrolyte was then injected into the case holding the packed electrodes under a high-purity argon atmosphere with a moisture and oxygen content of less than 3 ppm respectively. The electrolyte was a solution of LiPF₆ (1 M) in a mixture of ethylene carbonate (EC), ethyl methyl carbonate (EMC) and dimethyl carbonate (DMC) at a volume ratio of 1:1:1. After electrolyte filling, the coin cell was vacuum sealed and then mechanically pressed using a punch tooling with a standard circular shape.

### E) Electrochemical Measurements

The coin cells were analyzed in a constant current mode using a multi-channel battery tester (BTS-4008-5V10 mA, obtained from Neware Electronics Co. Ltd, China). An initial cycle at C/20 was completed, and the discharge capacity was recorded. Then, the coin cells were repeatedly charged and discharged at a rate of C/2. The charging/discharging cycling tests of the cells were performed between 3.0 and 4.3 V at a current density of C/2 at 25° C. to obtain the capacity retention at 50 cycles. The electrochemical performance of the coin cell of Example 1 is shown in Table 2 below.

### Preparation of Binder Material of Examples 2-5

Binder material was prepared by the method described in Example 1.

### Preparation of Positive Electrode of Example 2

A cathode was prepared by the method described in Example 1, except 0.93 g of lithium compound, LiNO₂, was added in the preparation of the first suspension, and 4.07 g of conductive agent was added in the preparation of the second suspension of the cathode slurry. The concentration of the lithium compound in the cathode slurry was 0.5 M, the solubility ratio of the lithium compound in the cathode slurry was 37.8, and the solid content of the cathode slurry was 65.00%.

### Preparation of Positive Electrode of Example 3

A cathode was prepared by the method described in Example 1, except 3.71 g of lithium compound, LiNO₂, was added in the preparation of the first suspension, 2.29 g of conductive agent was added in the preparation of the second suspension, and 57.0 g of the cathode active material, NMC811, was added in the preparation of the third suspension of the cathode slurry. The concentration of the lithium compound in the cathode slurry was 2.0 M, the solubility ratio of the lithium compound in the cathode slurry was 9.45, and the solid content of the cathode slurry was 65.00%.

### Preparation of Positive Electrode of Example 4

A cathode was prepared by the method described in Example 1, except 0.02 g of lithium compound, LiNO₂, was added in the preparation of the first suspension, and 4.98 g of conductive agent was added in the preparation of the second suspension of the cathode slurry. The concentration of the lithium compound in the cathode slurry was 0.01 M, the solubility ratio of the lithium compound in the cathode slurry was 1,890, and the solid content of the cathode slurry was 65.00%.

### Preparation of Positive Electrode of Example 5

A cathode was prepared by the method described in Example 1, except that 2.20 g of lithium compound, lithium squarate, was added in the preparation of the first suspension, and 2.80 g of conductive agent was added in the preparation of the second suspension of the cathode slurry. The concentration of the lithium compound in the cathode slurry was 0.5 M, the solubility ratio of the lithium compound in the cathode slurry was 3.18, while the lithium ion concentration of the lithium compound in the cathode slurry was 1.0 M, and the solid content of the cathode slurry was 65.00%.

### Example 6

### A) Preparation of Binder Material

18.15 g of sodium hydroxide (NaOH) was added into a round-bottom flask containing 380 g of distilled water. The mixture was stirred at 80 rpm for 30 mins to obtain a first suspension.

36.04 g of acrylic acid was added into the first suspension. The mixture was further stirred at 80 rpm for 30 mins to obtain a second suspension.

19.04 g of acrylamide was dissolved in 10 g of DI water to form an acrylamide solution. Thereafter, 29.04 g of acrylamide solution was added into the second suspension. The mixture was further heated to 55° C. and stirred at 80 rpm for 45 mins to obtain a third suspension.

12.92 g of acrylonitrile was added into the third suspension. The mixture was further stirred at 80 rpm for 10 mins to obtain a fourth suspension.

Further, 0.015 g of water-soluble free radical initiator (ammonium persulfate, APS; obtained from Aladdin Industries Corporation, China) was dissolved in 3 g of DI water and 0.0075 g of reducing agent (sodium bisulfite; obtained from Tianjin Damao Chemical Reagent Factory, China) was dissolved in 1.5 g of DI water. 3.015 g of APS solution and 1.5075 g of sodium bisulfite solution were added into the fourth suspension. The mixture was stirred at 200 rpm for 24 h at 55° C. to obtain a fifth suspension.

After the complete reaction, the temperature of the fifth suspension was lowered to 25° C. 3.72 g of NaOH was dissolved in 400 g of DI water. Thereafter, 403.72 g of sodium hydroxide solution was added dropwise into the fifth suspension to adjust pH to 7.3 to form the binder material. The binder material was filtered using 200 μm nylon mesh. The solid content of the binder material was 9.00 wt. %. The adhesive strength between the copolymeric binder and the current collector was 3.27 N/cm. The components of the copolymeric binder of Example 6 and their respective proportions are shown in Table 2 below.

### B) Preparation of Positive Electrode

A cathode was prepared by the method described in Example 1, except that 14.78 g of DI water was added in the preparation of the first suspension, and 22.22 g of the binder material above (9.00 wt. % solid content) was added in the preparation of the second suspension of the cathode slurry. The concentration of the lithium compound in the cathode slurry was 1.0 M, the solubility ratio of the lithium compound in the cathode slurry was 18.9, and the solid content of the cathode slurry was 65.00%.

### Preparation of Binder Material of Examples 7

Binder material was prepared by the method described in Example 6.

### Preparation of Positive Electrode of Example 7

A cathode was prepared by the method described in Example 6, except that 2.20 g of lithium compound, lithium squarate, was added in the preparation of the first suspension, and 2.80 g of conductive agent was added in the preparation of the second suspension of the cathode slurry. The concentration of the lithium compound in the cathode slurry was 0.5 M, the solubility ratio of the lithium compound in the cathode slurry was 3.18, while the lithium ion concentration of the lithium compound in the cathode slurry was 1.0 M, and the solid content of the cathode slurry was 65.00%.

### Preparation of Binder Material of Examples 8-12

Binder material was prepared by the method described in Example 1.

### Preparation of Positive Electrode of Example 8

A first suspension was prepared by dispersing 1.78 g of lithium compound, lithium oxalate in 14.48 g of deionized water in a 50 mL round bottom flask while stirring with an overhead stirrer (R20, IKA). After the addition, the first suspension was further stirred for about 10 minutes at a speed of 500 rpm.

Thereafter, 22.52 g of binder material above (8.88 wt. % solid content) was added into the first suspension while stirring with an overhead stirrer. The mixture was stirred at 500 rpm for about 30 minutes. 3.22 g of conductive agent (SuperP; obtained from Timcal Ltd, Bodio, Switzerland) was added into the mixture and stirred at 1,200 rpm for 30 minutes to obtain the second suspension.

A third suspension was prepared by dispersing 58.0 g of LNMO (obtained from Chengdu Xingneng New Materials Co., Ltd, China) into the second suspension at 25° C. while stirring with an overhead stirrer. Then, the third suspension was degas sed under a pressure of about 10 kPa for 1 hour. The third suspension was further stirred for about 90 minutes at 25° C. at a speed of 1,200 rpm to form a homogenized cathode slurry. The components of the cathode slurry of Example 8 are shown in Table 2 below. The concentration of the lithium compound in the cathode slurry was 0.5 M, the solubility ratio of the lithium compound in the cathode slurry was 1.56, while the lithium ion concentration of the lithium compound in the cathode slurry was 1.0 M, and the solid content of the cathode slurry was 65.00%.

The homogenized cathode slurry was coated onto one side of an aluminum foil having a thickness of 16 μm as a current collector using a doctor blade coater with a gap width of 60 μm at room temperature. The coated slurry film of 55 μm on the aluminum foil was dried to form a cathode electrode layer by an electrically heated oven at 80° C. The drying time was about 120 minutes. The electrode was then pressed to decrease the thickness of a cathode electrode layer to 34 μm. The surface density of the cathode electrode layer on the current collector was 16.00 mg/cm².

### Preparation of Positive Electrode of Example 9

A cathode was prepared by the method of Example 8, except that 0.89 g of lithium compound, lithium oxalate, was added in the preparation of the first suspension, and 4.11 g of conductive agent was added in the preparation of the second suspension of the cathode slurry. The concentration of the lithium compound in the cathode slurry was 0.25 M, the solubility ratio of the lithium compound in the cathode slurry was 3.12, while the lithium ion concentration of the lithium compound in the cathode slurry was 0.5 M, and the solid content of the cathode slurry was 65.00%.

### Preparation of Positive Electrode of Example 10

A cathode was prepared by the method of Example 8, except that 3.67 g of lithium compound, lithium citrate, was added in the preparation of the first suspension, 2.33 g of conductive agent was added in the preparation of the second suspension, and 57.0 g of cathode active material, LNMO, was added in the preparation of the third suspension of the cathode slurry. The concentration of the lithium compound in the cathode slurry was 0.5 M, the solubility ratio of the lithium compound in the cathode slurry was 4.76, while the lithium ion concentration of the lithium compound in the cathode slurry was 1.5 M, and the solid content of the cathode slurry was 65.00%.

### Preparation of Positive Electrode of Example 11

A cathode was prepared by the method of Example 8, except that 0.84 g of lithium compound, LiOH, was added in the preparation of the first suspension, and 4.16 g of conductive agent was added in the preparation of the second suspension of the cathode slurry. The concentration of the lithium compound in the cathode slurry was 1.0 M, the solubility ratio of the lithium compound in the cathode slurry was 4.18, and the solid content of the cathode slurry was 65.00%.

### Preparation of Positive Electrode of Example 12

A cathode was prepared by the method described in Example 8, except 2.38 g of lithium compound, lithium dodecyl sulfate, was added in the preparation of the first suspension, and 2.62 g of conductive agent was added in the preparation of the second suspension of the cathode slurry. The concentration of the lithium compound in the cathode slurry was 0.25 M, the solubility ratio of the lithium compound in the cathode slurry was 1.04, and the solid content of the cathode slurry was 65.00%.

### Preparation of Binder Material of Examples 13-15

Binder material was prepared by the method described in Example 6.

### Preparation of Positive Electrode of Example 13

A cathode was prepared by the method described in Example 8, except 14.78 g of DI water was added in the preparation of the first suspension, and 22.22 g of the binder material above (9.00 wt. % solid content) was added in the preparation of the second suspension of the cathode slurry. The concentration of the lithium compound in the cathode slurry was 0.5 M, the solubility ratio of the lithium compound in the cathode slurry was 1.56, while the lithium ion concentration of the lithium compound in the cathode slurry was 1.0 M, and the solid content of the cathode slurry was 65.00%.

### Preparation of Positive Electrode of Example 14

A cathode was prepared by the method described in Example 11, except 14.78 g of DI water was added in the preparation of the first suspension, and 22.22 g of binder material above (9.00 wt. % solid content) was added in the preparation of the second suspension of the cathode slurry. The concentration of the lithium compound in the cathode slurry was 1.0 M, the solubility ratio of the lithium compound in the cathode slurry was 4.18, and the solid content of the cathode slurry was 65.00%.

### Preparation of Positive Electrode of Example 15

A cathode was prepared by the method described in Example 12, except 14.78 g of DI water was added in the preparation of the first suspension, and 22.22 g of binder material above (9.00 wt. % solid content) was added in the preparation of the second suspension of the cathode slurry. The concentration of the lithium compound in the cathode slurry was 0.25 M, the solubility ratio of the lithium compound in the cathode slurry was 1.04, and the solid content of the cathode slurry was 65.00%.

### Example 16

### A) Preparation of Binder Material

27.27 g of sodium hydroxide (NaOH) was added into a round-bottom flask containing 380 g of distilled water. The mixture was stirred at 80 rpm for 30 mins to obtain a first suspension.

52.48 g of acrylic acid was added into the first suspension. The mixture was further stirred at 80 rpm for 30 mins to obtain a second suspension.

8.63 g of acrylamide was dissolved in 10 g of DI water to form an acrylamide solution. Thereafter, 18.63 g of acrylamide solution was added into the second suspension. The mixture was further heated to 55° C. and stirred at 80 rpm for 45 mins to obtain a third suspension.

8.59 g of acrylonitrile was added into the third suspension. The mixture was further stirred at 80 rpm for 10 mins to obtain a fourth suspension.

Further, 0.015 g of water-soluble free radical initiator (ammonium persulfate, APS; obtained from Aladdin Industries Corporation, China) was dissolved in 3 g of DI water and 0.0075 g of reducing agent (sodium bisulfite; obtained from Tianjin Damao Chemical Reagent Factory, China) was dissolved in 1.5 g of DI water. 3.015 g of APS solution and 1.5075 g of sodium bisulfite solution were added into the fourth suspension. The mixture was stirred at 200 rpm for 24 h at 55° C. to obtain a fifth suspension.

After the complete reaction, the temperature of the fifth suspension was lowered to 25° C. 3.72 g of NaOH was dissolved in 400 g of DI water. Thereafter, 403.72 g of sodium hydroxide solution was added dropwise into the fifth suspension to adjust pH to 7.3 to form the binder material. The binder material was filtered using 200 μm nylon mesh. The solid content of the binder material was 9.14 wt. %. The components of the copolymeric binder of Example 16 and their respective proportions are shown in Table 2 below.

A cathode was prepared by the method described in Example 1, except 15.12 g of DI water was added in the preparation of the first suspension, and 21.88 g of binder material above (9.14 wt. % solid content) was added in the preparation of the second suspension of the cathode slurry. The concentration of the lithium compound in the cathode slurry was 1.0 M, the solubility ratio of the lithium compound in the cathode slurry was 18.9, and the solid content of the cathode slurry was 65.00%.

### Example 17

### A) Preparation of Binder Material

5.02 g of sodium hydroxide (NaOH) was added into a round-bottom flask containing 380 g of distilled water. The mixture was stirred at 80 rpm for 30 mins to obtain a first suspension.

12.39 g of acrylic acid was added into the first suspension. The mixture was further stirred at 80 rpm for 30 mins to obtain a second suspension.

23.73 g of acrylamide was dissolved in 10 g of DI water to form an acrylamide solution. Thereafter, 33.73 g of acrylamide solution was added into the second suspension. The mixture was further heated to 55° C. and stirred at 80 rpm for 45 mins to obtain a third suspension.

26.84 g of acrylonitrile was added into the third suspension. The mixture was further stirred at 80 rpm for 10 mins to obtain a fourth suspension.

Further, 0.015 g of water-soluble free radical initiator (ammonium persulfate, APS; obtained from Aladdin Industries Corporation, China) was dissolved in 3 g of DI water and 0.0075 g of reducing agent (sodium bisulfite; obtained from Tianjin Damao Chemical Reagent Factory, China) was dissolved in 1.5 g of DI water. 3.015 g of APS solution and 1.5075 g of sodium bisulfite solution were added into the fourth suspension. The mixture was stirred at 200 rpm for 24 h at 55° C. to obtain a fifth suspension.

After the complete reaction, the temperature of the fifth suspension was lowered to 25° C. 3.72 g of NaOH was dissolved in 400 g of DI water. Thereafter, 403.72 g of sodium hydroxide solution was added dropwise into the fifth suspension to adjust pH to 7.3 to form the binder material. The binder material was filtered using 200 μm nylon mesh. The solid content of the binder material was 8.64 wt. %. The components of the copolymeric binder of Example 17 and their respective proportions are shown in Table 2 below.

### B) Preparation of Positive Electrode

A cathode was prepared by the method described in Example 1, except 13.85 g of DI water was added in the preparation of the first suspension, and 23.15 g of binder material above (8.64 wt. % solid content) was added in the preparation of the second suspension of the cathode slurry. The concentration of the lithium compound in the cathode slurry was 1.0 M, the solubility ratio of the lithium compound in the cathode slurry was 18.9, and the solid content of the cathode slurry was 65.00%.

### Example 18

### A) Preparation of Binder Material

12.30 g of sodium hydroxide (NaOH) was added into a round-bottom flask containing 380 g of distilled water. The mixture was stirred at 80 rpm for 30 mins to obtain a first suspension.

25.51 g of acrylic acid was added into the first suspension. The mixture was further stirred at 80 rpm for 30 mins to obtain a second suspension.

14.38 g of acrylamide was dissolved in 10 g of DI water to form an acrylamide solution. Thereafter, 24.38 g of acrylamide solution was added into the second suspension. The mixture was further heated to 55° C. and stirred at 80 rpm for 45 mins to obtain a third suspension.

24.15 g of acrylonitrile was added into the third suspension. The mixture was further stirred at 80 rpm for 10 mins to obtain a fourth suspension.

Further, 0.015 g of water-soluble free radical initiator (ammonium persulfate, APS; obtained from Aladdin Industries Corporation, China) was dissolved in 3 g of DI water and 0.0075 g of reducing agent (sodium bisulfite; obtained from Tianjin Damao Chemical Reagent Factory, China) was dissolved in 1.5 g of DI water. 3.015 g of APS solution and 1.5075 g of sodium bisulfite solution were added into the fourth suspension. The mixture was stirred at 200 rpm for 24 h at 55° C. to obtain a fifth suspension.

After the complete reaction, the temperature of the fifth suspension was lowered to 25° C. 3.72 g of NaOH was dissolved in 400 g of DI water. Thereafter, 403.72 g of sodium hydroxide solution was added dropwise into the fifth suspension to adjust pH to 7.3 to form the binder material. The binder material was filtered using 200 μm nylon mesh. The solid content of the binder material was 8.32 wt. %. The components of the copolymeric binder of Example 18 and their respective proportions are shown in Table 2 below.

### B) Preparation of Positive Electrode

A cathode was prepared by the method described in Example 1, except 12.96 g of DI water was added in the preparation of the first suspension, and 24.04 g of binder material above (8.32 wt. % solid content) was added in the preparation of the second suspension of the cathode slurry. The concentration of the lithium compound in the cathode slurry was 1.0 M, the solubility ratio of the lithium compound in the cathode slurry was 18.9, and the solid content of the cathode slurry was 65.00%.

### Preparation of Binder Material of Example 19

Binder material was prepared by the method described in Example 16.

### Preparation of Positive Electrode of Example 19

A cathode was prepared by the method described in Example 8, except 15.12 g of DI water was added in the preparation of the first suspension, and 21.88 g of binder material above (9.14 wt. % solid content) was added in the preparation of the second suspension of the cathode slurry. The concentration of the lithium compound in the cathode slurry was 0.5 M, the solubility ratio of the lithium compound in the cathode slurry was 1.56, while the lithium ion concentration of the lithium compound in the cathode slurry was 1.0 M, and the solid content of the cathode slurry was 65.00%.

### Comparative Example 1

### A) Preparation of Binder Material

Binder material was prepared by the method described in Example 1.

### B) Preparation of Positive Electrode

A positive electrode was prepared by the same method described in Example 1, except no lithium compound was added in the preparation of the first suspension, and 5.0 g of conductive agent was added in the preparation of the second suspension of the cathode slurry. The composite volume resistivity of the cathode and the interface resistance between the cathode layer and the current collector of Comparative Example 1 were measured and is shown in Table 4 below.

### Comparative Example 2

### A) Preparation of Binder Material

Binder material was prepared by the method described in Example 6.

### B) Preparation of Positive Electrode

A positive electrode was prepared by the same method described in Example 6, except no lithium compound was added in the preparation of the first suspension, and 5.0 g of conductive agent was added in the preparation of the second suspension of the cathode slurry.

### Comparative Example 3

### A) Preparation of Binder Material

Binder material was prepared by the method described in Example 8.

### B) Preparation of Positive Electrode

A positive electrode was prepared by the same method described in Example 8, except no lithium compound was added in the preparation of the first suspension, and 5.0 g of conductive agent was added in the preparation of the second suspension of the cathode slurry.

### Comparative Example 4

### A) Preparation of Binder Material

Binder material was prepared by the method described in Example 13.

### B) Preparation of Positive Electrode

A positive electrode was prepared by the same method described in Example 13, except no lithium compound was added in the preparation of the first suspension, and 5.0 g of conductive agent was added in the preparation of the second suspension of the cathode slurry.

### Preparation of Positive Electrode of Comparative Example 5

A first suspension was prepared by dispersing 1.85 g of lithium compound, LiNO₂ in 14.48 g of NMP in a 50 mL round bottom flask while stirring with an overhead stirrer (R20, IKA). After the addition, the first suspension was further stirred for about 10 minutes at a speed of 500 rpm.

Thereafter, 2 g of PVDF (Sigma-Aldrich, USA) and 20.52 g of NMP was added into the first suspension while stirring with an overhead stirrer. The mixture was stirred at 500 rpm for about 30 minutes. 3.15 g of conductive agent (SuperP; obtained from Timcal Ltd, Bodio, Switzerland) was added into the mixture and stirred at 1,200 rpm for 30 minutes to obtain the second suspension.

A third suspension was prepared by dispersing 58.0 g of NMC811 (obtained from Shandong Tianjiao New Energy Co., Ltd, China) into the second suspension at 25° C. while stirring with an overhead stirrer. Then, the third suspension was degas sed under a pressure of about 10 kPa for 1 hour. The third suspension was further stirred for about 90 minutes at 25° C. at a speed of 1,200 rpm to form a homogenized cathode slurry. The components of the cathode slurry of Comparative Example 5 are shown in Table 3 below. The number of moles of lithium compound present in the cathode slurry of Comparative Example 5 was the same as that of Example 1, and the solid content of the cathode slurry was 65.00%.

The homogenized cathode slurry was coated onto one side of an aluminum foil having a thickness of 16 μm as a current collector using a doctor blade coater with a gap width of 60 μm at room temperature. The coated slurry film of 55 μm on the aluminum foil was dried to form a cathode electrode layer by an electrically heated oven at 80° C. The drying time was about 120 minutes. The electrode was then pressed to decrease the thickness of a cathode electrode layer to 34 μm. The surface density of the cathode electrode layer on the current collector was 16.00 mg/cm². The composite volume resistivity of the cathode and the interface resistance between the cathode layer and the current collector of Comparative Example 5 were measured and is shown in Table 4 below.

### Preparation of Positive Electrode of Comparative Example 6

A positive electrode was prepared by the same method described in Comparative Example 5, except no lithium compound was added in the preparation of the first suspension, and 5.0 g of conductive agent was added in the preparation of the second suspension of the cathode slurry. The composite volume resistivity of the cathode and the interface resistance between the cathode layer and the current collector of Comparative Example 6 were measured and is shown in Table 4 below.

### Preparation of Positive Electrode of Comparative Example 7

A cathode was prepared by the method described in Example 1, except 2 g of polyacrylic acid (PAA, Sigma-Aldrich, USA), 20.52 g of DI water, and 3.15 g of conductive agent was added in the preparation of the second suspension of the cathode slurry. The concentration of the lithium compound in the cathode slurry was 1.0 M, the solubility ratio of the lithium compound in the cathode slurry was 18.9, and the solid content of the cathode slurry was 65.00%.

### Preparation of Positive Electrode of Comparative Example 8

A cathode was prepared by the method described in Example 1, except 0.6 g of carboxymethyl cellulose (CMC, BSH-12, DKS Co. Ltd., Japan), 1.4 g of SBR (AL-2001, NIPPON A&L INC., Japan), 20.52 g of DI water, and 3.15 g of conductive agent (SuperP; obtained from Timcal Ltd, Bodio, Switzerland) was added in the preparation of the second suspension of the cathode slurry. The concentration of the lithium compound in the cathode slurry was 1.0 M, the solubility ratio of the lithium compound in the cathode slurry was 18.9, and the solid content of the cathode slurry was 65.00%.

### Comparative Example 9

### A) Preparation of Binder Material

Binder material was prepared by the same method described by Example 1, except that in the preparation of the polymeric binder, 2.19 g of sodium hydroxide was added in the preparation of the first suspension, 7.29 g of acrylic acid was added in the preparation of the second suspension, 12.94 g of acrylamide was added in the preparation of the third suspension and 38.64 g of acrylonitrile was added in the preparation of the fourth suspension. The solid content of the binder material was 7.92 wt. %. The components of the copolymeric binder of Comparative Example 9 and their respective proportions are shown in Table 3 below.

### B) Preparation of Positive Electrode

A cathode was prepared by the method described in Example 1, except 11.75 g of DI water was added in the preparation of the first suspension, and 25.25 g of binder material above (7.92 wt. % solid content) was added in the preparation of the second suspension of the cathode slurry. The concentration of the lithium compound in the cathode slurry was 1.0 M, the solubility ratio of the lithium compound in the cathode slurry was 18.9, and the solid content of the cathode slurry was 65.00%.

### Comparative Example 10

### A) Preparation of Binder Material

Binder material was prepared by the same method described by Example 1, except that in the preparation of the polymeric binder, 30.51 g of sodium hydroxide was added in the preparation of the first suspension, 58.31 g of acrylic acid was added in the preparation of the second suspension, acrylamide was not added in the preparation of the third suspension and 10.73 g of acrylonitrile was added in the preparation of the fourth suspension. The solid content of the binder material was 9.46 wt. %. The components of the copolymeric binder of Comparative Example 10 and their respective proportions are shown in Table 3 below.

### B) Preparation of Positive Electrode

A cathode was prepared by the method described in Example 1, except 15.86 g of DI water was added in the preparation of the first suspension, and 21.14 g of binder material above (9.46 wt. % solid content) was added in the preparation of the second suspension of the cathode slurry. The concentration of the lithium compound in the cathode slurry was 1.0 M, the solubility ratio of the lithium compound in the cathode slurry was 18.9, and the solid content of the cathode slurry was 65.00%.

### Comparative Example 11

### A) Preparation of Binder Material

Binder material was prepared by the same method described by Example 1, except that in the preparation of the polymeric binder, 24.44 g of sodium hydroxide was added in the preparation of the first suspension, 47.38 g of acrylic acid was added in the preparation of the second suspension, 25.16 g of acrylamide was added in the preparation of the third suspension and acrylonitrile was not added in the preparation of the fourth suspension. The solid content of the binder material was 9.10 wt. %. The components of the copolymeric binder of Comparative Example 11 and their respective proportions are shown in Table 3 below.

### B) Preparation of Positive Electrode

A cathode was prepared by the method described in Example 1, except 15.02 g of DI water was added in the preparation of the first suspension, and 21.98 g of binder material above (9.10 wt. % solid content) was added in the preparation of the second suspension of the cathode slurry. The concentration of the lithium compound in the cathode slurry was 1.0 M, the solubility ratio of the lithium compound in the cathode slurry was 18.9, and the solid content of the cathode slurry was 65.00%.

### Preparation of Binder Material of Comparative Examples 12-13

Binder material was prepared by the method described in Example 1.

### Preparation of Positive Electrode of Comparative Example 12

A cathode was prepared by the method described in Example 1, except 4.63 g of lithium compound, LiNO₂, was added in the preparation of the first suspension. The concentration of the lithium compound in the cathode slurry was 2.5 M, the solubility ratio of the lithium compound in the cathode slurry was 7.56.

### Preparation of Positive Electrode of Comparative Example 13

A cathode was prepared by the method described in Example 8, except 3.21 g of lithium compound, lithium oxalate, was added in the preparation of the first suspension. The concentration of the lithium compound in the cathode slurry was 0.9 M, the solubility ratio of the lithium compound in the cathode slurry was 0.867, which is less than 1, while the lithium ion concentration of the lithium compound in the cathode slurry was 1.8 M.

### Preparation of Negative Electrodes of Examples 2-19, and Comparative Examples 1-13

Negative electrodes were prepared by the same method described in Example 1.

### Assembling of Coin Cells of Examples 2-19, and Comparative Examples 1-13

CR2032 coin-type Li cells were assembled by the same method described in Example 1.

### Electrochemical Measurements of Examples 2-19

Electrochemical measurements were taken by the same method described in Example 1. The electrochemical performance of the coin cells of Examples 2-19 were measured and is shown in Table 2 below.

### Electrochemical Measurements of Comparative Examples 1-13

Electrochemical measurements were taken by the same method described in Example 1. The electrochemical performance of the coin cells of Comparative Examples 1-13 were measured and is shown in Table 3 below.

TABLE 1

| | Decomposition |
|---|---|
| | Voltage |
| Lithium compound | (V vs. Li/Li⁺) |
| lithium azide (LiN₃) | 3.8 |
| lithium nitrite (LiNO₂) | 3.5 |
| lithium squarate (Li₂C₄O₄) | 4.1 |
| lithium croconate (Li₂C₅O₅) | 3.9 |
| lithium oxalate | 4.7 |
| lithium ketomalonate (Li₂C₃O₅) | 4.5 |
| lithium nitrate (LiNO₃) | 4.4 |
| lithium acetate (CH₃COOLi) | 4.5 |
| lithium formate | 4.7 |
| lithium hydroxide | 4.8 |
| lithium dodecyl sulfate | 4.7 |
| lithium succinate | 4.7 |
| lithium citrate | 4.6 |
| lithium borate | 4.5 |
| lithium lactate | 4.4 |

TABLE 2

| | Structural units in the copolymer | | | | | | | | | |
|---|---|---|---|---|---|---|---|---|---|---|
| | Proportion | Proportion | Proportion | | | Lithium compound | | | 0.05 C | |
| | of | of | of | | | | | Concentration | Initial | Capacity |
| | structural | structural | structural | Cathode | | | Compound | of lithium | discharging | retention |
| | unit (a) | unit (b) | unit (c) | active | | Compound | concentration | ion from | capacity | after 50 |
| | (mol %) | (mol %) | (mol %) | material | Solvent | type | (M) | compound (M) | (mAh/g) | cycles (%) |
| Example 1 | 23.01 | 10.00 | 66.99 | NCM811 | Water | LiNO₂ | 1.0 | 1.0 | 218 | 93.4 |
| Example 2 | 23.01 | 10.00 | 66.99 | NCM811 | Water | LiNO₂ | 0.5 | 0.5 | 203 | 87.5 |
| Example 3 | 23.01 | 10.00 | 66.99 | NCM811 | Water | LiNO₂ | 2.0 | 2.0 | 233 | 90.8 |
| Example 4 | 23.01 | 10.00 | 66.99 | NCM811 | Water | LiNO₂ | 0.01 | 0.01 | 187 | 81.6 |
| Example 5 | 23.01 | 10.00 | 66.99 | NCM811 | Water | Lithium | 0.5 | 1.0 | 222 | 91.7 |
| | | | | | | squarate | | | | |
| Example 6 | 49.45 | 26.48 | 24.07 | NCM811 | Water | LiNO₂ | 1.0 | 1.0 | 210 | 91.3 |
| Example 7 | 49.45 | 26.48 | 24.07 | NCM811 | Water | Lithium | 0.5 | 1.0 | 214 | 92.8 |
| | | | | | | squarate | | | | |
| Example 8 | 23.01 | 10.00 | 66.99 | LNMO | Water | Lithium | 0.5 | 1.0 | 111 | 80.4 |
| | | | | | | oxalate | | | | |
| Example 9 | 23.01 | 10.00 | 66.99 | LNMO | Water | Lithium | 0.25 | 0.5 | 104 | 77.5 |
| | | | | | | oxalate | | | | |
| Example 10 | 23.01 | 10.00 | 66.99 | LNMO | Water | Lithium | 0.5 | 1.5 | 113 | 81.0 |
| | | | | | | citrate | | | | |
| Example 11 | 23.01 | 10.00 | 66.99 | LNMO | Water | LiOH | 1.0 | 1.0 | 109 | 79.3 |
| Example 12 | 23.01 | 10.00 | 66.99 | LNMO | Water | Lithium | 0.25 | 0.25 | 105 | 78.4 |
| | | | | | | dodecyl | | | | |
| | | | | | | sulfate | | | | |
| Example 13 | 49.45 | 26.48 | 24.07 | LNMO | Water | Lithium | 0.5 | 1.0 | 110 | 78.3 |
| | | | | | | oxalate | | | | |
| Example 14 | 49.45 | 26.48 | 24.07 | LNMO | Water | LiOH | 1.0 | 1.0 | 108 | 79.9 |
| Example 15 | 49.45 | 26.48 | 24.07 | LNMO | Water | Lithium | 0.25 | 0.25 | 104 | 77.4 |
| | | | | | | dodecyl | | | | |
| | | | | | | sulfate | | | | |
| Example 16 | 72.00 | 12.00 | 16.00 | NCM811 | Water | LiNO₂ | 1.0 | 1.0 | 225 | 86.6 |
| Example 17 | 17.00 | 33.00 | 50.00 | NCM811 | Water | LiNO₂ | 1.0 | 1.0 | 208 | 87.1 |
| Example 18 | 35.00 | 20.00 | 45.00 | NCM811 | Water | LiNO₂ | 1.0 | 1.0 | 206 | 85.3 |
| Example 19 | 72.00 | 12.00 | 16.00 | LNMO | Water | Lithium | 0.5 | 1.0 | 121 | 77.6 |
| | | | | | | oxalate | | | | |

TABLE 3

| | Structural units in the copolymer | | | | | | | | | |
|---|---|---|---|---|---|---|---|---|---|---|
| | Proportion | Proportion | Proportion | | | Lithium compound | | | 0.05 C | |
| | of | of | of | | | | | Concentration | Initial | Capacity |
| | structural | structural | structural | Cathode | | | Compound | of lithium | discharging | retention |
| | unit (a) | unit (b) | unit (c) | active | | Compound | concentration | ion from | capacity | after 50 |
| | (mol %) | (mol %) | (mol %) | material | Solvent | type | (M) | compound (M) | (mAh/g) | cycles (%) |
| Comparative | 23.01 | 10.00 | 66.99 | NCM811 | Water | — | — | — | 181 | 72.4 |
| Example 1 | | | | | | | | | | |
| Comparative | 49.45 | 26.48 | 24.07 | NCM811 | Water | — | — | — | 179 | 71.1 |
| Example 2 | | | | | | | | | | |
| Comparative | 23.01 | 10.00 | 66.99 | LNMO | Water | — | — | — | 96.6 | 63.7 |
| Example 3 | | | | | | | | | | |
| Comparative | 49.45 | 26.48 | 24.07 | LNMO | Water | — | — | — | 94.3 | 64.1 |
| Example 4 | | | | | | | | | | |
| Comparative | 0.00 | 0.00 | 0.00 | NCM811 | NMP | LiNO₂ | — | — | 183 | 70.5 |
| Example 5 ¹ | | | | | | | | | | |
| Comparative | 0.00 | 0.00 | 0.00 | NCM811 | NMP | — | — | — | 178 | 73.0 |
| Example 6 ¹ | | | | | | | | | | |
| Comparative | 0.00 | 0.00 | 0.00 | NCM811 | Water | LiNO₂ | 1.0 | 1.0 | 165 | 67.8 |
| Example 7 ² | | | | | | | | | | |
| Comparative | 0.00 | 0.00 | 0.00 | NCM811 | Water | LiNO₂ | 1.0 | 1.0 | 167 | 62.3 |
| Example 8 ³ | | | | | | | | | | |
| Comparative | 10.00 | 18.00 | 72.00 | NCM811 | Water | LiNO₂ | 1.0 | 1.0 | 173 | 65.7 |
| Example 9 | | | | | | | | | | |
| Comparative | 80.00 | 0.00 | 20.00 | NCM811 | Water | LiNO₂ | 1.0 | 1.0 | 171 | 64.1 |
| Example 10 | | | | | | | | | | |
| Comparative | 65.00 | 35.00 | 0.00 | NCM811 | Water | LiNO₂ | 1.0 | 1.0 | 165 | 63.3 |
| Example 11 | | | | | | | | | | |
| Comparative | 23.01 | 10.00 | 66.99 | NCM811 | Water | LiNO₂ | 2.5 | 2.5 | 183 | 68.1 |
| Example 12 | | | | | | | | | | |
| Comparative | 23.01 | 10.00 | 66.99 | LNMO | Water | Lithium | 0.9 | 1.8 | 92.3 | 62.7 |
| Example 13 | | | | | | oxalate | | | | |

¹ PVDF was used as the binder instead.
² PAA was used as the binder instead.
³ SBR + CMC was used as the binder instead.

TABLE 4

| | Composite | |
|---|---|---|
| | volume | Interface |
| | resistivity | resistance |
| | (Ω · cm) | (Ω · cm²) |
| Example 1 | 0.937 | 0.004 |
| Comparative Example 1 | 0.970 | 0.009 |
| Comparative Example 5 | 3.895 | 0.731 |
| Comparative Example 6 | 0.853 | 0.014 |

While the invention has been described with respect to a limited number of embodiments, the specific features of one embodiment should not be attributed to other embodiments of the invention. In some embodiments, the methods may include numerous steps not mentioned herein. In other embodiments, the methods do not include, or are substantially free of, any steps not enumerated herein. Variations and modifications from the described embodiments exist. The appended claims intend to cover all those modifications and variations as falling within the scope of the invention.

1. A cathode slurry for a secondary battery, comprising a cathode active material, a polymeric binder, a lithium compound, and an aqueous solvent.

2. The cathode slurry of claim 1, wherein the lithium compound is a compound represented by the chemical formula:
[A⁺]ₐB^{a-}
wherein the cation A⁺ is Li⁺, a is an integer from 1 to 10, and the anion B^{a-} is an oxidizable anion.

3. The cathode slurry of claim 2, wherein the decomposition voltage of the lithium compound is from about 3.0 V to about 5.0 V; and wherein the concentration of the lithium compound in the slurry is from about 0.005 M to about 2.0 M, and wherein the solubility ratio of the lithium compound is greater than or equal to 1.

4. (canceled)

5. The cathode slurry of claim 1, wherein the aqueous solvent is water.

6. The cathode slurry of claim 1, wherein the aqueous solvent comprises water as the major component and a minor component; wherein the proportion of water in the aqueous solvent is from about 51% to about 100% by weight; and wherein the minor component is selected from the group consisting of methanol, ethanol, isopropanol, n-propanol, tert-butanol, n-butanol, acetone, dimethyl ketone, methyl ethyl ketone, ethyl acetate, isopropyl acetate, propyl acetate, butyl acetate, and combinations thereof.

7. The cathode slurry of claim 1, wherein the cathode active material is selected from the group consisting of Li₁₊ₓNiₐMn_{b}Co_{c}Al_{(1-a-b-c)}O₂, LiNi_{0.33}Mn_{0.33}Co_{0.33}O₂, LiNi_{0.4}Mn_{0.4}Co_{0.2}O₂, LiNi_{0.5}Mn_{0.3}Co_{0.2}O₂, LiNi_{0.6}Mn_{0.2}Co_{0.2}O₂, LiNi_{0.7}Mn_{0.15}Co_{0.15}O₂, LiNi_{0.8}Mn_{0.1}Co_{0.1}O₂, LiNi_{0.92}Mn_{0.04}Co_{0.04}O₂, LiNi_{0.8}Co_{0.15}Al_{0.05}O₂, LiCoO₂, LiNiO₂, LiMnO₂, LiMn₂O₄, Li₂MnO₃, LiMPO₄, LiNi_{d}MnₑO₄, and combinations thereof, wherein −0.2≤x≤0.2, 0≤a<1, 0≤b<1, 0≤c<1, a+b+c≤1, 0.1≤d≤0.8, 0.1≤e≤2, and M is selected from the group consisting of Fe, Co, Ni, Mn, Al, Mg, Zn, Ti, La, Ce, Sn, Zr, Ru, Si, Ge, or combinations thereof; and wherein the cathode active material is doped with a dopant selected from the group consisting of Fe, Ni, Mn, Al, Mg, Zn, Ti, La, Ce, Sn, Zr, Ru, Si, Ge, or combinations thereof; and wherein the proportion of cathode active material in the cathode slurry is from about 20% to about 70% by weight, based on the total weight of the cathode slurry.

8. The cathode slurry of claim 1, wherein the cathode active material comprises or is a core-shell composite comprising a core comprising a lithium transition metal oxide as claimed in claim 7 and the shell comprises a lithium transition metal oxide different to the core and is selected from the group consisting of Li₁₊ₓNiₐMn_{b}Co_{c}Al_{1-a-b-c)}O₂, LiCoO₂, LiNiO₂, LiMnO₂, LiMn₂O₄, Li₂MnO₃, LiCrO₂, Li₄Ti₅O₁₂, LiV₂O₅, LiTiS₂, LiMoS₂, and combinations thereof, wherein −0.2≤x≤0.2, 0≤a<1, 0≤b<1, 0≤c<1, and a+b+c≤1; and wherein each of the core and shell is independently doped with a dopant selected from the group consisting of Fe, Ni, Mn, Al, Mg, Zn, Ti, La, Ce, Sn, Zr, Ru, Si, Ge, and combinations thereof.

9. (canceled)

10. The cathode slurry of claim 1, wherein the polymeric binder comprises a structural unit (a), derived from a monomer selected from the group consisting of a carboxylic acid group-containing monomer, a sulfonic acid group-containing monomer, a phosphonic acid group-containing monomer, a carboxylic acid salt group-containing monomer, a sulfonic acid salt group-containing monomer, a phosphonic acid salt group-containing monomer, and combinations thereof.

11. The cathode slurry of claim 10, wherein the proportion of structural unit (a) within the polymeric binder is from about 15% to about 80% by mole, based on the total number of moles of monomeric units in the polymeric binder; wherein the carboxylic acid group-containing monomer is selected from the group consisting of acrylic acid, methacrylic acid, crotonic acid, 2-butyl crotonic acid, cinnamic acid, maleic acid, maleic anhydride, fumaric acid, itaconic acid, itaconic anhydride, tetraconic acid, 2-ethylacrylic acid, isocrotonic acid, cis-2-pentenoic acid, trans-2-pentenoic acid, angelic acid, tiglic acid, 3,3-dimethyl acrylic acid, 3-propyl acrylic acid, trans-2-methyl-3-ethyl acrylic acid, cis-2-methyl-3-ethyl acrylic acid, 3-isopropyl acrylic acid, trans-3-methyl-3-ethyl acrylic acid, cis-3-methyl-3-ethyl acrylic acid, 2-isopropyl acrylic acid, trimethyl acrylic acid, 2-methyl-3,3-diethyl acrylic acid, 3-butyl acrylic acid, 2-butyl acrylic acid, 2-pentyl acrylic acid, 2-methyl-2-hexenoic acid, trans-3-methyl-2-hexenoic acid, 3-methyl-3-propyl acrylic acid, 2-ethyl-3-propyl acrylic acid, 2,3-diethyl acrylic acid, 3,3-diethyl acrylic acid, 3-methyl-3-hexyl acrylic acid, 3-methyl-3-tert-butyl acrylic acid, 2-methyl-3-pentyl acrylic acid, 3-methyl-3-pentyl acrylic acid, 4-methyl-2-hexenoic acid, 4-ethyl-2-hexenoic acid, 3-methyl-2-ethyl-2-hexenoic acid, 3-tert-butyl acrylic acid, 2,3-dimethyl-3-ethyl acrylic acid, 3,3-dimethyl-2-ethyl acrylic acid, 3-methyl-3-isopropyl acrylic acid, 2-methyl-3-isopropyl acrylic acid, trans-2-octenoic acid, cis-2-octenoic acid, trans-2-decenoic acid, α-acetoxyacrylic acid, β-trans-aryloxyacrylic acid, α-chloro-β-E-methoxyacrylic acid, methyl maleic acid, dimethyl maleic acid, phenyl maleic acid, bromo maleic acid, chloromaleic acid, dichloromaleic acid, fluoromaleic acid, difluoro maleic acid, nonyl hydrogen maleate, decyl hydrogen maleate, dodecyl hydrogen maleate, octadecyl hydrogen maleate, fluoroalkyl hydrogen maleate, maleic anhydride, methyl maleic anhydride, dimethyl maleic anhydride, acrylic anhydride, methacrylic anhydride, methacrolein, methacryloyl chloride, methacryloyl fluoride, methacryloyl bromide, and combinations thereof; and wherein the carboxylic acid salt group-containing monomer is selected from the group consisting of acrylic acid salt, methacrylic acid salt, crotonic acid salt, 2-butyl crotonic acid salt, cinnamic acid salt, maleic acid salt, maleic anhydride salt, fumaric acid salt, itaconic acid salt, itaconic anhydride salt, tetraconic acid salt, 2-ethylacrylic acid salt, isocrotonic acid salt, cis-2-pentenoic acid salt, trans-2-pentenoic acid salt, angelic acid salt, tiglic acid salt, 3,3-dimethyl acrylic acid salt, 3-propyl acrylic acid salt, trans-2-methyl-3-ethyl acrylic acid salt, cis-2-methyl-3-ethyl acrylic acid salt, 3-isopropyl acrylic acid salt, trans-3-methyl-3-ethyl acrylic acid salt, cis-3-methyl-3-ethyl acrylic acid salt, 2-isopropyl acrylic acid salt, trimethyl acrylic acid salt, 2-methyl-3,3-diethyl acrylic acid salt, 3-butyl acrylic acid salt, 2-butyl acrylic acid salt, 2-pentyl acrylic acid salt, 2-methyl-2-hexenoic acid salt, trans-3-methyl-2-hexenoic acid salt, 3-methyl-3-propyl acrylic acid salt, 2-ethyl-3-propyl acrylic acid salt, 2,3-diethyl acrylic acid salt, 3,3-diethyl acrylic acid salt, 3-methyl-3-hexyl acrylic acid salt, 3-methyl-3-tert-butyl acrylic acid salt, 2-methyl-3-pentyl acrylic acid salt, 3-methyl-3-pentyl acrylic acid salt, 4-methyl-2-hexenoic acid salt, 4-ethyl-2-hexenoic acid salt, 3-methyl-2-ethyl-2-hexenoic acid salt, 3-tert-butyl acrylic acid salt, 2,3-dimethyl-3-ethyl acrylic acid salt, 3,3-dimethyl-2-ethyl acrylic acid salt, 3-methyl-3-isopropyl acrylic acid salt, 2-methyl-3-isopropyl acrylic acid salt, trans-2-octenoic acid salt, cis-2-octenoic acid salt, trans-2-decenoic acid salt, α-acetoxyacrylic acid salt, β-trans-aryloxyacrylic acid salt, α-chloro-β-E-methoxyacrylic acid salt, methyl maleic acid salt, dimethyl maleic acid salt, phenyl maleic acid salt, bromo maleic acid salt, chloromaleic acid salt, dichloromaleic acid salt, fluoromaleic acid salt, difluoro maleic acid salt, and combinations thereof.

12. (canceled)

13. (canceled)

14. The cathode slurry of claim 10, wherein the sulfonic acid group-containing monomer is selected from the group consisting of vinylsulfonic acid, methylvinylsulfonic acid, allylvinylsulfonic acid, allylsulfonic acid, methallylsulfonic acid, styrenesulfonic acid, 2-sulfoethyl methacrylic acid, 2-methylprop-2-ene-1-sulfonic acid, 2-acrylamido-2-methyl-1-propane sulfonic acid, 3-allyloxy-2-hydroxy-1-propane sulfonic acid, and combinations thereof; and wherein the sulfonic acid salt group-containing monomer is selected from the group consisting of vinylsulfonic acid salt, methylvinylsulfonic acid salt, allylvinylsulfonic acid salt, allylsulfonic acid salt, methallylsulfonic acid salt, styrenesulfonic acid salt, 2-sulfoethyl methacrylic acid salt, 2-methylprop-2-ene-1-sulfonic acid salt, 2-acrylamido-2-methyl-1-propane sulfonic acid salt, 3-allyloxy-2-hydroxy-1-propane sulfonic acid salt, and combinations thereof.

15. (canceled)

16. The cathode slurry of claim 10, wherein the phosphonic acid group-containing monomer is selected from the group consisting of vinyl phosphonic acid, allyl phosphonic acid, vinyl benzyl phosphonic acid, acrylamide alkyl phosphonic acid, methacrylamide alkyl phosphonic acid, acrylamide alkyl diphosphonic acid, acryloylphosphonic acid, 2-methacryloyloxyethyl phosphonic acid, bis(2-methacryloyloxyethyl) phosphonic acid, ethylene 2-methacryloyloxyethyl phosphonic acid, ethyl-methacryloyloxyethyl phosphonic acid, and combinations thereof; and wherein the phosphonic acid salt group-containing monomer is selected from the group consisting of vinyl phosphonic acid salt, salt of allyl phosphonic acid, salt of vinyl benzyl phosphonic acid, salt of acrylamide alkyl phosphonic acid, salt of methacrylamide alkyl phosphonic acid, salt of acrylamide alkyl diphosphonic acid, salt of acryloylphosphonic acid, salt of 2-methacryloyloxyethyl phosphonic acid, salt of bis(2-methacryloyloxyethyl) phosphonic acid, salt of ethylene 2-methacryloyloxyethyl phosphonic acid, salt of ethyl-methacryloyloxyethyl phosphonic acid, and combinations thereof.

17. (canceled)

18. The cathode slurry of claim 10, wherein the polymeric binder further comprises a structural unit (b), wherein structural unit (b) is derived from a monomer selected from the group consisting of an amide group-containing monomer, a hydroxyl group-containing monomer, and combinations thereof.

19. The cathode slurry of claim 18, wherein the proportion of structural unit (b) within the polymeric binder is from about 5% to about 35% by mole, based on the total number of moles of monomeric units in the polymeric binder; and wherein the amide group-containing monomer is selected from the group consisting of acrylamide, methacrylamide, N-methyl methacrylamide, N-ethyl methacrylamide, N-n-propyl methacrylamide, N-isopropyl methacrylamide, isopropyl acrylamide, N-n-butyl methacrylamide, N-isobutyl methacrylamide, N,N-dimethyl acrylamide, N,N-dimethyl methacrylamide, N,N-diethyl acrylamide, N,N-diethyl methacrylamide, N-methylol methacrylamide, N-(methoxymethyl)methacrylamide, N-(ethoxymethyl)methacrylamide, N-(propoxymethyl)methacrylamide, N-(butoxymethyl)methacrylamide, N,N-dimethyl methacrylamide, N,N-dimethylaminopropyl methacrylamide, N,N-dimethylaminoethyl methacrylamide, N,N-dimethylol methacrylamide, diacetone methacrylamide, diacetone acrylamide, methacryloyl morpholine, N-hydroxyl methacrylamide, N-methoxymethyl acrylamide, N-methoxymethyl methacrylamide, N,N′-methylene-bis-acrylamide (MBA), N-hydroxymethyl acrylamide, and combinations thereof.

20. (canceled)

21. The cathode slurry of claim 10, wherein the polymeric binder further comprises a structural unit (c), wherein structural unit (c) is derived from a monomer selected from the group consisting of a nitrile group-containing monomer, an ester group-containing monomer, an epoxy group-containing monomer, a fluorine-containing monomer, and combinations thereof.

22. The cathode slurry of claim 21, wherein the proportion of structural unit (c) within the polymeric binder is from about 15% to about 75% by mole, based on the total number of moles of monomeric units in the polymeric binder; and wherein the nitrile group-containing monomer is selected from the group consisting of acrylonitrile, α-halogenoacrylonitrile, α-alkylacrylonitrile, α-chloroacrylonitrile, α-bromoacrylonitrile, α-fluoroacrylonitrile, methacrylonitrile, α-ethylacrylonitrile, α-isopropylacrylonitrile, α-n-hexylacrylonitrile, α-methoxyacrylonitrile, 3-methoxyacrylonitrile, 3-ethoxyacrylonitrile, α-acetoxyacrylonitrile, α-phenylacrylonitrile, α-tolylacrylonitrile, α-(methoxyphenyl)acrylonitrile, α-(chlorophenyl)acrylonitrile, α-(cyanophenyl)acrylonitrile, vinylidene cyanide, and combinations thereof.

23. (canceled)

24. The cathode slurry of claim 1, wherein the proportion of polymeric binder within the cathode slurry is from about 0.1% to about 10% by weight, based on the total weight of the cathode slurry; and wherein the solid content of the cathode slurry is from 40% to 80%.

25. The cathode slurry of claim 1, further comprising a conductive agent that is selected from the group consisting of carbon, carbon black, graphite, expanded graphite, graphene, graphene nanoplatelets, carbon fibers, carbon nano-fibers, graphitized carbon flake, carbon tubes, carbon nanotubes, activated carbon, Super P, 0-dimensional KS6, 1-dimensional vapor grown carbon fibers (VGCF), mesoporous carbon, and combinations thereof.

26. The cathode slurry of claim 25, wherein the proportion of conductive agent within the cathode slurry is from about 0.5% to about 5%, based on the total weight of the cathode slurry.

27. (canceled)

28. A cathode for a secondary battery, comprising a cathode active material, a polymeric binder, and a lithium compound, wherein the lithium compound is a compound represented by the chemical formula:
[A⁺]ₐB^{a-}
wherein the cation A⁺ is Li⁺, a is an integer from 1 to 10, and the anion B^{a-} is an oxidizable anion.

29. The cathode of claim 28, wherein the decomposition voltage of the lithium compound is from about 3.0 V to about 5.0 V; and wherein the lithium compound is attached onto the surface of the particles of cathode active material particles, and wherein the ratio of average cathode active material diameter to average lithium compound grain length is from 100:1 to 1:1.

30. (canceled)
